(19) United States
(12) Patent Application Publication
(10) Pub. No.: US 2026/0065229 A1
(43) Pub. Date: Mar. 5, 2026

(54) COMPUTER IMPLEMENTED SYSTEM AND METHOD FOR AUTOMATICALLY GENERATING OFFER RANGES FOR CANDIDATES IN AN INTERVIEWING PROCESS

(71) Applicant: Talview Inc, San Mateo, CA (US)

(72) Inventor: SANJOE TOM MATHEW JOSE, Clovis, CA (US)

(21) Appl. No.: 19/379,806

(22) Filed: Nov. 5, 2025

Related U.S. Application Data
(63) Continuation-in-part of application No. 18/531,466, filed on Dec. 6, 2023.

(51) Int. Cl. G06Q 10/1053; G06F 40/253; G06F 40/284; G06F 40/295; G06F 40/35; G06F 40/40; G06T 13/20; G06T 13/40; G06T 17/00; G06V 40/16; G06V 40/20; G10L 13/027; G10L 13/033

(52) U.S. Cl. CPC G06Q 10/1053; G06F 40/253; G06F 40/284; G06F 40/295; G06F 40/35; G06F 40/40; G06T 13/205; G06T 13/40; G06T 17/00; G06V 40/171; G06V 40/176; G06V 40/28; G10L 13/027; G10L 13/0335

(57) ABSTRACT

A computer implemented system and method for generating offer ranges for candidates in an interviewing process is disclosed. The system generates an AI-based interviewer simulating human-based interactions for conducting an ongoing interview with candidates. The system analyzes data associated with candidates obtained during ongoing interview. The system process analyzed responses of candidates to determine contextual attributes associated with responses using ML models. The system automatically generates follow-up interview questions to be delivered to candidates during ongoing interview based on analyzed responses from candidates, by applying AI model to contextual attributes associated with responses. The system generates recruitment scores for candidates based on analyzed responses, contextual attributes, and interpreted non-verbal cues, associated with candidates, using AI model. The system generates offer ranges for candidates based on recruitment scores using AI model. The system provides information associated with selected candidates, and offer ranges generated for selected candidates, to users.

### CROSS-REFERENCE TO RELATED APPLICATIONS

The present application is a continuation-in-part of U.S. patent application Ser. No. 18/531,466, filed on Dec. 6, 2023, and titled “System and method for generating interview insights in an interviewing process”, which claims priority from U.S. patent application Ser. No. 17/510,442, filed on Oct. 26, 2021, and titled “System and method for facilitating an interviewing process”, which claims priority from U.S. Provisional Patent Application 63/118,758, filed on Nov. 27, 2020, and titled “System and method for extracting and using interview intelligence to improve quality of interviews”; each of the above-identified applications is fully incorporated herein by reference.

### TECHNICAL FIELD

Embodiments of the present disclosure relate to a recruitment system and more particularly relate to a computer implemented system and a method for automatically generating one or more offer ranges for one or more candidates in an interviewing process to improve the efficiency and effectiveness of the interviewing process.

### BACKGROUND

Interviews are one of the most used methods to evaluate a candidate's eligibility for opportunities for job, promotion, higher studies, and the like. Therefore, thoroughness and fairness of the evaluation process is particularly important. The ability of an interviewer to interact with a candidate and unearth sufficient information to determine the candidate's eligibility is a crucial step of the evaluation process as the interviewer represents the organization during the interview. Often organizations may end up with poor decisions as there is no formal training process for interviewers, no quality review is performed on their interviewing technique, no interview insights, or candidate skill graphs for the interviewers, and no analysis is performed on the success of their decision to approve or reject any candidate in a systematic manner. Moreover, sometimes the interviews become biased due to unconscious biases of the interviewer. Improper training of the interviewer, lack of reviews and poor analysis may lead to poor decisions and being unfair to candidates who are actually deserving. In addition, there are areas where candidates may be more objectively evaluated by a proprietary scoring mechanism than individual interviewers. At the same time, replacing AI based tools or applications with the human interviewers is cumbersome task during the interviews.

Hence, there is a need in the art for a computer implemented system and method for automatically generating one or more offer ranges for one or more candidates in an interviewing process, in order to address at least the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a computer implemented system for automatically generating one or more offer ranges for one or more candidates during an interviewing process. The computer implemented system includes one or more hardware processors and a memory. The memory is communicatively coupled to the one or more hardware processors. The memory comprises a plurality of subsystems in form of programmable instructions executable by the one or more hardware processors.

The plurality of subsystems comprises an AI-based interviewer generating subsystem configured to generate an AI-based interviewer simulating human-based interactions for conducting an ongoing interview with one or more candidates. The plurality of subsystems further comprises a data obtaining subsystem configured to obtain data associated with the one or more candidates through at least one of: one or more image capturing devices and one or more audio devices, during the ongoing interview. The data associated with the one or more candidates comprise at least one of: profile information, responses in form of audio and text, and non-verbal cues, associated with the one or more candidates.

The plurality of subsystems further comprises a data analyzing subsystem configured to analyze the data associated with the one or more candidates obtained during the ongoing interview. In an embodiment, analyzing associated with the one or more candidates comprises processing of the responses of the one or more candidates using natural language processing (NLP) techniques, and interpreting the one or more non-verbal cues. The plurality of subsystems further comprises a data processing subsystem configured to process the analyzed responses of the one or more candidates to determine one or more contextual attributes associated with the responses using one or more machine learning (ML) models. The one or more contextual attributes comprise at least one of: one or more verbal attributes, one or more non-verbal attributes, one or more performance attributes, and one or more contextual interaction attributes.

The plurality of subsystems further comprises a query generating subsystem configured to automatically generate one or more follow-up interview questions to be delivered to the one or more candidates during the ongoing interview based on the analyzed responses from the one or more candidates, by applying an AI model to the one or more contextual attributes associated with the responses. The plurality of subsystems further comprises a score generating subsystem configured to generate one or more recruitment scores for the one or more candidates based on at least one of: the analyzed responses, the one or more contextual attributes, and interpreted non-verbal cues, associated with the one or more candidates, using the AI model.

The plurality of subsystems further comprises a decision supporting subsystem configured to generate one or more offer ranges for the one or more candidates based on the one or more recruitment scores using the AI model. The one or more offer ranges are configured to assist for one or more users in recruitment-related decision making. The plurality of subsystems further comprises an output subsystem configured to provide information associated with at least one of: one or more selected candidates, and the one or more offer ranges generated for the one or more selected candidates, to the one or more users through one or more user interfaces associated with one or more electronic devices of the one or more users.

In an embodiment, for generating the AI-based interviewer, the AI-based interviewer generating subsystem is configured to: (a) identify one or more objectives of the AI-based interviewer by creating one or more interactive visual representations conducting the ongoing interview effectively; (b) generate a lifelike AI-based interviewer based on user personas relevant to one or more targeted interview domains comprising at least one of: one or more job roles and industries; (c) generate a visually appealing AI-based interviewer reflecting an identity and desired competencies of a human interviewer using a three dimensional modelling application; (d) perform at least one of: analyzing one or more inputs, processing the one or more inputs, and responding to the one or more inputs of the one or more candidates in real-time, by integrating one or more NLP capabilities within the AI-based interviewer; (e) train the AI-based interviewer with a set of competency-based questions and the one or more follow-up interview questions, relevant to a career path of the one or more candidates using the one or more ML models; (f) utilize one or more behavioral models to guide one or more interactions of the AI-based interviewer to emulate human-like behaviors comprising at least one of: changing tone, expressing empathy, providing facial expressions, and adjusting emotional responses, based on the responses from the one or more candidates; (g) implement a conversation engine for the AI-based interviewer to adapt for follow-up questions based on the responses from the one or more candidates, using the AI model; (h) synchronize at least one of: lip movements, gestures, and the facial expressions, of the AI-based interviewer with verbal communication of the AI-based interviewer during the ongoing interview, using a visual and audio synchronization technique; and (i) generate a natural sounding voice matching a visual persona of the AI-based interviewer using a speech synthesis technology.

In another embodiment, for analyzing the data associated with the one or more candidates obtained during the ongoing interview, the data analyzing subsystem is configured to at least one of: (a) process the responses of the one or more candidates using the natural language processing (NLP) techniques, by: obtaining the data associated with the one or more candidates; processing the responses in form of the audio by a speech recognition model, wherein the speech recognition model transforms the audio into a text; segmenting the transformed text into one or more tokens for analyzing the transformed text; tagging each token with one or more corresponding grammatical roles for analyzing a structure of the responses; analyzing an emotional tone of the responses comprising at least one of: positive, neutral, and negative emotions, to provide one or more insights into attitudes and feelings of the one or more candidates, using the one or more ML models; identifying one or more key entities comprising skills, experiences, and names, within the responses, for matching the one or more candidates with one or more job roles; and processing context surrounding specific phrases with the one or more key entities for analyzing nuance in the responses of the one or more candidates, using one or more transformer models; (b) interpret the one or more non-verbal cues by: analyzing visual data collected during the ongoing interview using a computer vision technique; identifying one or more emotions through the facial expressions of the one or more candidates; tracking body language and hand gestures to assess confidence and reluctance of the one or more candidates; and determining physical stance to guage comfort levels and engagement during the ongoing interview; and (c) integrate the processed responses of the one or more candidates and the interpreted one or more non-verbal cues to generate a comprehensive profile of the one or more candidates during the ongoing interview.

In yet another embodiment, for automatically generating the one or more follow-up interview questions, the query generating subsystem is configured to: (a) obtain the analyzed responses comprising at least one of: verbal response and the non-verbal responses, from the one or more candidates; (b) identify the one or more contextual attributes from the analyzed responses; (c) utilize the one or more ML models being trained on one or more datasets of interview transcripts and the one or more follow-up interview questions, to analyze context and intention behind the responses of the one or more candidates; (d) interpret the nuances in a language capturing subtleties around meaning and intent guiding question formulation using the AI model with the NLP techniques; and (e) generate contextually appropriate one or more follow-up interview questions based on the identified one or more contextual attributes, using one or more neural network architectures.

In yet another embodiment, the query generating subsystem is further configured to: (a) filter the one or more follow-up interview questions based on relevance of the specific context provided by one or more previous responses of the one or more candidates; (b) generate multiple variation of the one or more follow-up interview questions for at least one of: natural conversation flow, avoiding rigid scripts, and enabling dynamic interactions; (c) structure the one or more follow-up interview questions to assess competencies related to the one or more job roles; and (d) interact with the one or more candidates with one or more follow-up questions, adapting to a flow of conversation with the one or more candidates.

In yet another embodiment, for generating the one or more recruitment scores for the one or more candidates, using the AI model, the score generating subsystem is configured to: (a) obtain information associated with at least one of: the analyzed responses, the one or more contextual attributes, and interpreted non-verbal cues, of each candidate of the one or more candidates; (b) generate one or more weights to at least one of: the analyzed responses, the one or more contextual attributes, and interpreted non-verbal cues, of the one or more candidates, using a scoring model; and (c) compute the one or more interview scores for each candidate based on the one or more weights generated for at least one of: the analyzed responses, the one or more contextual attributes, and interpreted non-verbal cues, of each candidate of the one or more candidates.

In yet another embodiment, for generating the one or more offer ranges for the one or more candidates based on the one or more recruitment scores using the AI model, the decision supporting subsystem is configured to: (a) obtain information associated with the one or more recruitment scores generated for the one or more candidates; (b) analyze one or more target parameters and benchmarks based on at least one of: one or more industry standards, historical data, one or more organizational compensation structures, and competitor analyses; and (c) generate the one or more offer ranges for each candidate of the one or more candidates by correlating the one or more offer ranges with the one or more recruitment scores, based on at least one of: the one or more target parameters and benchmarks and one or more factors, using the AI model, wherein the one or more factors comprise at least one of: experience level, skill set, and overall fit for the job role, of the one or more candidates within an organization.

In yet another embodiment, the AI-based interviewer is configured to analyze at least one of: emotion recognition, gaze tracking, and head movement through a real-time webcam, for performing at least one of: adjusting tone, pacing, and questioning in style using a multi-modal fusion, by adapting at least one of: the data obtaining subsystem to continuously capture visual data with high-resolution video streams associated with the one or more candidates from webcam inputs, processing frame-by-frame visual data at rates for real-time emotion detection and behavioral analysis; the data analyzing subsystem configured to: (a) analyze the visual data using computer vision techniques to identify emotions through facial expressions of the one or more candidates, (b) categorize the facial expressions of the one or more candidates as at least one of: happiness, sadness, confusion, anxiety, and confidence based on real-time analysis of facial movements and micro-expressions using a convolutional neural network model, (c) identify key facial features comprising eyebrow position, mouth curvature, eye openness, and cheek muscle tension, to analyze the emotion recognition, (d) track eye movements, fixation points, and gaze direction, of the one or more candidates, to assess candidate engagement and attention levels, using a computer vision system, and (e) track head position, tilt angles, and movement patterns, of the one or more candidates, to assess candidate comfort, agreement and disagreement signals, and overall engagement levels; the data processing subsystem configured to: (a) process the analyzed responses to determine the one or more contextual attributes using machine learning models, wherein the visual data obtained from the real-time webcam input is processed to dynamically modify the one or more contextual attributes that are provided as input to a transformer-based large language model (LLM), (b) generate unified embeddings indicating verbal content and real-time visual behavioral data, and (c) correlate verbal responses with simultaneous visual cues to detect incongruence between spoken words and body language, using the transformer-based LLM; and the query generating subsystem configured to: (a) utilize one or more behavioral models to guide interactions and emulate human-like behaviors comprising changing tone based on detected emotional states from the real-time webcam, (b) monitor visual indicators of cognitive processing comprising prolonged gaze aversion and facial expressions indicating concentration, to adjust the pacing, and (c) generate contextually appropriate follow-up questions influenced by real-time visual feedback.

In yet another embodiment, the AI-based interviewer generating subsystem is configured to emulate at least one of: the lip movements, the gestures, the facial expressions, and speech tone through a text-to-speech engine with phoneme sync, using a LLM, by: (a) synchronizing the lip movements with verbal communication during the ongoing interview using visual and audio synchronization techniques; (b) analyzing generated speech content at a phoneme level, mapping each speech sound to corresponding viseme representations indicating lip and mouth movements; (c) synchronizing gestures of the AI-based interviewer with verbal communication during the ongoing interview; (d) analyzing LLM-generated content for contextual cues triggering corresponding hand and arm movements, comprising counting gestures for enumerated points and descriptive gestures for spatial concepts; (e) utilizing the one or more behavioral models to guide interactions of the AI-based interviewer to emulate human-like behaviors comprising the gestures based on the one or more responses from the one or more candidates; (f) utilizing the one or more behavioral models to guide the interactions and emulate human-like behaviors including providing facial expressions based on the one or more responses from the one or more candidates; (g) processing emotional context from LLM outputs and candidate analysis to select corresponding facial expressions indicating empathy, interest, concern, and encouragement; (h) utilizing the one or more behavioral models to guide the interactions including changing tone based on the one or more responses from the one or more candidates; and (i) modifying vocal parameters comprising pitch, pace, volume, and intonation to match emotional context determined by the LLM and candidate analysis systems.

In an aspect, a computer implemented method for automatically generating one or more offer ranges for one or more candidates during an interviewing process, is disclosed. The computer implemented method comprises generating, by one or more hardware processors, an AI-based interviewer simulating human-based interactions for conducting an ongoing interview with one or more candidates. The computer implemented method further comprises obtaining, by the one or more hardware processors, data associated with the one or more candidates through at least one of: one or more image capturing devices and one or more audio devices, during the ongoing interview. The data associated with the one or more candidates comprise at least one of: profile information, responses in form of audio and text, and non-verbal cues, associated with the one or more candidates.

The computer implemented method further comprises analyzing, by the one or more hardware processors, the data associated with the one or more candidates obtained during the ongoing interview. In an embodiment, analyzing associated with the one or more candidates comprises processing of the responses of the one or more candidates using natural language processing (NLP) techniques, and interpreting the one or more non-verbal cues.

The computer implemented method further comprises processing, by the one or more hardware processors, the analyzed responses of the one or more candidates to determine one or more contextual attributes associated with the responses using one or more machine learning (ML) models. The one or more contextual attributes comprise at least one of: one or more verbal attributes, one or more non-verbal attributes, one or more performance attributes, and one or more contextual interaction attributes.

The computer implemented method further comprises automatically generating, by the one or more hardware processors, one or more follow-up interview questions to be delivered to the one or more candidates during the ongoing interview based on the analyzed responses from the one or more candidates, by applying an AI model to the one or more contextual attributes associated with the responses.

The computer implemented method further comprises generating, by the one or more hardware processors, one or more recruitment scores for the one or more candidates based on at least one of: the analyzed responses, the one or more contextual attributes, and interpreted non-verbal cues, associated with the one or more candidates, using the AI model. The computer implemented method further comprises generating, by the one or more hardware processors, one or more offer ranges for the one or more candidates based on the one or more recruitment scores using the AI model, wherein the one or more offer ranges are configured to assist for one or more users in recruitment-related decision making.

The computer implemented method further comprises providing, by the one or more hardware processors, information associated with at least one of: one or more selected candidates, and the one or more offer ranges generated for the one or more selected candidates, to the one or more users through one or more user interfaces associated with one or more electronic devices of the one or more users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1 illustrates an exemplary block diagram representation of a network architecture implementing a computer implemented system for generating interview insights with one or more offer ranges for one or more candidates in an interviewing process, in accordance with an embodiment of the present disclosure;

FIG. 2A illustrates an exemplary block diagram representation of a computer implemented system, such as those shown in FIG. 1, capable of generating interview insights in an interviewing process, in accordance with an embodiment of the present disclosure;

FIG. 2B illustrates an exemplary block diagram representation of the computer implemented system, such as those shown in FIG. 1, capable of generating one or more offer ranges in the interviewing process, in accordance with an embodiment of the present disclosure;

FIG. 2C illustrates a sequence diagram representing a flow from video input of a candidate to computer vision speech recognition engine, a conversation engine, and a text to speech engine, to generate a response by an AI-based interviewer, in accordance with an embodiment of the present disclosure;

FIG. 3A illustrates an exemplary flow chart representation depicting a computer implemented method for generating interview insights in an interviewing process, in accordance with an embodiment of the present disclosure;

FIG. 3B illustrates an exemplary flow chart illustrating the computer implemented method for generating the one or more offer ranges in the interviewing process, in accordance with an embodiment of the present disclosure;

FIGS. 4A and 4B illustrate exemplary schematic diagram representations of graphical user interface screens of web application capable of outputting one or more attributes associated with one or more interviews, in accordance with an embodiment of the present disclosure;

FIGS. 4C and 4D illustrate exemplary schematic diagram representations of graphical user interface screens of a web application capable of outputting score card associated with interviewer, in accordance with an embodiment of the present disclosure;

FIGS. 4E and 4F illustrate exemplary schematic diagram representations of graphical user interface screens of a web application capable of outputting interview structure, and interview transcript, respectively, for the interviewer, in accordance with an embodiment of the present disclosure;

FIGS. 4G and 4H illustrate exemplary schematic diagram representations of graphical user interface screens of a web application capable of outputting interview summary, and interview insights, respectively, for the interviewer, in accordance with an embodiment of the present disclosure;

FIG. 4I illustrates an exemplary schematic diagram representation of a graphical user interface screen of a web application capable of outputting topic coverage during the interviewing process, in accordance with an embodiment of the present disclosure;

FIG. 5 illustrates an exemplary flow diagram representation depicting a method for facilitating the interviewing process, in accordance with an embodiment of the present disclosure; and

FIG. 6 illustrates an exemplary flow diagram representation depicting a method for creating topic cluster for one or more exemplary candidate roles, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or s “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

Although the explanation is limited to a single interviewer and candidate, it should be understood by the person skilled in the art that the computing system is applied if there is more than one interviewer and candidate.

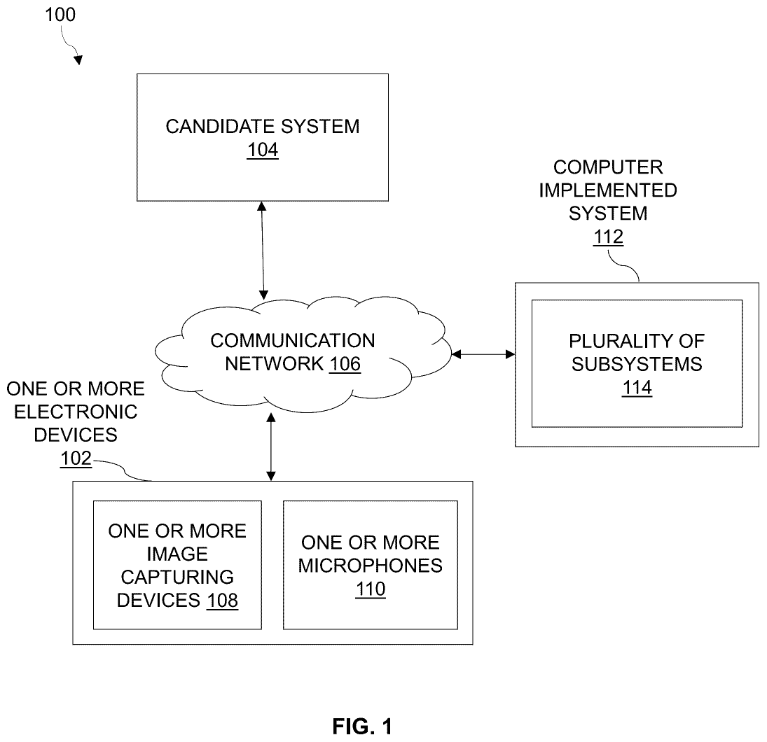

Referring now to the drawings, and more particularly to FIG. 1 through FIG. 6, where similar reference characters denote corresponding features consistently throughout the figures, there are shown preferred embodiments and these embodiments are described in the context of the following exemplary system and/or method.

FIG. 1 illustrates an exemplary block diagram representation of a network architecture 100 implementing a computer implemented system 112 for generating interview insights with one or more offer ranges for one or more candidates in an interviewing process, in accordance with an embodiment of the present disclosure.

According to FIG. 1, the network architecture 100 may include one or more electronic devices 102 associated with an interviewer communicatively coupled to a candidate system 104 associated with a candidate via a communication network 106. In an exemplary embodiment, the interviewer may use the one or more electronic devices 102 and the candidate may use the candidate system 104 for conducting one or more interviews. In an alternative embodiment of the present disclosure, the one or more interviews may also be traditional face to face interviews. The one or more electronic devices 102 and the candidate system 104 may be, but is not limited to, a laptop computer, a desktop computer, a tablet computer, a phablet computer, a smartphone, a wearable device, a smart watch, a personal digital assistant (PDA), a Virtual/Augmented Reality (AR/VR) device, an image capturing device, a depth-based image capturing device, and the like. Further, the communication network 106 may be a wired communication network and/or a wireless communication network.

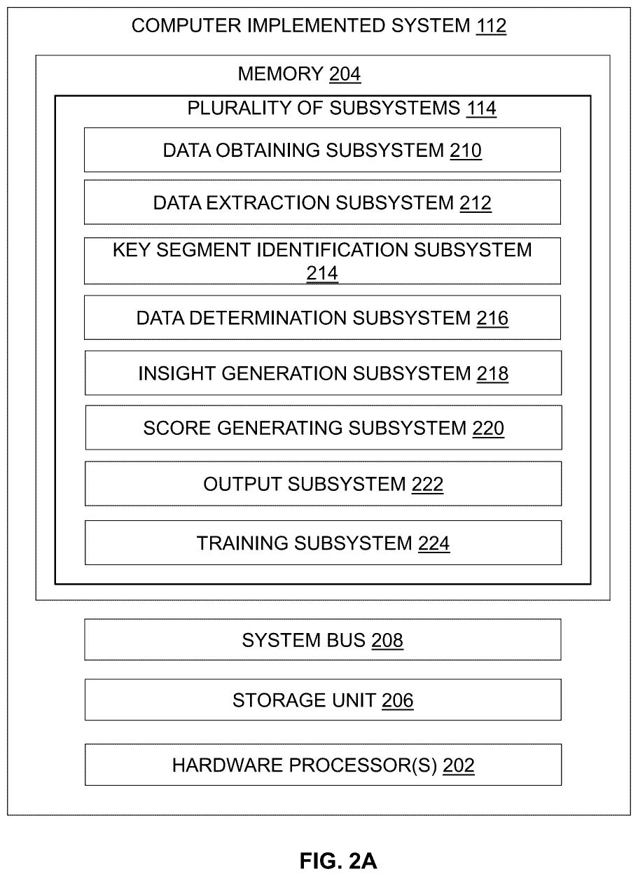

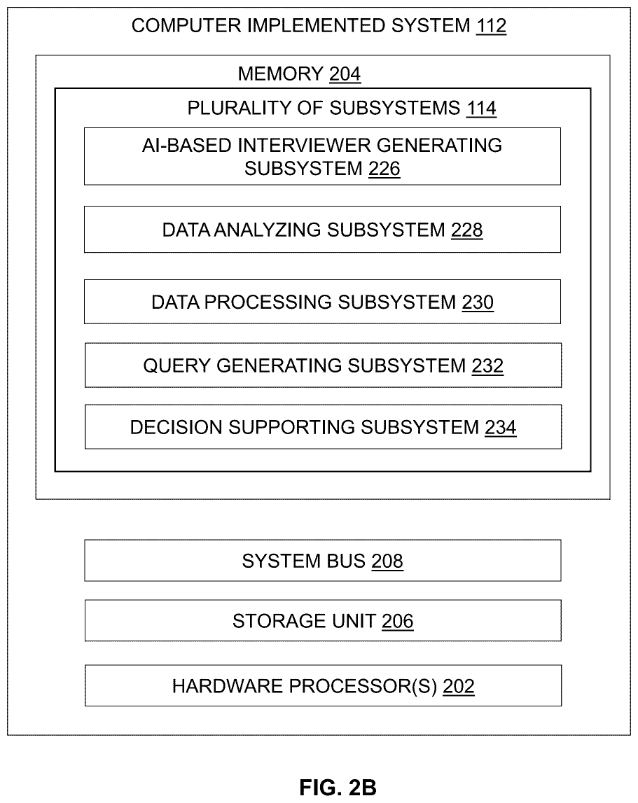

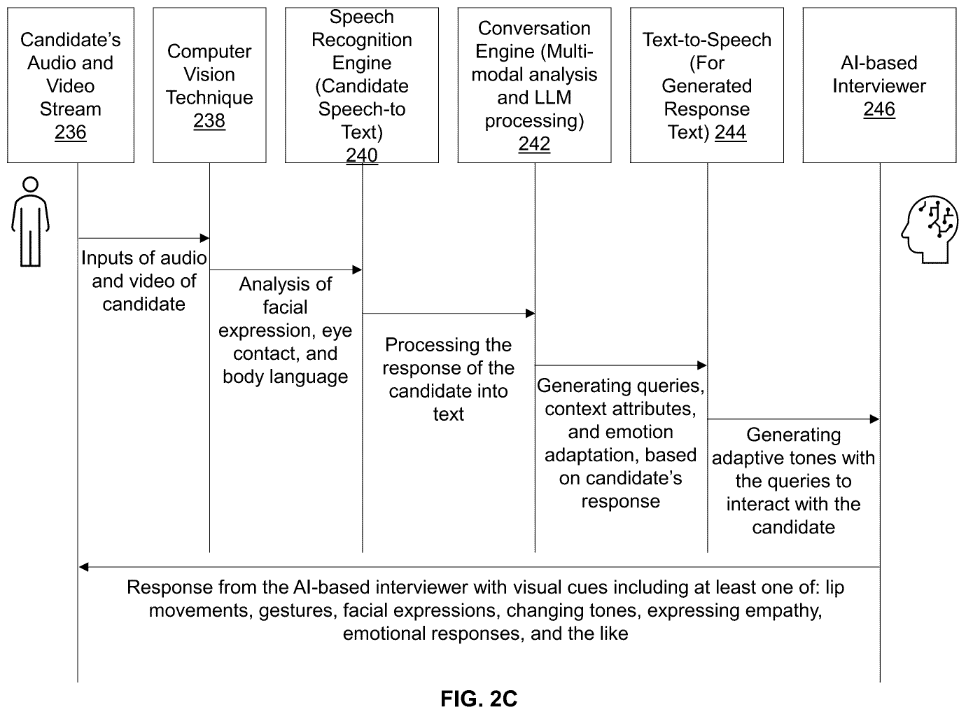

Further, the one or more electronic devices 102 include one or more image capturing devices 108 and one or more microphones 110. The one or more image capturing devices 108 and the one or more microphones 110 capture the one or more interviews between the interviewer and the candidate. In an alternative embodiment of the present disclosure, the one or more image capturing devices and one or more microphones may be placed in a meeting room to capture the traditional face to face interviews. Furthermore, the one or more electronic devices 102 associated with the interviewer are communicatively coupled to the computer implemented system 112 via the communication network 106. The one or more electronic devices 102 include a web browser and/or a mobile application to access the computer implemented system 112 via the communication network 106. In an exemplary embodiment of the present disclosure, the candidate/interviewer may use a web application through the web browser to access the computer implemented system 112. The candidate/interviewer may use the computer implemented system 112 to determine one or more attributes and generate a score card for facilitating the interviewing process. The computer implemented system 112 may be a central server, such as cloud server or a remote server. In an embodiment of the present disclosure, the computer implemented system 112 may be seamlessly integrated with video communications platforms or human resources management systems for facilitating the interviewing process. Furthermore, the computer implemented system 112 includes a plurality of subsystems 114. Details on the plurality of computer implemented 114 have been elaborated in subsequent paragraphs of the present description with reference to FIGS. 2A and 2B.

In an exemplary embodiment, the computer implemented system 112 is configured to receive the one or more interviews captured by the one or more image capturing devices 108 and the one or more microphones 110. The computer implemented system 112 extracts audio and video data from the received one or more interviews between the interviewer and the candidate. Further, the computer implemented system 112 also identifies one or more key segments from a plurality of segments. The plurality of segments is identified from the extracted audio data corresponding to the interviewer and the candidate. The computer implemented system 112 determines one or more sentiment parameters associated with the interviewer and the candidate, by analyzing the extracted video data, wherein the one or more sentiment parameters comprise at least one of emotions, attitudes and thoughts associated with the interviewer and the candidate and the like. Furthermore, the computer implemented system 112 determines one or more attributes associated with each of the one or more interviews based on at least one of: the extracted audio data, the extracted video data, the one or more key segments, the one or more sentiment parameters, a job description and a resume of the candidate, by using an interview optimization based Artificial Intelligence (AI) model. The computer implemented system 112 determines one or more interview structural parameters and one or more interview practice parameters in each of the one or more interview structural parameters, based on the determined one or more attributes. In an exemplary embodiment, the one or more interview structural parameters includes, but not limited to, introduction of the interviewer and the candidate, discussion between the interviewer and the candidate, conclusion of the interviewer and the candidate, and the like.

The computer implemented system 112 annotates the plurality of segments based on the determined one or more interview structural parameters and the one or more interview practice parameters. The computer implemented system 112 identifies the one or more key segments from the annotated plurality of segments for an interested action of the interviewer. The computer implemented system 112 identifies one or more key topics corresponding to the identified one or more key segments based on the one or more attributes, to generate a skill graph of the candidate.

In an exemplary embodiment, the computer implemented system 112 generates an interview summary for the interested action of the interviewer. The interested action comprises at least one of an action of an inference of topics discussed in the interview and an action of a preparation of upstream notes of the one or more interviews. The computer implemented system 112 generates one or more interview insights comprising a comparison of the one or more interview insights for each of the one or more interviews with an average ratio of pre-determined insights, for the one or more attributes. In an exemplary embodiment, the one or more interviews insights include, but are not limited to, language insights, situational judgement insights, diversity, equity, and inclusion (DEI) insights, legal risk and compliance insights, interview bias probability insights, domain insights, and the like. The DEI insights may be the ability to provide feedback to the interviewer and the organization, if the interview language used is inclusive or has aspects that might repel candidates from a particular group. Further, the domain Insights may be the ability to score candidate's knowledge in a particular domain by measuring the depth and breadth of topics candidate was able to discuss during an interview conversation.

The computer implemented system 112 maps skills discussed in the interview with a skill graph based on the identified one or more key topics, to determine if there is sufficient topic coverage for the topics to be discussed in each of the one or more interviews. In an alternate embodiment, one or more external/internal databases may include up-to-date skill graphs with skills along with one or more associated topics for each skill. The one or more external/internal databases may monitor logs mentions of the topics or related keywords in the conversation. The computer implemented system 112 may retrieve the skill graphs from the one or more external/internal databases. The computer implemented system 112 generates a score card associated with the interviewer comprising one or more interviewer profile parameters based on the determined one or more attributes and predefined criteria by using the interview optimization-based AI model. The computer implemented system 112 outputs the determined one or more attributes, the generated score card, the interview summary, the one or more interview insights, and the skill graph on a graphical user interface of one or more electronic devices associated with the interviewer.

In one aspect of the present invention, the computer implemented system 112 is configured to generate the one or more offer ranges for the one or more candidates during the interviewing process. The computer implemented system 112 is initially configured to generate an AI-based interviewer simulating human-based interactions for conducting an ongoing interview with one or more candidates. The computer implemented system 112 is further configured to obtain data associated with the one or more candidates through at least one of: the one or more image capturing devices 108 and one or more audio devices (e.g., the one or more microphones 110), during the ongoing interview. In an embodiment, the data associated with the one or more candidates may include at least one of: profile information, responses in form of audio and text, and non-verbal cues, associated with the one or more candidates.

The computer implemented system 112 is further configured to analyze the data associated with the one or more candidates obtained during the ongoing interview. In an embodiment, analyzing associated with the one or more candidates comprises processing of the responses of the one or more candidates using natural language processing (NLP) techniques, and interpreting the one or more non-verbal cues. The computer implemented system 112 is further configured to process the analyzed responses of the one or more candidates to determine one or more contextual attributes associated with the responses using one or more machine learning (ML) models. The one or more contextual attributes comprise at least one of: one or more verbal attributes, one or more non-verbal attributes, one or more performance attributes, and one or more contextual interaction attributes.

The computer implemented system 112 is further configured to automatically generate one or more follow-up interview questions to be delivered to the one or more candidates during the ongoing interview based on the analyzed responses from the one or more candidates, by applying an AI model to the one or more contextual attributes associated with the responses. The computer implemented system 112 is further configured to generate one or more recruitment scores for the one or more candidates based on at least one of: the analyzed responses, the one or more contextual attributes, and interpreted non-verbal cues, associated with the one or more candidates, using the AI model.

The computer implemented system 112 is further configured to generate one or more offer ranges for the one or more candidates based on the one or more recruitment scores using the AI model. In an embodiment, the one or more offer ranges are configured to assist for one or more users in recruitment-related decision making. The computer implemented system 112 is further configured to provide information associated with at least one of: one or more selected candidates, and the one or more offer ranges generated for the one or more selected candidates, to the one or more users through one or more user interfaces associated with the one or more electronic devices 102 of the one or more users.

FIG. 2A illustrates an exemplary block diagram representation of the computer implemented system 112, such as those shown in FIG. 1, capable of generating interview insights in an interviewing process, in accordance with an embodiment of the present disclosure. The computer implemented system 112 comprises one or more hardware processors 202, a memory 204, and a storage unit 206. The one or more hardware processors 202, the memory 204 and the storage unit 206 are communicatively coupled through a system bus 208 or any similar mechanism. The memory 204 comprises the plurality of subsystems 114 in form of programmable instructions executable by the one or more hardware processors 202. Further, the plurality of subsystems 114 includes a data obtaining subsystem 210, a data extraction subsystem 212, a key segment identification subsystem 214, a data determination subsystem 216, an insight generation subsystem 218, a score generating subsystem 220, an output subsystem 222, and a training subsystem 224.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of subsystems 114 stored in the form of machine-readable instructions on any of the above-mentioned storage media and may be in communication with and executed by the one or more hardware processors 202.

The storage unit 206 may be a cloud storage. The storage unit 206 may store the one or more attributes associated with the one or more interviews and the score card associated with the interviewer. The storage unit 206 may also store the predefined criteria, predefined score associated with each of the one or more attributes and the one or more interviews.

In an exemplary embodiment, the plurality of subsystems 114 includes the data obtaining subsystem 210 that is communicatively connected to the one or more hardware processors 202. The data obtaining subsystem 210 is configured to receive information associated with the one or more interviews between the candidate and the interviewer captured by the one or more image capturing devices 108 and the one or more microphones 110. In an embodiment of the present disclosure, the one or more interviews may be ongoing interviews. In another embodiment of the present disclosure, the one or more interviews may be pre-stored interviews stored in the storage unit 206.

The data obtaining subsystem 210 is a critical component of the computer implemented system 210 designed to capture and process the information during the interviews between the candidates and interviewers. This data obtaining subsystem 210 is specifically configured to receive multimedia data collected through various input devices, including image capturing devices 108 (such as cameras) and audio devices (such as microphones 110). The information acquired encompasses a range of data related to the candidate's interactions during the interviews, which may include audio responses, visual data (such as facial expressions and body language), and any pre-existing profile information about the candidates.

For example, a tech company uses the computer implemented system 112 to evaluate candidates for a software engineering position. During the interview process, the data obtaining subsystem 210 captures the candidate's spoken responses via a microphone. For instance, when asked, “Can you describe a time when you resolved a conflict within your team?”. The candidates articulate their answers. The data obtaining subsystem 210 records this audio for analysis. Simultaneously, the data obtaining subsystem 210 uses a webcam to capture video footage of the interview. This provides visual information on non-verbal cues like body language, eye contact, and facial expressions when responding to the questions. Prior to the interview, the data obtaining subsystem 210 may also load relevant candidate profiles from a database, which includes resumes and other pertinent background information, ensuring that the interview process is grounded in historical candidate data.

In an exemplary embodiment, the plurality of subsystems 114 further includes the data extraction subsystem 212 that is communicatively connected to the one or more hardware processors 202. The data extraction subsystem 212 may be configured to extract audio data and video data from one or more interviews between the interviewer and the one or more candidates. The data extraction subsystem 212 is a functional component of the computer implemented system 112 designed to systematically extract audio and video data collected from interviews between candidates and interviewers. The data extraction subsystem 212 ensures that both verbal and non-verbal communication data are accurately extracted, allowing for detailed analysis and insights into candidate performance.

For example, a scenario where a financial firm conducts interviews for a junior analyst position using the computer implemented system 112. The candidate participates in a virtual interview facilitated by the computer implemented system 112, where their responses are recorded through a high-definition camera (image capturing device) and a high-fidelity microphone (audio device). As the interview progresses, the data extraction subsystem 212 diligently captures and separates the audio of the candidate's verbal responses (e.g., “I have a strong foundation in financial analysis and recently completed an internship specializing in market research”) and video recordings showcasing their facial expressions and body language. For instance, the data extraction subsystem 212 may extract a segment of audio where the candidate describes their relevant experience and pairing it with the video segment that displays the candidate's confident demeanor and engaging eye contact.

In an exemplary embodiment, the plurality of subsystems 114 further includes the key segment identification subsystem 214 that is communicatively connected to the one or more hardware processors 202. The key segment identification subsystem 214 may be configured to identify one or more key segments from a plurality of segments. The plurality of segments is identified from the extracted audio data corresponding to the interviewer and the one or more candidates. In identifying the one or more key segments from the plurality of segments, the key segment identification subsystem 214 converts the extracted audio data into a plurality of text streams using a natural language processing technique and an audio analytic technique. For example, a scenario where an organization is interviewing candidates for a marketing manager position. The interview is recorded, and both the audio and video data are captured. As the interview progresses, the candidate responds to various prompts from the interviewer regarding their experience and approach to marketing strategies. Once the interview concludes, the key segment identification subsystem 214 applies NLP techniques to convert the recorded audio (e.g., “I led our social media campaigns which increased engagement by 150% in one year”) into corresponding text streams. Each spoken response from both the interviewer and candidate becomes a part of a larger set of text data.

An audio stream is further analyzed using acoustic models and techniques such as voice tremor analysis, to generate speech patterns length, silence, talk ratios, and frequency. Further, the key segment identification subsystem 214 determines one or more portions of the plurality of text streams corresponding to the interviewer and the candidate. The audio stream analysis involves the evaluation of audio data captured during interviews using various acoustic models and techniques, including voice tremor analysis. This analysis produces valuable metrics such as speech patterns, silence durations, talk ratios, and frequency. The key segment identification subsystem 214 utilizes this analytical data to determine significant portions of the transcribed dialogues corresponding to both the interviewer and the candidate. The audio from the interview is processed using sophisticated acoustic models. These models analyze the characteristics of the audio data to extract metrics that inform the performance and effectiveness of communication during the interview. The voice tremor analysis helps detect variations in a candidate's voice that may indicate stress or confidence levels. The analysis delineates patterns in speech, including tone and cadence. Metrics are generated for periods of silence versus talk time, providing insights into candidate engagement and the balance of conversation between interviewer and candidate. The frequency refers to the frequency of speech elements such as keywords or phrases pertinent to the job role.

In an exemplary scenario, as the candidate elaborates on their experience, the following dialogue occurs. The interviewer asks, “Can you describe a project where you faced significant challenges?”. The candidate replies “Certainly! During my last role, we had to pivot our strategy due to unexpected economic shifts. I led a team that successfully adapted our approach, which resulted in a 20% increase in project efficiency.” The audio is analyzed, revealing that the candidate's voice displayed steady pitch with occasional tremors during the “unexpected economic shifts” phrase, indicating possible stress. The analysis measures silence between responses and finds a talk ratio of 70% for the candidate versus 30% for the interviewer during key discussions. From the transcribed text, the key segment identification subsystem 214 identifies the candidate's response about “pivoting strategy” as a key segment due to its relevance to adaptability and problem-solving skills. This segment is annotated and saved, allowing recruiters to focus on these insights when evaluating the candidate's fit for the role.

In an embodiment of the present disclosure, the key segment identification subsystem 214 may identify one or more conversation dividers between the interviewer and the interviewee to determine the one or more portions of the plurality of text streams corresponding to the interviewer and the candidate. The audio stream is run through dedicated speaker diarization technology, and the audio stream is partitioned in segments to identify the speaker and the number of speakers. The key segment identification subsystem 214 divides the plurality of text streams into the plurality of segments based on the determined one or more portions.

The key segment identification subsystem 214 uses speaker diarization to segment audio into distinct parts, delineating who is speaking (whether the interviewer or the candidate) and when they are speaking. By marking the transitions between speakers, the system can break down the audio stream into manageable, labeled segments. Once the audio stream is analyzed through the speaker diarization technology, the audio stream is divided into segments that correspond to identifiable speech intents. Each segment is tagged with the identity of the speaker, which is vital for accurate transcript generation and analysis. This process allows the key segment identification subsystem 214 to construct a comprehensive dialogue flow that can be further evaluated for content relevance and effectiveness. After partitioning the segments, the key segment identification subsystem 214 not only identifies the conversations but also categorizes them based on content. This makes it possible to pinpoint key discussions regarding candidate qualifications, experiences, and soft skills. Annotating these segments aids in the extraction and reporting of the most pertinent parts of the interview.

In an exemplary scenario, an interview scenario is considered for a data analyst position. The interview is conducted via an online platform where both audio and video are recorded. As the interviewer begins speaking, the key segment identification subsystem 214 captures the audio stream. The dialogue may include exchanges like the interviewer asks, “Can you tell me about a time you used data to solve a problem?”. The candidate replies “Sure! In my prior role, I analyzed sales data, which revealed significant trends that helped us improve our inventory management.” The audio stream is processed using the speaker diarization technology that detects when the interviewer finishes asking a question and the candidate begins to respond. The system identifies the speaker shifts, creating a segmented audio timeline, for instance: Segment 1: “Interviewer: Can you tell me about a time you used data to solve a problem?” and the Segment 2: “Candidate: Sure! In my prior role, I analyzed sales data”. The key segment identification subsystem 214 successfully identifies and labels both segments as spoken by different individuals, tagging them accordingly for analysis. The identified segments are annotated, allowing evaluators to focus on the candidate's response about using data to solve problems. This response can be highlighted as a key segment for further consideration in hiring decisions. Based on the segmented and analyzed audio data, the key segment identification subsystem 214 generates insights that facilitate a thorough understanding of candidate competencies, making the interview evaluation process more efficient and data-driven.

Furthermore, the key segment identification subsystem 214 annotates the plurality of segments. The key segment identification subsystem 214 identifies the one or more key segments from the annotated plurality of segments. The one or more key segments are sections of the plurality of segments in which relevant topics are discussed, such as qualification, experience, soft skills of the candidate and the like. In an embodiment of the present disclosure, the key segment identification subsystem 214 may determine and assign the identity of the interviewer and the candidate by analyzing the extracted audio data using an audio analytics technique. The key segment identification subsystem 214 determines the identity of each speaker (interviewer or candidate) by analyzing the audio data. This is achieved through techniques that disentangle overlapping speech and pinpoint specific parts of the audio stream that correspond to each speaker. The audio analytics techniques convert the primitive audio data into textual data streams through speech recognition processes. Once transcribed, the text can be segmented to figure out who spoke what and when, allowing for structured conversations to be documented and analyzed. After segmenting the audio into distinguishable parts for each participant, the key segment identification subsystem 214 assigns identities based on predefined criteria, such as the designated roles of the participants, contextual cues from the conversation, and possibly metadata (such as names or user images) associated with the interview participants. The key segment identification subsystem 214 stores the unique ID of the interview participants while joining the online meeting/interview. In an exemplary scenario, an interview scenario is considered for a software engineering position. The interview takes place using an online platform, where both audio and video streams are captured. During the interview, the following dialogue from interviewer “Can you explain a challenging project you've worked on?” and reply from the candidate “Yes, I developed a real-time data processing application that encountered significant scalability issues.” The audio stream is captured and processed using audio analytics techniques. The system identifies distinct speech patterns, analyzing factors such as pitch, tone, and frequency. Through this analysis, the key segment identification subsystem 214 identifies momentary pauses and vocal qualities that distinguish the candidate from the interviewer. Based on these audio patterns, the key segment identification subsystem 214 assigns: Speaker 1 as interviewer and Speaker 2 as candidate. In an embodiment, during the speaker diarization process, the key segment identification subsystem 214 identifies the interviewer and the candidate with the relevant details such as email, name, user thumbnail picture, and the like.

In an exemplary embodiment, the plurality of subsystems 114 further includes the data determination subsystem 216 that is communicatively connected to the one or more hardware processors 202. The data determination subsystem 216 may be configured to determine one or more sentiment parameters associated with the interviewer and the candidate, by analyzing the extracted video data. In an exemplary embodiment, the one or more sentiment parameters include, but not limited to, emotion, attitude, thought of the interviewer and the candidate, and the like. In determining the one or more sentiment parameters for the interviewer and the candidate by analyzing the extracted video data, the data determination subsystem 216 determines identity of the interviewer and the candidate by analyzing the extracted video data using a video analytics technique. For example, the actors/characters are assigned to the platform information with unique IDs, email, name, and user thumbnail pictures and the like. The video analytics analyzes the inactivity in a conversation and identifies any objects from the interview environment. Body language and communication effectiveness are analyzed. Further, the data determination subsystem 216 determines the one or more sentiment parameters corresponding to the determined identity of the interviewer and the candidate by performing sentiment analysis on the extracted video data.

In an exemplary embodiment, the data determination subsystem 216 may determine one or more attributes associated with each of the one or more interviews based on at least one of: the extracted audio data, the extracted video data, the one or more key segments, the one or more sentiment parameters, a job description and a resume of the candidate or any combination thereof, by using an interview optimization based Artificial Intelligence (AI) model. The data determination subsystem 216 captures audio and video data from interviews between candidates and interviewers. This includes verbal and non-verbal cues that are processed to discern various attributes relevant to each interview. The extracted audio data is transcribed to form text streams, which are further segmented into manageable parts representing specific conversations or key topics discussed during the interview. Similarly, video data is analyzed to gauge sentiment parameters, analyzing body language and facial expressions to capture emotional responses. Using various AI techniques, including natural language processing (NLP) and computer vision, the subsystem determines relevant attributes for the interview. This includes metrics such as talk ratios (amount of time candidates and interviewers speak), inactivity (periods of silence), and sentiment levels (positive or negative emotional engagement). Additionally, keywords from job descriptions and resumes are mapped against the interview segments to ascertain relevance.

The interview optimization based AI model utilizes the identified attributes to generate insights into the interview. It may apply machine learning techniques to allocate scores based on historical data related to candidate performance and hiring outcomes. The interview optimization based AI model computes, weights, and adjusts its predictions on the one or more attributes about which candidates are most suitable for specific roles based on their interview performance and interactions.

In an exemplary embodiment, the one or more attributes include, but are not limited to, talk ratio, inactivity, sentiment level, plurality of keywords, range, candidate at risk, questions asked by the interviewer during the one or more interviews, interview bias probability, relevance of the one or more interviews to the job description, company pitch, assessment report reference and the resume of the candidate and, timelines in the interview, the like. In case of a candidate at risk, if a candidate was spoken between the below-mentioned ratios, the candidate risk metric changes accordingly. For example, 10-35% or >80%-High (Red), 36-44% or 56% to 80% Medium (Amber) and 45-55%-Low (Green). The Ideal range may be between 45 to 55%.

In an exemplary embodiment, the talk ratio is ratio of time spent by the interviewer and the candidate in the one or more interviews. Inactivity is a time-period associated with the one or more interviews in which the interviewer and the candidate are in an ideal state. In an embodiment of the present disclosure, the determined identity of the interviewer and the candidate may also be used to determine the one or more attributes, such as the talk ratio and the inactivity. In an embodiment of the present disclosure, each of the one or more attributes may have a predefined score associated with it. In an exemplary scenario, an interview scenario is considered for a marketing manager position. An interviewer and candidate engage in a video conference, which is recorded for analysis. The audio from the interview is transcribed, revealing moments like interviewer asks, “What strategies have you used to increase brand awareness?” and the candidate replies “In my previous role, I implemented a multi-channel marketing approach that integrated social media and email campaigns.” The audio and video analytics tools analyze the candidate's talk ratio. If the candidate spoke approximately 70% of the time during discussions related to relevant job duties, it indicates on-topic engagement and enthusiasm. The data determination subsystem 216 generates attributes such as talk ratio as 70%, inactivity as 10 seconds silent pauses (indicating thoughtful consideration), and sentiment level as positive (indicated by the candidate's enthusiastic tone and appropriate body language).

The interview optimization based AI model compares the identified keywords from the interview with those in the job description and resume, determining the candidate's fit for the role. If relevant keywords are covered extensively, the outcome suggests relevancy and competence. Consequently, the data determination subsystem 216 recommends this candidate as a strong fit for the role based on their interview performance metrics as processed through the interview optimization based AI model.

In obtaining relevance of the one or more interviews to the job description, the company pitch, the assessment report reference and the resume of the candidate, the data determination subsystem 216 extracts the plurality of keywords from the job description, the company pitch, the assessment report reference, and the resume of the candidate. Further, the data determination subsystem 216 maps the extracted plurality of keywords with the plurality of segments. The data determination subsystem 216 determines relevance of the one or more interviews to the job description, the company pitch, the assessment report reference, and the resume of the candidate based on the result of mapping. For example, when most of the extracted plurality of keywords are covered in the plurality of segments, it may be said that the one or more interviews are relevant to the job description, the company pitch, the assessment report reference, and the resume of the candidate. In an embodiment of the present disclosure, the data determination subsystem 216 may also identify where each of the extracted plurality of keywords is used in the one or more interviews.

In an exemplary embodiment, the data determination subsystem 216 may determine one or more interview structural parameters and one or more interview practice parameters in each of the one or more interview structural parameters, based on the determined one or more attributes. In an exemplary embodiment, the one or more interview structural parameters includes, but not limited to, introduction of the interviewer and the candidate, discussion between the interviewer and the candidate, conclusion of the interviewer and the candidate, and the like.

In an exemplary embodiment, the data determination subsystem 216 may annotate the plurality of segments based on the determined one or more interview structural parameters and the one or more interview practice parameters. In an exemplary embodiment, the data determination subsystem 216 may identify the one or more key segments from the annotated plurality of segments for an interested action of the interviewer. In an exemplary embodiment, the data determination subsystem 216 may identify one or more key topics corresponding to the identified one or more key segments based on the one or more attributes, to at least one of generation and augmentation a skill graph for matching of the candidates to an opportunity. The one or more key topics refer to the significant themes or subject matters that emerge from the transcription and analysis of key segments during the interviews. The one or more key topics are derived from analyzing the attributes determined through various data points such as audio and video data, sentiment analysis, and candidate information, thus helping to create a structured understanding of the dialogue. A skill graph is a structured representation of skills associated with various jobs, indicating how skills relate to one another and identifying potential growth paths for candidates based on their experiences and qualifications. The identification of key topics helps in generating or augmenting this skill graph to match candidates' qualifications with job opportunities effectively.

The data determination subsystem 216 captures data from interviews, including audio and video recordings. The data determination subsystem 216 then extracts relevant segments identified as pivotal during the conversations. Through the interview optimization based AI model, attributes such as talk ratio, sentiment levels, keywords from resumes, and job descriptions are assessed. This information provides context around how candidates respond to questions, enabling the detection of the one or more key topics during discussions. The identified attributes lead to the determination of the one or more key topics linked to specific roles, responsibilities, or skills relevant to the job position. For instance, if a candidate discusses leadership frequently, the model may derive “leadership” as a key topic. Once key topics are identified, they are mapped onto a skill graph. This graph showcases how identified skills relate to particular job roles, including the relevant experiences that candidates have discussed during the interviews. The data determination subsystem 216 assimilates external databases of skill graphs, ensuring that the identified skills align with contemporary demands in the job market. With the skill graph in place, candidates can be matched more effectively to job openings based on their discussed experiences and skills, facilitating more accurate recruitment decisions.

In an exemplary scenario, consider a software engineer candidate involved in a structured interview process. A panel interviews the candidate and various segments reveal discussions on programming languages, teamwork, and project management. The interview optimization based AI model assesses attributes, resulting in the identification of attributes such as talk ratio as 60% (candidate talk), and sentiment level as Positive (indicated by enthusiasm while discussing a past project). The key topics are identified from the conversation include “python programming”, “agile project management”, and “collaboration and teamwork”. These identified key topics are mapped onto a skill graph which illustrates the relationship between the software engineering role, the skills needed (e.g., proficiency in python, understanding of Agile methodologies), and candidate experiences. Using this skill graph, the data determination subsystem 216 can identify suitable job opportunities aligning with the individual's demonstrated skills and discussed topics. If the candidate expressed substantial experience in using python and agile practices, they would be presented as highly matched for roles requiring those skills.

In an exemplary embodiment, the plurality of subsystems 114 further includes the insight generation subsystem 218 that is communicatively connected to the one or more hardware processors 202. The insight generation subsystem 218 may be configured to generate an interview summary for the interested action of the interviewer. In an exemplary embodiment, the interested action includes, but not limited to, an action of an inference of topics discussed in the interview, an action of a preparation of upstream notes of the one or more interviews, and the like.

In an exemplary embodiment, the insight generation subsystem 218 may generate one or more interview insights comprising a comparison of the one or more interview insights for each of the one or more interviews with an average ratio of pre-determined insights, for the one or more attributes. In an exemplary embodiment, the one or more interview insights include, but are not limited to, language insights, situational judgment insights, diversity, equity, and inclusion (DEI) insights, legal risk and compliance insights, interview bias probability insights, domain insights, and the like.

In an exemplary embodiment, the insight generation subsystem 218 may map skills discussed in the interview with a skill graph based on the identified one or more key topics, to determine if there is sufficient topic coverage for the topics to be discussed in each of the one or more interviews.

In an exemplary embodiment, the plurality of subsystems 114 further includes the score generating subsystem 220 that is communicatively connected to the one or more hardware processors 202. The score card generation subsystem 220 may be configured to generate a score card associated with the interviewer comprising one or more interviewer profile parameters based on the determined one or more attributes and predefined criteria by using the interview optimization-based AI model. In an exemplary embodiment, the one or more profile parameters include, but not limited to, interview evaluations, number of interviews completed, learning score, number of comments, average candidate rating, time to interview, offer acceptance rate, select or reject ratio, average repeated questions per interview, compliance with guidance, interviewer learning path recommendation, and the like. The interview evaluations may be the number of interview evaluations completed by an interviewer; the leaning score may be the interview learning score for an Interviewer (computed based on the completion of learning path assessments). The number of comments includes comments that may be received for an interviewer from past candidates during interviewer feedback. The average candidate rating may be computed based on each candidate's interviewer feedback rating. The compliance with guidance is when an interviewer will have Interview guidelines check-list, the score generating subsystem 220 analyzes whether Interview is meeting with Interview Guidelines. The interviewer learning path recommendation refers to path or stage when every Interviewer goes through an assessment, to assess an interviewer in certain areas such as diversity, equity, and inclusion (DEI) readiness, Domain Knowledge, interviewing techniques, candidate experience, and the like. The offer acceptance rate is the rate at which job offers are accepted by the candidates. Further, the select or reject ratio is a ratio at which the interviewer selects the candidates. In an exemplary embodiment, the predefined criteria may be used to obtain the compliance with guidance. In generating the score card associated with the interviewer including the one or more interviewer profile parameters based on the determined one or more attributes and the predefined criteria by using the interview optimization-based AI model, the score generating subsystem 220 generates one or more scores corresponding to each of the one or more attributes based on the determined one or more attributes and the predefined criteria by using the interview optimization-based AI model. Further, the score generating subsystem 220 generates the score card for the generated one or more scores by using the interview optimization-based AI model.

The score card generation process is an integral component of the computer implemented system 112 designed to evaluate the effectiveness of interviewers based on predetermined metrics and the attributes derived from the interviews they conduct. The score card aims to provide insight into interviewer performance through quantitative measures, which can help improve hiring processes and decision-making. The interviewer profile parameters are specific metrics used to assess each interviewer's performance and include at least one of: interview evaluations (assessments based on feedback from candidates), number of interviews completed (total interviews conducted by the interviewer), learning score (a metric indicating how well the interviewer adapts and learns from feedback), candidate ratings (average ratings provided by the candidates after the interviews), and offer acceptance rate (the proportion of job offers accepted following the interviews).

The score generating subsystem 220 determines various attributes associated with interview performance, which may include talk ratio, inactivity during interviews, sentiment levels of interactions, and relevance of discussions related to the job description. These attributes are critical in evaluating the effectiveness of an interviewer. The evaluation metrics are based on predefined criteria set by the organization. These criteria can encompass standards for what constitutes a successful interview, such as candidate engagement levels and adherence to interviewing best practices. Utilizing the interview optimization based AI model, the score generating subsystem 220 computes scores for each identified attribute based on their significance to the interview process. This calculation may involve weights that reflect the importance of certain parameters over others. The score generating subsystem 220 then compiles these scores into an accessible format, producing a score card that reflects an overall assessment of the interviewer's performance. This can be visualized or outputted through a user interface so that interviewers can access it, review feedback, and take necessary steps for improvement.

In an exemplary scenario, consider an example where an interviewer, Jane Doe, conducts a series of interviews for a project manager position. Jane conducts ten interviews over a month. Each interview is analyzed, measuring attributes such as talk ratio as 55% (i.e., the percentage of time Jane spoke relative to candidates), average candidate rating as 4.2/5 based on feedback collected from the candidates on their experience, offer acceptance rate as 70% (of candidates who received offers, 7 accepted), and learning score as 87% based on Jane's participation in learning and feedback training sessions.

The score generating subsystem 220 processes data, determines attributes such as inactivity measured during interviews averages 15 seconds, suggesting responsiveness, and sentiment analysis that reflects a positive engagement trend, indicated by the tonal reception of candidate responses. Using predefined benchmarks for successful interviews, Jane's scores might break down as follows: talk ratio score as 80 out of 100, candidate rating score as 85, and offer acceptance score 90. The score generating subsystem 220 compiles these scores and produces a score card stating “Interviewer: Jane Doe, and the score overview as Talk Ratio: 80, Average Candidate Rating: 85, Offer Acceptance Rate: 90, and learning path recommendation: input on engagement strategies suggested”. This score card is not only outputted to a graphical user interface for Jane but also stored in the system for HR review, contributing to ongoing training and development strategies.

In an exemplary embodiment, the plurality of subsystems 114 further includes the output subsystem 222 that is communicatively connected to the one or more hardware processors 202. The output subsystem 222 may be configured to output the determined one or more attributes, the generated score card, the interview summary, the one or more interview insights, and the skill graph on a graphical user interface of the one or more electronic devices 102 associated with the interviewer. In an embodiment of the present disclosure, the interviewer may use the output one or more attributes and the score card for training himself/herself. Further, the output subsystem 222 outputs one or more notifications corresponding to the extracted plurality of keywords on the graphical user interface of the one or more electronic devices 102 based on the mapping of the extracted plurality of keywords with the plurality of segments.

In an embodiment of the present disclosure, the output subsystem 222 outputs the one or more notifications corresponding to the extracted plurality of keywords for ascertaining that all the extracted plurality of keywords are covered by the interviewer during the one or more interviews. For example, when the interviewer forgets to cover keywords related to the job description, the output subsystem 222 outputs the one or more notifications corresponding to the keywords related to the job description. The one or more notifications may be in the form of visual, audio, audio visual and the like. In an exemplary embodiment of the present disclosure, the one or more notifications include one or more images with the plurality of keywords, one or more cues with the plurality of keywords and the like. In an embodiment of the present disclosure, the one or more notifications may be output in real-time.

In an exemplary embodiment, the plurality of subsystems 114 further includes the training subsystem 224 that is communicatively connected to the one or more hardware processors 202. The training subsystem 224 is configured to provide offer acceptance and job performance of the candidate selected by the interviewer as inputs to the interview optimization-based AI model for training. In an embodiment of the present disclosure, when the interview optimization-based AI model is trained based on the offer acceptance and job performance of the candidate selected by the interviewer, the interview optimization-based AI model may determine success rate of the interviewer in selecting the candidate. For example, when the job performance of the candidate selected by the interviewer is good, the success rate of the interviewer is high. Further, when the job performance of the candidate selected by the interviewer is poor, the success rate of the interviewer is low.

The training subsystem 224 is configured to collect metrics that are crucial for the optimization of interview processes. Specifically, it gathers two primary inputs: the offer acceptance rate and the job performance of candidates selected by interviewers. These inputs are essential for refining the interview optimization based AI model's predictive capabilities on candidate selection effectiveness. The training subsystem 224 captures data regarding candidates' post-interview, focusing on their job performance as evaluated through performance reviews and metrics set by the employing organization. In parallel, the offer acceptance rate is monitored to determine how frequently selected candidates accept job offers. Once the data is collected, the training subsystem 224 is organized to align with the inputs required for the interview optimization based AI model. This typically involves quantifying job performance through established metrics (e.g., performance ratings, productivity levels) and computing offer acceptance rates against historical datasets to ensure a comprehensive training dataset. The interview optimization based AI model undergoes training using the prepared datasets. During this phase, various machine learning algorithms assess relationships between the indicators of interviewer success (composed of job performance and offer acceptance) and the attributes derived from past interview data. For instance, if a particular interviewing style corresponds with higher acceptance rates or better job performance, the model learns to strengthen this association. As the interview optimization based AI model learns from various scenarios across multiple candidates, the interview optimization based AI model establishes predictive patterns that correlate interviewer actions (like the types of questions asked or the flow of conversation) and outcomes (candidate performance and their decisions to accept job offers).

Throughout the training, the interview optimization based AI model is continuously refined based on new data inputs. As the organization hires more candidates and collects new performance data, the training subsystem 224 integrates this information to enhance the model's accuracy. The iterative nature of machine learning ensures that the model remains relevant over time, adapting to changes in industry standards and hiring practices. Once trained, the interview optimization based AI model generates insights and metrics that aid interviewers in refining their approaches. For example, if the data indicates that interviewers who ask competency-based questions more strategically achieve higher job performance ratings and candidate acceptance, this feedback loop is crucial for training and ongoing interviewer development.

In an exemplary scenario, a hypothetical scenario is considered where the organization repeatedly hires software developers. The training subsystem 224 collects performance data over several months, noting that the candidates who were selected by specific interviewers score an average of 4.7 out of 5 on their performance evaluations, and of the candidates selected, 90% accept their offers. Using the inputs, the interview optimization based AI model may learn that the candidates respond positively to a particular interviewing style that emphasizes problem-solving exercises and project-based queries. The interview optimization based AI model may further learn Interviewers who consistently employ this approach tend to reflect an increased offer acceptance rate and robust job performance. Through repeated cycles of training, the interview optimization based AI model enhances its predictive accuracy, allowing for continuous improvement in selection strategies. This training process of the interview optimization based AI model is pivotal in bridging the gap between candidate selection and organizational success, ultimately leading to better hiring outcomes.

FIG. 2B illustrates an exemplary block diagram representation of the computer implemented system 112, such as those shown in FIG. 1, capable of generating the one or more offer ranges in the interviewing process, in accordance with an embodiment of the present disclosure.

The plurality of subsystems 114 further includes an AI-based interviewer generating subsystem 226, a data analyzing subsystem 228, a data processing subsystem 230, a query generating subsystem 232, and a decision supporting subsystem 234.

The plurality of subsystems 114 further includes the AI-based interviewer generating subsystem 226 that is communicatively connected to the one or more hardware processors 202. The AI-based interviewer generating subsystem 226 refers to a technological framework designed to create an AI-based interviewer that simulates human interactions. The AI-based interviewer generating subsystem 226 conducts ongoing interviews with the one or more candidates in a manner that mirrors traditional human interviewers, allowing for a more engaging and effective assessment process. The AI-based interviewer generating subsystem 226 autonomously generates an AI-driven interviewer that can interact with multiple candidates. The AI-based interviewer generating subsystem 226 engages them through dialogue that resembles human conversation. The AI-based interviewer generating subsystem 226 is equipped with advanced algorithms and natural language processing (NLP) capabilities to ask competency-based questions, adapt based on candidate responses, and provide follow-up questions that enhance the depth of the interview.

The AI-based interviewer generating subsystem 226 often features a lifelike avatar, which visually represents an interviewer. This avatar engages with the one or more candidates in a manner that feels personal and relatable. The AI-based interviewer generating subsystem 226 is configured to analyze both verbal answers and non-verbal cues (such as facial expressions and body language) to assess candidate responses comprehensively. The AI-based interviewer generating subsystem 226 is configured to utilizes a conversation engine that dynamically adjusts the flow of the interview based on candidate inputs. This ensures that the conversation remains relevant and encompasses the nuances of candidate replies.

In an exemplary scenario, a technology company is hiring for a software developer position and uses the AI-based interviewer subsystem 226. The company configures the AI-based interviewer subsystem 226 to conduct initial screening interviews for a batch of candidates applying for the role. As the candidates enter the virtual interview, the AI-based interviewer subsystem 226 greets them through an avatar and initiates the conversation by asking a series of job-specific questions, such as: “Can you explain the software development lifecycle?” or “What programming languages are you proficient in?”. As the candidates respond, the AI-based interviewer subsystem 226 analyzes not only the content of the verbal answers but also their non-verbal cues. For example, if a candidate shows signs of hesitation or uncertainty, the AI-based interviewer subsystem 226 might follow up with a clarifying question like “Could you elaborate on your experience with that programming language?”.

After the interviews, the AI-based interviewer subsystem 226 provides a structured report that includes a scoring evaluation based on the candidates' responses, highlighting competencies and areas for improvement. The insights generated by the AI-based interviewer subsystem 226 assist the hiring managers in making data-driven recruitment decisions, enhancing the efficiency and effectiveness of the hiring process.

For generating the AI-based interviewer, the AI-based interviewer generating subsystem 226 is configured to identify one or more objectives of the AI-based interviewer by creating one or more interactive visual representations conducting the ongoing interview effectively. The one or more interactive visual representations help in illustrating the one or more objectives of the interview, such as assessing a candidate's technical skills, communication abilities, or cultural fit. These one or more interactive visual representations can include flowcharts, graphs, or avatars that guide the direction of the ongoing interview. For example, during an interview, the AI-based interviewer displays a visual roadmap showing the main competencies being evaluated such as teamwork, problem-solving, and adaptability, thereby keeping both the interviewer and candidate aligned on the focus areas throughout the discussion.

The AI-based interviewer generating subsystem 226 is further configured to generate a lifelike AI-based interviewer based on user personas relevant to one or more targeted interview domains comprising at least one of: one or more job roles and industries. This feature allows the AI-based interviewer generating subsystem 226 to create a realistic AI avatar tailored to specific user personas relevant to the interview domains, ensuring authenticity in simulated interactions. By utilizing demographic data and desired characteristics of the interviewer, the AI-based interviewer generating subsystem 226 generates avatars that closely resemble human interviewers in appearance, mannerisms, and interaction styles. This personalization enhances relatability and comfort for candidates. For example, a financial firm may opt for an AI interviewer with a professional appearance and demeanor, tailored to embody the characteristics of a seasoned financial analyst, thus making candidates feel more at ease during technical discussions.

The AI-based interviewer generating subsystem 226 is further configured to generate a visually appealing AI-based interviewer reflecting an identity and desired competencies of a human interviewer using a three dimensional modelling application. The AI-based interviewer generating subsystem 226 creates a visually attractive AI avatar that represents the identity and traits of a human interviewer through advanced three-dimensional modeling tool. By employing 3D modeling techniques, the AI-based interviewer can be expressed in a visually engaging manner that incorporates realistic aspects such as facial expressions and body language, further enhancing the realism of the interaction. For example, an AI avatar for a creative role in advertising could be designed with a trendy appearance and dynamic gestures to reflect the company's innovative culture and attract similarly minded candidates.

The AI-based interviewer generating subsystem 226 is further configured to perform at least one of: analyzing one or more inputs, processing the one or more inputs, and responding to the one or more inputs of the one or more candidates in real-time, by integrating one or more NLP capabilities within the AI-based interviewer. The AI-based interviewer generating subsystem 226 enables the AI-based interviewer to analyze, process, and respond to candidate inputs in real-time using Natural Language Processing (NLP) technologies. By integrating NLP, the AI-based interviewer can understand and interpret candidate responses, formulate follow-up questions, and maintain the flow of conversation in a human-like manner, enhancing interaction quality. For example, if a candidate mentions a specific project during the interview, the AI-based interviewer can recognize and inquire further about that project, thereby creating a more engaging discussion tailored to the candidate's experience.

The AI-based interviewer generating subsystem 226 is further configured to train the AI-based interviewer with a set of competency-based questions and the one or more follow-up interview questions, relevant to a career path of the one or more candidates using the one or more ML models. The AI-based interviewer generating subsystem 226 equips the AI-based interviewer with a curated set of competency-based questions and relevant follow-up inquiries targeted to specific career paths. By leveraging the one or more machine learning models, the AI-based interviewer can adaptively apply these questions during interviews, ensuring that they are pertinent and aligned with the candidate's skills and experiences. For example, for a software engineering role, the AI-based interviewer might ask about proficiency in coding languages and then follow up with scenario-based questions assessing problem-solving skills.

The one or more ML models require large datasets to learn from, particularly when creating competency-based questions and responses. The AI-based interviewer generating subsystem 226 leverages datasets that align with specific career paths, facilitating training that is well-suited to the context in which candidates will be evaluated. Different ML techniques may be employed based on the nature of the questions being asked. For instance, classification models might be used to categorize candidates based on their responses (e.g., identifying strengths or weaknesses), while regression models could assess the qualitative impact of those responses on overall candidate scoring. NLP algorithms are integral to interpreting candidate responses accurately. These ML models help in the generation of follow-up questions that reflect the language and context of the previous responses, enhancing both the relevance and depth of the conversation.

The ML model may be decision tree algorithms that are often used to create structured pathways for follow-up questions based on candidate responses. This method allows for clear decision-making criteria rooted in candidate answers. For example, if a candidate answers a technical question correctly, the decision tree might prompt a follow-up that explores the depth of their understanding, such as, “Can you provide an example where you applied this skill in a project setting?”. The ML model may be Support Vector Machines (SVM) that is employed for classification purposes, where candidate responses are classified into predefined categories of competencies (e.g., technical skill, communication, teamwork). For example, if a candidate demonstrates strong interpersonal skills in their response, the AI-based interviewer generating subsystem 226 could classify that response accordingly and delve deeper with a follow-up like, “What strategies do you use to foster collaboration in a team environment?”. The ML model may be neural networks that provide advanced capabilities, especially in analyzing complex response patterns and nuances in natural language. For example, a scenario where a candidate discusses a challenging situation, a neural network model could analyze the emotional tone of the response and generate empathetic follow-ups, such as, “That sounds quite challenging; what did you learn from that experience?”. The ML model may be reinforcement learning approach that allows the ML model to learn and improve over time based on interactions. By evaluating which follow-up questions yield better responses and candidate satisfaction, the ML model tunes its questioning strategy accordingly. For example, if certain communication styles or types of follow-up questions consistently yield more engaging responses, the ML model may adapt to favor these in future interactions.

The AI-based interviewer generating subsystem 226 is further configured to utilize one or more behavioral models to guide one or more interactions of the AI-based interviewer to emulate human-like behaviors comprising at least one of: changing tone, expressing empathy, providing facial expressions, and adjusting emotional responses, based on the responses from the one or more candidates. This approach enhances realism in interviews by allowing the AI-based interviewer to respond to emotional cues from candidates, making interactions feel more genuine and supportive. For example, if a candidate shows apprehension while discussing a challenging project, the AI-based interviewer might soften its tone and express encouragement, thus creating a supportive environment.

The AI-based interviewer generating subsystem 226 is further configured to implement a conversation engine for the AI-based interviewer to adapt for follow-up questions based on the responses from the one or more candidates, using the AI model. By utilizing a sophisticated conversation engine, the AI-based interviewer can generate contextually relevant inquiries that delve deeper into topics of interest or concern raised by candidates during the interview. The AI model utilized in the AI-based interviewer generating subsystem 226 serves as the core mechanism powering the conversation engine, which allows for dynamic and adaptive interactions during interviews. This AI model facilitates the generation of follow-up questions tailored to the specific responses of candidates, effectively mimicking a human interviewer's adaptive questioning techniques. The AI model is designed to assess candidate responses in real-time. By analyzing keywords, emotional tone, and contextual relevance in candidate answers, the AI model can determine the most appropriate follow-up questions. This adaptability enhances the natural flow of conversation and ensures that each interaction is uniquely tailored to the candidate's input. The AI model employs advanced NLP techniques to understand and interpret the nuances in candidate responses. This capability enables the AI to engage in meaningful dialogue, develop deeper insights into the candidate's qualifications and experiences, and produce relevant follow-up inquiries. The AI model takes into account the context of the conversation, including the specific job role and competencies being assessed. This ensures that follow-up questions are not only relevant to the immediate response but also aligned with broader interview objectives, such as evaluating technical skills or cultural fit.

Modern AI models, such as those based on the Transformer architecture (e.g., Bidirectional Encoder Representations from Transformers (BERT), Generative Pre-trained Transformer (GPT)), are often employed for their proficiency in understanding context and generating human-like text. In the AI-based interviewer, a transformer model could analyze a candidate's response to a technical question and produce a follow-up that probes deeper into the candidate's methodology or problem-solving process. For example, If a candidate explains their approach to a complex coding challenge, the AI model might generate a follow-up question like, “Can you describe an instance where your approach did not work as expected, and what you learned from it?”. The AI model may be reinforcement learning model that enhances the conversation engine by learning from interaction outcomes to improve future responses. They can evaluate various follow-up questions based on previous candidate interactions, thus refining the AI-based interviewer's ability to engage effectively. For example, If certain follow-up questions lead to positive engagements with candidates, the AI adjusts to favor similar questions in subsequent interviews, improving the overall candidate experience and gathering richer data for evaluations.

The AI model may be Bidirectional Encoder Representations models like BERT using a bidirectional context to understand the sentence structure and meaning effectively. The AI-based interviewer can utilize this AI model to ensure the follow-up questions are contextually appropriate and linguistically coherent. For example, when a candidate discusses working on a team project, the AI might ask, “How did you handle differing opinions within the team?” This question captures the dynamics of the conversation while allowing for a comprehensive assessment of interpersonal skills.

The AI-based interviewer generating subsystem 226 is further configured to synchronize at least one of: lip movements, gestures, and the facial expressions, of the AI-based interviewer with verbal communication of the AI-based interviewer during the ongoing interview, using a visual and audio synchronization technique. By utilizing visual and audio synchronization techniques, the AI-based interviewer ensures that its physical demeanor aligns with verbal communication, enhancing the perception of realism. For example, if the AI-based interviewer states, “I appreciate your detailed answer,” its avatar simultaneously smiles and nods, reinforcing positive feedback and engagement.

The AI-based interviewer generating subsystem 226 is further configured to generate a natural sounding voice matching a visual persona of the AI-based interviewer using a speech synthesis technology. The AI-based interviewer generating subsystem 226 employs the speech synthesis technologies to create a voice for the AI-based interviewer that aligns with its visual persona, contributing to a seamless interaction. By matching the voice characteristics to the avatar's persona considering tone, pitch, and accent, the AI interviewer's communication becomes more coherent and relatable. For example, for a friendly and approachable avatar, the AI-based interviewer may utilize a warm and inviting voice that encourages candidates to express themselves more freely during the conversation.

Upon generating the AI-based interviewer, the data obtaining subsystem 210 is configured to obtain the data associated with the one or more candidates through at least one of: the one or more image capturing devices 108 and the one or more audio devices (e.g., the one or more microphones 110), during the ongoing interview. In other words, the data obtaining subsystem 210 is a component of an computer implemented system 112 designed to gather various types of data associated with the one or more candidates during the ongoing interviews. This data can be collected through multiple interfaces, such as image capturing devices 108 (e.g., cameras) and audio devices (e.g., microphones 110), and encompasses candidate profile information, audio and text responses, and non-verbal cues.

In an aspect, the AI-based interviewer generating subsystem 226 generates a visually appealing AI-based interviewer reflecting an identity and desired competencies of the human interviewer using a three dimensional modelling application. The AI-based interviewer generating subsystem 226 creates a lifelike 3D mesh model with detailed facial geometry, including individual facial muscles, bone structure, and skin surface topology optimized for realistic expression rendering. The AI-based interviewer generating subsystem 226 generates a lifelike AI-based interviewer based on user personas relevant to targeted interview domains comprising job roles and industries. The 3D modeling process incorporates demographic characteristics, professional appearance standards, and cultural appropriateness factors to create avatars that candidates can relate to and feel comfortable interacting with.

The AI-based interviewer generating subsystem 226 implements a comprehensive facial rigging system with blend shapes and bone-based deformation controls for precise facial expression manipulation. The 3D avatar includes morph targets for fundamental expressions (happiness, concern, interest, empathy) and micro-expressions that convey subtle emotional nuances during interview interactions. The AI-based interviewer generating subsystem 226 synchronizes lip movements with verbal communication during the ongoing interview using visual and audio synchronization techniques. The AI-based interviewer generating subsystem 226 analyzes generated speech content at the phoneme level, mapping each speech sound to corresponding viseme (visual phoneme) representations that drive lip and mouth movements.

The AI-based interviewer generating subsystem 226 generates a natural sounding voice matching a visual persona of the AI-based interviewer using speech synthesis technology. Simultaneously, the TTS engine provides phoneme timing data that drives the 3D avatar's lip synchronization, ensuring precise alignment between audio output and visual mouth movements. The synchronization process operates in real-time, with the AI-based interviewer generating subsystem 226 processing LLM-generated text through the TTS pipeline while simultaneously calculating lip movement trajectories. The 3D avatar's mouth geometry deforms according to phoneme sequences, creating natural-looking speech articulation that matches the generated audio output.

The AI-based interviewer generating subsystem 226 synchronizes gestures of the AI-based interviewer with verbal communication during the ongoing interview. The AI-based interviewer generating subsystem 226 analyzes LLM-generated content for contextual cues that trigger appropriate hand and arm movements, such as counting gestures for enumerated points or descriptive gestures for spatial concepts. The AI-based interviewer generating subsystem 226 utilizes behavioral models to guide interactions of the AI-based interviewer to emulate human-like behaviors including gestures based on responses from candidates. The 3D avatar's gesture library includes professional interview-appropriate movements such as open-palm gestures for welcoming responses, pointing for emphasis, and supportive hand positions during candidate responses. The synchronization system ensures that gestures begin slightly before corresponding verbal content, mimicking natural human communication patterns. The 3D avatar's gesture animations include realistic acceleration and deceleration curves, avoiding robotic movements through smooth interpolation between gesture states.

The AI-based interviewer generating subsystem 226 utilizes behavioral models to guide interactions and emulate human-like behaviors including providing facial expressions based on responses from candidates. The AI-based interviewer generating subsystem 226 processes emotional context from LLM outputs and candidate analysis to select appropriate facial expressions that convey empathy, interest, concern, or encouragement. The 3D avatar system blends multiple facial expressions simultaneously to create nuanced emotional displays. For example, the avatar might combine slight concern (furrowed brow) with encouragement (slight smile) when a candidate struggles with a difficult question, creating a supportive yet attentive expression. The AI-based interviewer generating subsystem 226 incorporates subtle micro-expressions that enhance the avatar's believability, such as brief eyebrow raises during candidate responses, slight head tilts indicating active listening, and periodic blinking patterns that appear natural rather than mechanical.

The AI-based interviewer generating subsystem 226 utilizes behavioral models to guide interactions including changing tone based on responses from candidates. The TTS engine modifies vocal parameters such as pitch, pace, volume, and intonation to match the emotional context determined by the LLM and candidate analysis systems. The AI-based interviewer generating subsystem 226 adjusts emotional responses based on candidate feedback, with the TTS system reflecting these adjustments through vocal tone changes. For nervous candidates, the avatar may speak more slowly with a warmer tone; for confident candidates, it may use a more direct, professional tone. The AI-based interviewer generating subsystem 226 incorporates natural speech patterns including appropriate pauses, emphasis on key words, and conversational rhythm that matches the 3D avatar's visual presentation. The TTS engine synchronizes with facial animation systems to ensure that vocal stress patterns align with facial expressions and lip movements.

The AI-based interviewer generating subsystem 226 implements a real-time rendering pipeline that processes LLM outputs through multiple synchronized channels such as text analysis for content understanding, TTS conversion for audio generation, phoneme extraction for lip sync, emotional analysis for facial expressions, and contextual analysis for gesture selection. The AI-based interviewer generating subsystem 226 coordinates all avatar components to ensure temporal alignment between audio output, lip movements, facial expressions, and gestures. The synchronization framework maintains consistent timing across all modalities, preventing visual-audio desynchronization that could break immersion or appear unnatural.

In an exemplary scenario, in a virtual interview setting, the AI-based interviewer begins with a greeting: “Hello!I appreciate you taking the time to speak with me today. “As it speaks, the AI-based interviewer generating subsystem 226 accurately synchronizes the lips of the avatar to this statement, creating a realistic lip movement that matches the speech output. Moreover, the avatar smiles warmly while delivering the opening line, reinforcing a friendly atmosphere.

As the interview progresses, a candidate answers a technical question regarding a programming challenge they faced. The AI-based interviewer, utilizing advanced natural language processing capabilities, analyzes this response for content and emotional tone. If the candidate expresses hesitation or uncertainty (for instance, saying, “I . . . I initially struggled with understanding the requirements”), the AI avatar subtly tilts its head to one side, conveying empathy through body language. Following the candidate's response, the AI-based interviewer may ask a follow-up question like: “Can you elaborate on the strategies you used to overcome those challenges?” In this moment, the AI ensures that the lip movements and gestures align with the tonal quality of the voice generated using text-to-speech (TTS) technology. The AI-based interviewer generating subsystem 226 employs phoneme synchronization to ensure that the vocalization of the follow-up question matches the avatar's lip movements.

The data obtaining subsystem 210 continuously collects the data throughout the interview process, ensuring a comprehensive dataset for each candidate. The data obtaining subsystem 210 employs image capturing devices 108 to gather visual data and audio devices 110 for capturing spoken responses. This dual data collection enhances the depth and quality of evaluation. In an embodiment, the profile information pertains to candidates' resumes, qualifications, and other relevant background information preloaded into the system. The audio responses may be verbal answers given by the one or more candidates in response to interview questions, which are recorded and processed for assessment. The text responses may refer to written answers or comments submitted by the one or more candidates during the ongoing interview, particularly in interactive formats. The non-verbal cues interpreted by the data obtaining subsystem 210, are visual data to assess non-verbal communication such as facial expressions, body language, and gestures, contributing to a holistic understanding of the candidate's engagement and confidence levels. The data collected by the data obtaining subsystem 210 feeds into analysis algorithms which assess the responses and non-verbal cues, aiding in the overall evaluation process and facilitating generation of follow-up questions or insights.

In an exemplary scenario, a healthcare organization is using an AI-powered hiring platform to candidates for nursing positions. During the ongoing interview, each candidate is connected to the computer implemented system 112 equipped with a webcam 108 and a microphone 110. As a candidate responds to questions like “What would you do in a high-pressure situation involving a patient?”, the AI-based interviewer generating subsystem 226 captures their spoken answers via the microphone 110. At the same time, the camera 108 records the candidate's expressions and posture, documenting cues such as smiles, frowns, or signs of nervousness. The AI-based interviewer generating subsystem 226 compiles the candidate's profile information (e.g., their qualifications and previous relevant experience). The AI-based interviewer generating subsystem 226 records the audio responses directly for later analysis and generates transcriptions for textual review. The AI-based interviewer generating subsystem 226 analyzes the non-verbal cues in real-time to indicate levels of confidence, stress, or engagement.

After the interviews, the AI-based interviewer generating subsystem 226 generates a report that includes not only the candidates' verbal proficiency through their audio responses but also insights derived from their non-verbal behaviors. This report assists the hiring managers in refining their candidate selection based on comprehensive data. By employing this data obtaining subsystem 210, the organization gains richer insights into candidates' qualifications and demeanor, leading to well-informed hiring decisions that go beyond traditional interviews.

The plurality of subsystem 114 further includes the data analyzing subsystem 228 that is communicatively connected to the one or more hardware processors 202. The data analyzing subsystem 228 is a crucial component within the computer implemented system 112 that is responsible for analyzing data associated with the one or more candidates obtained during the ongoing interview sessions. This analysis comprises the processing of candidates' responses using natural language processing (NLP) techniques and interpreting their non-verbal cues to provide comprehensive insights into their performance and suitability for the position.

For analyzing the data associated with the one or more candidates obtained during the ongoing interview, the data analyzing subsystem 228 is configured to process the responses of the one or more candidates using the natural language processing (NLP) techniques, by obtaining the data associated with the one or more candidates. The audio data is processed using a speech recognition model, which converts spoken words into written text. This textual transformation serves as the foundation for subsequent analyses. The resulting text is then segmented into tokens (i.e., individual elements such as words or phrases), allowing for a more detailed analysis of the structure and content. Each token is tagged with corresponding grammatical roles (e.g., nouns, and verbs) to dissect the grammatical structure of candidates' responses, aiding in a deeper understanding of their language use.

The data analyzing subsystem 228 is further configured to analyze an emotional tone of the responses comprising at least one of: positive, neutral, and negative emotions, to provide one or more insights into attitudes and feelings of the one or more candidates, using the one or more ML models.

In the context of the data analyzing subsystem 228, the one or more machine learning (ML) models play a pivotal role in interpreting the emotional tone of candidates' responses. These ML models are designed to classify sentiments expressed in the candidates' spoken or written answers into specific categories: positive, neutral, or negative emotions. The analysis of emotional tone provides crucial insights into candidates' attitudes and feelings, enhancing the recruitment process. The process begins with collecting candidates' responses, which may include audio or text data from their answers to interview questions. This input serves as the foundation for emotional tone analysis. The audio is transcribed into text (if applicable), followed by tokenization (breaking the text into smaller units) to prepare the data for analysis. One or more relevant features are extracted from the text, which may include word choice, sentence structure, and use of emotional language. This phase is critical, as it identifies indicators of emotional states.

The one or more ML models including at least one of: Support Vector Machines (SVM), Naïve Bayes classifiers, or neural networks, are trained on a labeled dataset containing examples of text annotated with emotional tones. The one or more ML models learn to recognize patterns associated with different emotions. During the interview analysis, these trained one or more ML models evaluate the candidates' responses against learned patterns, assigning classifications of positive, neutral, or negative emotional tone based on the content and context of the responses. The output from the one or more ML models delivers insights into the candidates' emotional states, indicating how positively or negatively they may view their experiences or the job role. For example, the positive emotions such as responses that include affirming language or enthusiasm, suggesting confidence or a positive outlook towards the role or employer. The neutral emotions such as responses that are factual and devoid of emotional language, indicating ambivalence or a measured response to the questions posed. The negative emotions such as responses displaying frustration, sadness, or discontent, hinting toward potential concerns about the job or the interviewing process.

In an exemplary scenario, considering a candidate's response where they express, “I really enjoyed leading the last project and felt empowered by my team.” The ML model analyzes key phrases such as “really enjoyed” and “felt empowered,” recognizing them as indicators of a positive emotional tone. The analysis indicates this candidate likely possesses a positive attitude towards teamwork and leadership, making them a compelling candidate for a managerial role within a collaborative environment.

The data analyzing subsystem 228 is further configured to identify one or more key entities comprising skills, experiences, and names, within the responses, for matching the one or more candidates with one or more job roles. By processing the context surrounding specific phrases associated with these key entities, the data analyzing subsystem 228 is further configured to analyze nuances in the candidates' responses. This allows for a more nuanced understanding of their implications and context.

In an exemplary scenario, a technology company utilizes the AI-based interviewer to conduct interviews for software development positions. As candidates are interviewed, their responses to technical questions about programming languages and project management strategies are recorded. A candidate mentions, “I have used Python and Java for developing scalable applications.” The speech recognition model captures this statement and converts it into the text: “I have used Python and Java for developing scalable applications.” The text is segmented into tokens: [“I”, “have”, “used”, “Python”, “and”, “Java”, “for”, “developing”, “scalable”, “applications” ]. Each token is tagged accordingly (e.g., “I”—pronoun, “used”—verb). An analysis reveals that the candidate's tone is positive, indicating enthusiasm and confidence about their experiences with the programming languages.

Key entities such as “Python”, “Java”, and “scalable applications” are recognized, linking the candidate to essential skills relevant to the job description. The data analyzing subsystem 228 evaluates the context around “Python” and “Java” to assess the candidate's programming experience more holistically, understanding that mentioning both languages highlights versatility. The data analyzing subsystem 228 compiles all findings into a comprehensive report, showcasing the candidate's contextual understanding of programming languages and their emotional engagement during the discussion. Hiring managers utilize these insights to determine the candidate's fit for the software developer role based not only on their technical knowledge but also on their communicative attributes.

For analyzing the data associated with the one or more candidates obtained during the ongoing interview, the data analyzing subsystem 228 is configured to interpret the one or more non-verbal cues by analyzing visual data collected during the ongoing interview using a computer vision technique. This feature employs computer vision algorithms to process and analyze the visual data captured during the ongoing interview. It includes the identification of key facial features and movements to glean insights into a candidate's overall demeanor. The computer vision technique converts the visual data from the interview (typically video feeds) into interpretable information. This may involve object detection, motion tracking, and identification of specific visual cues that indicate engagement or lack thereof. For example, the AI-based interviewer might use facial recognition technology to track the candidate's eye movements and determine their level of focus or distraction during the conversation. For instance, consistently looking away from the camera could signal discomfort or lack of confidence.

The data analyzing subsystem 228 is configured to identify one or more emotions through the facial expressions of the one or more candidates. The data analyzing subsystem 228 focuses on recognizing and interpreting a range of emotions by analyzing the candidate's facial expressions during the interview. The advanced algorithms may categorize facial movements and expressions (such as smiles, frowns, or raised eyebrows) to assess emotional responses. These can be cross-referenced with spoken words to create a fuller picture of candidate sentiment. For example, if a candidate expresses surprise or hesitation while responding to a question, the AI-based interviewer may map this emotion to the content of the answer, indicating further probing may be necessary. For instance, if a candidate smiles while discussing a collaborative project, the AI-based interviewer may signal enthusiasm about their past experiences.

The data analyzing subsystem 228 is configured to track body language and hand gestures to assess confidence and reluctance of the one or more candidates. The data analyzing subsystem 228 analyzes physical movements, such as posture and hand gestures, to assess a candidate's confidence and reluctance. Body language analysis might include monitoring gestures that indicate openness or closed-off behaviors. This aspect of analysis involves an integration of both visual data and contextual understanding of different gestures. For example, if a candidate frequently fidgets with their hands or avoids strong eye contact, the AI-based interviewer could interpret this as signs of nervousness or reluctance. As a result, the AI-based interviewer may modify future questions to help the candidate feel more at ease.

The data analyzing subsystem 228 is configured to determine physical stance to guage comfort levels and engagement during the ongoing interview. The data analyzing subsystem 228 evaluates the overall physical demeanor of the candidate to measure their comfort and engagement throughout the interview. By assessing aspects such as how comfortably a candidate is seated, their posture (leaning forward vs. slouching), and if they use gestures confidently, the AI-based interviewer may form conclusions about the candidate's level of engagement and comfort. For example, if a candidate sitting upright and leaning slightly towards the camera may indicate engagement and interest, while slumping back in their chair could suggest disengagement or discomfort, prompting the interviewer to pivot their approach to better engage the candidate.

The data analyzing subsystem 228 is configured to integrate the processed responses of the one or more candidates and the interpreted one or more non-verbal cues to generate a comprehensive profile of the one or more candidates during the ongoing interview. The data analyzing subsystem 228 integrates processed responses and non-verbal cues from candidates during interviews, ultimately generating a comprehensive profile that reflects each candidate's qualifications, demeanor, and suitability for the role. The data analyzing subsystem 228 integrates both the verbal responses given by candidates and the non-verbal cues interpreted from their demeanor (such as facial expressions and body language). This fusion of qualitative and quantitative data creates a well-rounded profile of each candidate. By synthesizing verbal communications with visual cues, the data analyzing subsystem 228 subsystem provides a multi-dimensional assessment of a candidate. For example, strong verbal answers may be bolstered or diminished by non-verbal signals like positive facial expressions or signs of discomfort. The data analyzing subsystem 228 thus creates a nuanced profile that reflects not only what candidates say but also how they say it, providing deeper insights into their potential fit within an organization.

For example, during an interview, a candidate provides articulate and well-structured responses to competency-based questions regarding teamwork. At the same time, the data analyzing subsystem 228 captures non-verbal cues such as a confident posture and sustained eye contact, which indicate engagement. The data analyzing subsystem 228 integrates this information to generate a comprehensive profile that highlights the candidate's communication skills and confidence. For instance, the profile might conclude that the candidate is not only knowledgeable about teamwork concepts but is also likely to thrive in collaborative environments due to their confident demeanor and positive non-verbal signals.

The plurality of subsystems 114 further includes the data processing subsystem 230 that is communicatively connected to the one or more hardware processors 202. The data processing subsystem 230 is configured to process the analyzed responses of the one or more candidates to determine one or more contextual attributes associated with the responses using the one or more machine learning (ML) models. In an embodiment, the one or more contextual attributes may include at least one of: one or more verbal attributes, one or more non-verbal attributes, one or more performance attributes, and one or more contextual interaction attributes.

The data processing subsystem 230 is a functional component designed to process the analyzed responses of the one or more candidates from the ongoing interviews. The data processing subsystem 230 utilizes the one or more machine learning (ML) models to determine various contextual attributes associated with these responses. The data processing subsystem 230 processes the output from the interview analysis by applying machine learning algorithms that have been trained on diverse datasets. These one or more ML models are capable of recognizing patterns and extracting significant attributes from both the verbal and non-verbal communication of candidates.

The one or more verbal attributes are pertained to the content and quality of the spoken responses, including vocabulary, coherence, and response length. The one or more non-verbal attributes may include body language and facial cues that may provide insights into a candidate's confidence or engagement level. The one or more performance attributes are metrics that assess the effectiveness of the candidate's answers against predetermined criteria (e.g., relevance to job requirements). The one or more contextual interaction attributes reflect how the candidate interacts in the interview setting, including adaptability to questions, responsiveness to follow-ups, and overall engagement demonstrated through various communicative behaviors.

For example, a candidate participates in an interview where they respond to a question about their leadership experience. The data analyzing subsystem 228 captures their verbal response, which may include phrases that suggest confidence and clarity, while also interpreting their non-verbal cues like assertive posture and frequent eye contact. Afterward, the data processing subsystem 230 applies a trained ML model to process this information. The trained ML model identifies that the candidate utilized convincing language (verbal attributes) and displayed dominant body language (non-verbal attributes). Based on accumulated data, the data processing subsystem 230 might categorize these as high performance attributes for leadership roles. The overall assessment might result in generating a profile that flags this candidate as a strong fit for positions that require robust leadership skills.

The ML model may be Natural Language Processing (NLP) models such as BERT for understanding the context of words in relation to all other words in a sentence, which can help in analyzing verbal responses to assess relevance and depth of answers. The ML model may be recurrent neural networks (RNNs) suitable for sequential data like speech, making them useful for understanding context over time in a candidate's spoken responses. The ML model may be convolutional neural networks (CNNs) used in image classification tasks. The CNNs may analyze video feeds from interviews to extract facial expressions, body language, and other non-verbal cues indicative of a candidate's emotional state and engagement. The ML model may be facial expression recognition models that may categorize emotions (e.g., happiness, sadness, confusion) based on real-time analysis of facial movements, which is crucial for interpreting non-verbal communication.

The ML model may be random forests and gradient boosting, which may be employed to combine features from both verbal and non-verbal analyses to make more accurate predictions about a candidate's overall performance based on multiple attributes. The ML model may be SVM for classifying responses based on various features extracted from candidates' verbal and non-verbal behaviors, such as creating categories for pass/fail based on performance metrics. The ML model may be multimodal learning models that integrate data from various modalities (e.g., audio, video, text) to capture the complete context of an interview. For example, the multimodal learning models jointly analyze both the transcription of spoken answers and visual data from the interview may provide richer insights into a candidate's suitability for a role. The ML model may be sentiment analysis models configured to gauge sentiment from text (using methods such as more advanced NLP techniques) for providing evaluations of a candidate's tone and attitude reflected in their verbal responses.

The plurality of subsystems 114 further includes the query generating subsystem 232 that is communicatively connected to the one or more hardware processors 202. The query generating subsystem 232 is configured to automatically generate one or more follow-up interview questions to be delivered to the one or more candidates during the ongoing interview based on the analyzed responses from the one or more candidates, by applying the AI model to the one or more contextual attributes associated with the responses.

For automatically generating the one or more follow-up interview questions, the query generating subsystem 232 is configured to obtain the analyzed responses comprising at least one of: verbal response and the non-verbal responses, from the one or more candidates. The query generating subsystem 232 collects candidate data, including spoken words, tone of voice, and physical cues (like body language and facial expressions), which are crucial in assessing responses comprehensively. For example, if a candidate provides a verbal response to a question about their leadership style, the query generating subsystem 232 not only analyzes the words spoken but also evaluates the candidate's confidence level through their tone and body language (e.g., maintaining eye contact, posture).

The query generating subsystem 232 is further configured to identify the one or more contextual attributes from the analyzed responses. This involves extracting relevant contextual features and sentiments from the analyzed responses that can influence the understanding of the candidate's answers. By assessing responses in context, the query generating subsystem 232 can identify keywords, emotional tone, and situational factors that shape the meaning behind the words. For example, if a candidate expresses enthusiasm about a team project, the query generating subsystem 232 may identify that as a positive contextual attribute indicating the candidate's teamwork and collaborative skills, influencing follow-up questions.

The query generating subsystem 232 is further configured to utilize the one or more ML models being trained on one or more datasets of interview transcripts and the one or more follow-up interview questions, to analyze context and intention behind the responses of the one or more candidates. The ML models analyze historical data to identify patterns and underlying intentions within candidate responses, allowing the system to generate relevant follow-up questions. For example, an ML model trained on positive responses about conflict resolution might suggest that a candidate who discusses a personal experience with conflict management is likely a team player, guiding the query generating subsystem 232 to ask follow-up questions about their specific roles in team conflicts.

The ML model may utilize NLP techniques to process and analyze transcripts of candidate responses during interviews. The ML models are trained on datasets of interview transcripts to recognize patterns, sentiments, and the context behind the candidates' answers. This ML model can understand nuances in language, such as emotional tone or uncertainty. By analyzing the constructed meaning from candidates' responses, the ML model then assists in generating contextually relevant follow-up questions. The ML model may be a sentiment analysis model focuses on identifying the sentiment behind candidate responses by classifying them as positive, negative, or neutral. The sentiment analysis model is trained on a wide dataset of interview responses tagged with sentiments. The sentiment analysis model aids in determining the emotional engagement of candidates when they provide answers. The model's insights help the AI-based interviewers gauge candidate enthusiasm or hesitation, influencing the direction of subsequent questions.

The ML model may be a topic modeling based ML model employing topic modeling techniques to categorize responses based on overarching themes discussed by the candidates during the interview. By clustering similar responses and identifying prevalent topics, the topic modeling based ML model enables interviewers to focus on specific areas of interest or concern. The topic modeling based ML model provides valuable insights on which competencies or experiences candidates emphasize, assisting the AI-based interviewer in tailoring follow-up questions relevant to each candidate's background.

The ML model may be an intent recognition model that extracts the intent behind a candidate's statements to understand their underlying motivations and objectives. The intent recognition model is trained with examples of intent-laden responses, the model identifies specific intents and correlates them with predefined job competencies. The intent recognition model informs the generation of subsequent questions that delve deeper based on the identified intent, facilitating a more meaningful dialogue with candidates.

The ML model may be a classification model for the non-verbal cues. The classification model analyzes non-verbal communication, such as body language and facial expressions, during the interview process. The classification model classifies behaviors and cues associated with confidence, nervousness, or distraction, incorporating visual data alongside verbal responses. By integrating both verbal and non-verbal insights, the classification model enhances context and intention analysis, guiding the AI-based interviewer to formulate comprehensive follow-up questions related to candidate engagement.

The query generating subsystem 232 is further configured to interpret the nuances in a language capturing subtleties around meaning and intent guiding question formulation using the AI model with the NLP techniques. This feature leverages AI capabilities, particularly natural language processing (NLP) techniques, to analyze and understand the subtleties in candidate responses. The AI model interprets different layers of meaning in language, such as sarcasm, politeness, or hesitation, guiding the formulation of context-rich questions. For example, if a candidate states, “I think I could probably manage the team,” the AI model might detect uncertainty in their wording, prompting follow-up questions targeted toward exploring their confidence and decision-making in leadership roles.

The AI model may be a contextual intent model that is configured to decode the intent behind candidates' responses using advanced NLP methodologies. The contextual intent model assesses linguistic cues such as word choice and sentence structure to extract contextual meaning, allowing the AI-based interviewer to understand not just what the candidate is saying but the subtext of their statements. The insights gained from this contextual intent model inform the AI-based interviewer's question formulation strategy, facilitating deeper exploration of subjects important to the applicant.

The AI model may be a sentiment analysis model within the AI-based interviewer leveraging the NLP to assess the emotional tone of candidate responses. The sentiment analysis model is trained on a dataset that categorizes responses by sentiment (positive, neutral, or negative), and the sentiment analysis model helps discern the candidate's feelings about particular topics or experiences. This understanding guides the AI-based interviewer in generating the follow-up questions that might address any concerns or highlight positive experiences of the candidate, fostering a more productive interaction.

The AI model may be a language nuance recognition model focuses on identifying and interpreting language nuances, such as sarcasm, hesitation, or ambiguity present in candidate responses. The language nuance recognition model leverages sophisticated parsing techniques to analyze the structure and syntax of spoken language, extracting rich, contextual information that can suggest deeper meanings. By recognizing these language subtleties, the language nuance recognition model enhances the AI-based interviewer's ability to pose insightful and pertinent follow-up questions, improving the overall quality of the assessment.

The AI model may be an adaptive question generation model for adapting follow-up questions in real time based on the insights derived from NLP analysis of candidate responses. The adaptive question generation model synthesizes information on the candidate's verbal cues, emotional responses, and identified intents to craft tailored queries that encourage more in-depth discussion. This adaptive questioning approach not only enriches the interaction but also provides hiring managers with a more comprehensive understanding of the candidate's qualifications and fitness.

The query generating subsystem 232 is further configured to generate contextually appropriate one or more follow-up interview questions based on the identified one or more contextual attributes, using one or more neural network architectures. The query generating subsystem 232 involves the automatic creation of follow-up interview questions tailored to the candidate's responses using advanced neural network models. The neural network processes the contextual attributes identified during the analysis stage, producing questions that are relevant and engaging based on identified themes and sentiments. For example, if a candidate mentions a specific project they found challenging, the neural network might generate a follow-up question like, “What strategies did you implement to overcome difficulties with that project?”.

The query generating subsystem 232 is further configured to filter the one or more follow-up interview questions based on relevance of the specific context provided by one or more previous responses of the one or more candidates. This feature enables the query generating subsystem 232 to select the follow-up interview questions that are closely aligned with the context provided by previous candidate responses. By analyzing past answers, the query generating subsystem 232 can discern the thematic elements and topics raised by the candidate, ensuring that subsequent questions are pertinent, thus enhancing the relevance of the interview. For example, if a candidate mentions their experience with team leadership, the follow-up question may be, “Can you share a specific challenge you faced while leading a team and how you addressed it?” This question builds directly upon the candidate's prior input.

The query generating subsystem 232 is further configured to generate multiple variation of the one or more follow-up interview questions for at least one of: natural conversation flow, avoiding rigid scripts, and enabling dynamic interactions. The query generating subsystem 232 creates different iterations of the same follow-up question to maintain a natural conversational flow, diverging from more rigid scripts. This feature allows for dynamic interactions by varying the phrasing or structure of questions, making the dialogue resemble more of an organic conversation and reducing the mechanical feel of scripted interviews. For example, if an initial question was, “How did you handle a conflict in your last job?” subsequent variations could include, “Can you describe a time when you disagreed with a colleague and how you resolved it?” or “What approach did you take when facing conflicts at work?”.

The query generating subsystem 232 is further configured to structure the one or more follow-up interview questions to assess competencies related to the one or more job roles. The query generating subsystem 232 involves in designing follow-up questions specifically aimed at evaluating the competencies required for the job role in question. By aligning questions with the essential skills and attributes sought for a position, the query generating subsystem 232 ensures that the interview process effectively assesses the candidate's fit for the role. For example, for a project management position, if a candidate discusses their organizational skills, a competency-oriented follow-up could be, “How do you prioritize tasks when managing multiple project deadlines?”.

The query generating subsystem 232 is further configured to interact with the one or more candidates with one or more follow-up questions, adapting to a flow of conversation with the one or more candidates. The query generating subsystem 232 allows the AI-based interviewer to engage with candidates through tailored follow-up questions that adapt fluidly to the direction of the conversation. By dynamically adjusting to the conversational flow, the query generating subsystem 232 can maintain an engaging interview atmosphere, prompting candidates to elaborate on their responses and providing a more interactive experience. For example, if a candidate mentions a specific technology they are familiar with, the AI might adapt to ask, “What projects have you implemented that used this technology?” shifting focus based on the candidate's interests and expertise.

In an aspect, the query generating subsystem 232 is configured to dynamically generate one or more AI-interviewer responses based on the analyzed responses from the one or more candidates and the one or more contextual attributes, using transformer-based large language models (LLMs). The generation of the one or more AI-interviewer responses refer to production of real-time, contextually appropriate non-question outputs during an interview (e.g., transitions (“Thanks—next topic”), clarifications, brief coaching tips, short summaries of candidate responses, acknowledgement/encouragement, or requests to rephrase) using a transformer-based LLM conditioned on the candidate responses/context signals.

The query generating subsystem 232 receives the one or more inputs comprising request contexts (e.g., candidate_id, role, stage_of_interview, current_turn_text/audio, last_N turns), candidate signals (e.g., confidence_score, answer_length, pause_durations, eye_contact_score, sentiment_score, performance_attributes), policy constraints (banned topics, fairness rules, PII scrubbing rules), and external knowledge (job description, rubric, interviewer style profile). The query generating subsystem 232 converts current audio to text (ASR) and computer ASR confidence and normalizes times and indices. The query generating subsystem 232 gathers last N turns and candidate signals from the data analyzing subsystem 228/data processing subsystem 230.

The query generating subsystem 232 with the transformer-based LLM builds a compact context bundle: system instruction (fixed), job profile snippet, recent conversation summary (or retrieved compressed embeddings), candidate signals vector, and the target response type (e.g., transition, summary, coaching, acknowledgement, clarification). If the raw context is too large, run a summarizer (LLM or lightweight transformer) to compress to fit token budget. The query generating subsystem 232 with the transformer-based LLM generates one or more prompts for the computer-implemented system 112 and the user. For the computer-implemented system 112, the prompts may be roles (e.g., “You are a professional, neutral interviewer assistant that never asks illegal or discriminatory questions. Keep responses ≤20 words for acknowledgements, ≤50 for transitions.”), constraints (no PII, supportive tone)). For the user, the message includes structured JSON-like context fields: {job_desc: . . . , last_answer: “ . . . ” signals:{confidence:0.42,sentiment:“anxious”},desired_type:“ACKNOWLEDGEMENT”} and an instruction template to the LLM to “Generate a single short output of type X”.

Optionally, if needed, the query generating subsystem 232 retrieves relevant rubric lines or prior candidate notes via embeddings (RAG) and append top-k retrieved snippets into prompt. The transformer LLM (e.g., GPT) with parameters tuned by desired_type (e.g., low temperature (0.0-0.3) for factual/summaries, slightly higher (0.4-0.7) for empathetic phrasing or creative coaching). The transformer LLM uses sampling/top_p as appropriate. The transformer LLM sets maximum tokens per type (e.g., 15 for ACK, 50 for transition). The query generating subsystem 232 runs the generated text through a lightweight classifier for disallowed content, bias, or privacy leaks. If flagged, the query generating subsystem 232 either (a) auto-repairs (truncate/redact) or (b) regenerates with stricter constraints. The query generating subsystem 232 applies micro-formatting (timestamps, tokens), attach provenance (model version, prompt id), and wrap as ResponsePackage with metadata: {type, text, score, candidate_signals_snapshot, audit_id}. If output is spoken, the query generating subsystem 232 sends to TTS module with voice/style matching interviewer.

In an exemplary scenario, the candidate answers, “At my last job I led a migration that cut processing time by half.” and signals with confidence 0.6, pause 2s. The query generating subsystem 232 generates the interviewer response as “Great—that's an impressive outcome. Can you share the biggest technical obstacle?” (if follow-up allowed). For non-follow-up, the query generating subsystem 232 generates the interviewer response as: “Thank you—impressive impact.” or a transition: “Thanks—next we'll discuss leadership style.” The query generating subsystem 232 selects output (non-follow-up) as “Thanks—impressive impact; noted for scoring.” (LLM generates short acknowledgment)”.

In an aspect, the query generating subsystem 232 is further configured to detect candidate emotional state from multimodal signals and adapt wording, tone, and length of LLM outputs to match/soothe/enhance candidate experience while following policy (no manipulation, no discriminatory treatment). The query generating subsystem 232 receives the inputs including at least one of: multimodal signals (text sentiment, vocal prosody features (pitch, loudness, speech rate), facial expression scores, body posture; aggregated emotion_state with confidence (e.g., {anxious:0.7, neutral:0.2})), interview context (stage, stakes), candidate profile, and accessibility needs, and mapping rules (emotion). The query generating subsystem 232 runs emotion models on audio (prosody), text (sentiment/affect), and video (facial expression). The query generating subsystem 232 fuses into composite emotion_state with confidence and timestamp, performed by the data analyzing subsystem 228. The query generating subsystem 232 maps emotion states to a strategy. For example, for anxious, the query generating subsystem 232 uses calming, reassurance phrases, slower TTS, concise prompts. For frustrated, the query generating subsystem 232 uses validating language and offer break.

The query generating subsystem 232 converts the strategy into LLM control knobs(tone=“calm”,formality=“friendly”,verbosity=“low”, use_reassurance_phrases=true). The query generating subsystem 232 represents this a prompt meta. The query generating subsystem 232 then generates candidate phrasing with the transformer-based LLM using a model call with lower temperature. The query generating subsystem 232 with the transformer-based LLM includes a small set of few-shot examples showing target tone. Optionally, the query generating subsystem 232 uses style-conditioning models or a fine-tuned adapter. The query generating subsystem 232 runs a lightweight tone classifier (or small LLM score) to ensure output matches target tone. If mismatch, the query generating subsystem 232 regenerates with stricter constraints (e.g., more explicit examples). The query generating subsystem 232 sends the outputs to UI/TTS with voice settings (e.g., calm cadence). After delivery, the query generating subsystem 232 measures candidate reaction (did anxiety level drop?). The query generating subsystem 232 feeds that back into the emotion model for closed-loop adaptation.

In an exemplary scenario, the query generating subsystem 232 detects emotion i.e., anxious:0.82 after a difficult question and a Desired output is reassurance transition (non-follow-up). The query generating subsystem 232 prompt to LLM includes “Tone indicating calm, short, and validating”. The LLM outputs as “It's okay—take your time. If you'd like, we can pause or rephrase the question”. The query generating subsystem 232 delivers spoken reassurance and reduces next question complexity.

In another aspect, the query generating subsystem 232 generates multiple candidate prompt/response templates or LLM outputs, scores them using a re-ranking model that considers context relevance, candidate signals, recruiter constraints, safety and fairness, then select the best to present. The query generating subsystem 232 receives the inputs including at least one of: request context and candidate signals (e.g., the one or more responses from the one or more candidates), a pool of prompt templates and candidate prompt variants (N), and scoring signals (e.g., semantic relevance, tone match, clarity, brevity, safety, fairness, rubric alignment, expected candidate comfort, recruiter preference weights).

The query generating subsystem 232 generates N prompt variants (candidate prompts) using strategies to vary templates (i.e., different wording, level of directness, length, degree of empathy, explicitness). For each variant, the query generating subsystem 232 either (a) constructs a different system/user prompt to the LLM, or (b) generates candidate completions from a single prompt with sampling to produce diverse candidate outputs. For each variant, the query generating subsystem 232 utilizes the LLM (parallelized), producing Response_i with generation metadata (logprobs, tokens). The query generating subsystem 232 computes per-response feature factors for each response. The features include at least one of: semantic relevance (embedding similarity between Response_i and job/rubric context (via embeddings+cosine), tone match (score how well Response_i matches desired tone (use a tone classifier), clarity/brevity (length penalty, reading grade), safety/bias (content safety classifier outputs), candidate alignment (predicted candidate comfort/confidence if this response used (model trained on historical outcomes), recruiter preference (scored against recruiter-provided weightings (e.g., prefer concise), and LLM confidence (normalized logprob/entropy).

The query generating subsystem 232 scores and re-ranks the prompts using the ranking model using either (a) a learner cross-encoder ranking model that ingests context, candidate signals, response text, and outputs a scalar score, or (a) a heuristic weighted sum over normalized features (score=w1*relevance+w2*tone_match+w3*(1−length_penalty)+w4*safety_score+w5*alignment−w6*bias_risk). The query generating subsystem 232 configures the weights per role/job. The query generating subsystem 232 then selects top-scoring response and optionally selects a backup candidate for fast fallback if policy checks fail. The query generating subsystem 232 runs final filter. If candidate fails, the query generating subsystem 232 next best or regenerates. The query generating subsystem 232 stores variants, features, scores, chosen response id, model versions for traceability and continuous learning.

In an exemplary scenario, a candidate provided a complex technical answer but long pauses. The candidate signals are confidence=0.45, pauses=3, anxious=0.6. The query generating subsystem 232 generates 5 candidate responses such as a concise acknowledgement, a calm reassurance, a brief summary+note, a direct compliment+move on, and a clarifying paraphrase. The query generating subsystem 232 computes features such as relevance, tone match to calm, clarity, safety. The ranking model scores them and selects “Thanks”-that clarifies the approach. The query generating subsystem 232 selects “Could you briefly summarize the key tradeoffs?” (because it balances calm tone, invites concise restatement, aligns with rubric).

In another aspect, the AI-based interviewer is configured to analyze at least one of: emotion recognition, gaze tracking, and head movement through a real-time webcam, for performing at least one of: adjusting tone, pacing, and questioning in style using a multi-modal fusion, by adapting the data obtaining subsystem 210 to continuously capture visual data with high-resolution video streams associated with the one or more candidates from webcam inputs, processing frame-by-frame visual data at rates for real-time emotion detection and behavioral analysis. The data analyzing subsystem 228 is adapted to analyzes visual data collected during the ongoing interview using computer vision techniques to identify emotions through facial expressions of candidates. The data analyzing subsystem 228 employs convolutional neural networks (CNNs) for facial expression recognition models that categorize emotions such as happiness, sadness, confusion, anxiety, and confidence based on real-time analysis of facial movements and micro-expressions. The data analyzing subsystem 228 identifies key facial features including eyebrow position, mouth curvature, eye openness, and cheek muscle tension. These landmarks are tracked continuously to detect emotional transitions, with the data analyzing subsystem 228 mapping facial movements to emotional states that influence the AI-based interviewer's response generation.

The computer vision system tracks eye movements, fixation points, and gaze direction to assess candidate engagement and attention levels. The data analyzing subsystem 228 analyzes whether candidates maintain appropriate eye contact with the camera, look away during difficult questions, or exhibit scanning behaviors that may indicate uncertainty or discomfort. Gaze tracking data contributes to contextual interaction attributes by measuring sustained attention periods, frequency of eye contact breaks, and correlation between gaze patterns and response quality. These metrics inform the AI model about candidate confidence levels and engagement throughout the interview process.

The data analyzing subsystem 228 correlates gaze patterns with question complexity to assess cognitive load. Rapid eye movements or prolonged looking away may indicate processing difficulty, prompting the AI-based interviewer to adjust questioning complexity or provide additional context. The data analyzing subsystem 228 determines physical stance to gauge comfort levels and engagement during the ongoing interview. The data analyzing subsystem 228 tracks head position, tilt angles, and movement patterns to assess candidate comfort, agreement/disagreement signals, and overall engagement levels. The data analyzing subsystem 228 tracks body language and hand gestures to assess confidence and reluctance of candidates, incorporating head movements as part of comprehensive non-verbal communication analysis. Head nodding, shaking, tilting, and positioning relative to the camera provide additional behavioral indicators. The data analyzing subsystem 228 monitors changes in head position and overall posture throughout the interview, detecting shifts that may indicate fatigue, increased interest, discomfort, or emotional state changes that require adaptive interviewer responses.

The data processing subsystem 230 processes analyzed responses to determine contextual attributes using machine learning models, where visual signals from real-time webcam input directly influence the contextual attributes fed into transformer-based LLMs. The data processing subsystem 230 creates unified embeddings that represent both verbal content and real-time visual behavioral data. The transformer-based LLM incorporates visual attention weights alongside textual attention mechanisms. Different attention heads process visual emotional cues, gaze patterns, and postural information, allowing the model to generate responses that account for both what candidates say and how they physically present during responses. The data processing subsystem 230 correlates verbal responses with simultaneous visual cues to detect incongruence between spoken words and body language. For example, if a candidate verbally expresses confidence while displaying nervous facial expressions or avoiding eye contact, the LLM adjusts its interpretation and response generation accordingly.

The query generating subsystem 232 utilizes behavioral models to guide interactions and emulate human-like behaviors including changing tone based on detected emotional states from webcam input. If facial expression analysis indicates candidate stress, the query generating subsystem 232 may soften its vocal tone and adjust speech patterns to be more supportive. The query generating subsystem 232 monitors visual indicators of cognitive processing, such as prolonged gaze aversion or facial expressions indicating concentration, to adjust question pacing. The conversation engine adapts timing between questions, allowing additional processing time when visual cues suggest the candidate needs more time to formulate responses. The query generating subsystem 232 generates contextually appropriate follow-up questions influenced by real-time visual feedback. If gaze tracking indicates confusion or facial expressions show uncertainty, the query generating subsystem 232 may generate clarifying questions or rephrase complex queries in more accessible language.

In an exemplary scenario, Sarah, a candidate who is applying for senior software engineer position. 1080p video stream at 30 fps capturing Sarah's upper body and face. The data obtaining subsystem 210 continuously processes visual frames while simultaneously recording audio responses. The data analyzing subsystem 228 analyzes each frame for facial landmarks, eye position, and head orientation. In the event with timestamp 00:15:30—Question Delivery from the AI interviewer, “Can you walk me through how you would design a scalable microservices architecture for an e-commerce platform?”. The data analyzing subsystem 228 analyses that gaze tracking (Sarah maintains direct eye contact for 2.3 seconds), facial expression (Slight eyebrow raise indicating interest/engagement), head position (Upright, facing camera directly), emotion recognition (Confidence score: 7.2/10).

The data processing subsystem 230 processes at the timestamp 00:15:33, detects visual cues including gaze pattern (Eyes move up-right (accessing visual memory)), facial expression (Slight frown, indicating concentration), head movement (Minor head tilt to left), micro expressions (Brief lip compression (thinking indicator)). The LLM Multi-Modal processes contextual attributes which enables the system to identify “cognitive processing” state. The LLM Multi-Modal increases visual attention weights for concentration indicators. The AI-based interviewer maintains patient waiting posture. The AI-based interviewer, at timestamp 00:15:38, the response from Sarah is “Well, I'd start by identifying the core business domains . . . ”. The system performs simultaneous visual analysis such as gaze tracking (Returns to camera, steady eye contact), facial expressions (relaxed features, slight smile), head position (slight forward lean (engagement indicator), head gestures (begins using descriptive hand movements).

The multi-modal fusion processes cross-modal correlation that maps high confidence verbal tone positive facial expressions. The multi-modal fusion correlates technical vocabulary with confident body language. At timestamp 00:16:15, the visual cue change is detected such as facial expression (slight furrow between eyebrows), gaze pattern (brief downward glance), head movement (minor backward lean), emotion recognition (uncertainty score increases to 6.8/10), and Sarah's verbal content (“ . . . and for the payment service, I would . . . um . . . probably use . . . ”). The real-time LLM adaptation on (a) tone adjustment indicates AI-based interviewer's facial expression becomes more encouraging, (b) pacing modification allows the system to prepare to allow longer processing time, and (c) response preparation enable the system to prepare supportive follow-up options.

At timestamp 00:16:45, the query generating subsystem 232 generates visual assessment summary such as overall confidence (moderate (6.5/10) with uncertainty spikes), engagement level (high 8.2/10 based on eye contact and forward lean), cognitive load (elevated (7.1/10) from facial tension indicators). The original generated questions before the visual input are: “What specific technologies would you use for inter-service communication?”, “How would you handle distributed transactions?”. The query generating subsystem 232 then generates question as “What are the key principles you'd keep in mind when designing these services?”, based on the re-ranked prompts (e.g., question 1: ranked lower due to detected uncertainty about technical specifics, and question 2: ranked higher as it's more conceptual, matching current cognitive state).

The score generating subsystem 220 is configured to generate one or more recruitment scores for the one or more candidates based on at least one of: the analyzed responses, the one or more contextual attributes, and interpreted non-verbal cues, associated with the one or more candidates, using the AI model. The score generating subsystem 220 is a component designed to evaluate and quantify the suitability of candidates for a particular job role by generating one or more recruitment scores. These recruitment scores are computed based on a combination of analyzed candidate responses, contextual attributes derived from those responses, and interpreted non-verbal cues.

For generating the one or more recruitment scores for the one or more candidates, using the AI model, the score generating subsystem 220 is configured to obtain information associated with at least one of: the analyzed responses, the one or more contextual attributes, and interpreted non-verbal cues, of each candidate of the one or more candidates. The score generating subsystem 220 is configured to gather comprehensive information from the interview process. The analyzed responses may be actual spoken or written answers given by the candidate during the interview. The one or more contextual attributes may be surrounding factors that help interpret the responses, such as the specific job requirements or industry standards relevant to the position. The interpreted non-verbal cues may be observations of the candidate's body language, facial expressions, and other physical indicators that may provide insight into their confidence or engagement levels. For example, considering a scenario where a candidate, John, is asked to describe how he handled a difficult project. The score generating subsystem 220 analyzes his verbal answer, considers the context of project management challenges, and also interprets his nervous fidgeting as a non-verbal cue indicating possible discomfort with the question.

The score generating subsystem 220 is further configured to generate one or more weights to at least one of: the analyzed responses, the one or more contextual attributes, and interpreted non-verbal cues, of the one or more candidates, using a scoring model (i.e., the AI model (e.g., multi-layer neural network model, a random forest scoring model, and Gradient Boosting Scoring Model)). This feature refers to the allocation of importance or significance to each type of information collected and analyzed responses, contextual attributes, and non-verbal cues, through the application of the scoring model. The scoring model evaluates each component to assign the one or more weights that reflect its relevance to the overall assessment of the candidate's suitability. The one or more weights help determine how much influence each factor will have on the final recruitment score. For example, in a scoring scenario, the scoring model might find that John's detailed description of his project management success (the analyzed response) should carry a higher weight (e.g., 60%) in the scoring model, while his nervous body language (the non-verbal cue) might be given a lower weight (e.g., 20%), with contextual attributes receiving the remaining weight (e.g., 20%).

The score generating subsystem 220 utilizes the multi-layer neural network model as the scoring model that processes three primary input categories: analyzed responses (the text embeddings from candidate verbal responses processed through NLP techniques), contextual attributes (the feature vectors representing verbal attributes, non-verbal attributes, performance attributes, and contextual interaction attributes), and interpreted non-verbal cues (the numerical representations of facial expressions, body language, and engagement metrics). The multi-layer neural network model applies learned parameters to generate dynamic weights based on job role requirements and candidate profile matching, as given below:

‘‘‘
Weight_Responses = sigmoid(W1 response_features + b1)
Weight_Context = sigmoid(W2 context_features + b2)
Weight_NonVerbal = sigmoid(W3 nonverbal_features + b3)
‘‘‘

Where W1, W2, W3 are learned weight matrices and b1, b2, b3 are bias terms.

For example, John, 5 years experience, applying for Senior Software Engineer, is considered. The multi-layer neural network model processes the analyzed response “I implemented microservices architecture using Docker and Kubernetes, which improved system scalability by 40%”, contextual attributes “Technical competency score: 8.5/10, Communication clarity: 7.8/10” and non-verbal cues “Confidence level: 8.2/10, Eye contact: 85%, Engagement: 9.1/10”. The multi-layer neural network model generates response weight as 0.65 (high technical content relevance), context weight as 0.25 (supporting evidence for technical claims), and non-verbal weight as 0.10 (confidence supports verbal claims). For technical roles, the multi-layer neural network model assigns higher weight to analyzed responses containing specific technical knowledge, with contextual attributes providing supporting evidence and non-verbal cues serving as confidence indicators.

The score generating subsystem 220 utilizes the random forest scoring model that creates multiple decision trees, each focusing on different combinations of input features to generate importance weights. Each tree in the forest evaluates the importance of different input categories based on their contribution to accurate candidate assessment predictions. The random forest scoring model calculates feature importance scores across all trees and normalizes them to generate weights as given below:

‘‘‘
Importance_Responses = Σ(tree_importance_responses) / n_trees
Importance_Context = Σ(tree_importance_context) / n_trees
Importance_NonVerbal = Σ(tree_importance_nonverbal) / n_trees
Total_Importance = Importance_Responses + Importance_Context +
Importance_NonVerbal
Weight_Responses = Importance_Responses / Total_Importance
Weight_Context = Importance_Context / Total_Importance
Weight_NonVerbal = Importance_NonVerbal / Total_Importance
‘‘‘

For example, Maria, 8 years sales experience, applying for Regional Sales Manager, is considered. The random forest scoring model processes the analyzed response “I consistently exceeded quotas by building strong client relationships and understanding customer pain points”, contextual attributes “Relationship building: 9.2/10, Results orientation: 8.7/10” and non-verbal cues “Charisma: 9.5/10, Persuasiveness indicators: 8.9/10”. The random forest scoring model generates response weight as 0.35 (relationship-focused language important but not sufficient), context weight as 0.30 (proven track record crucial for sales roles), and non-verbal weight as 0.35 (interpersonal skills heavily weighted for sales positions). For sales roles, the random forest scoring model recognizes that non-verbal communication and interpersonal presence are equally important as verbal responses and contextual performance history.

The score generating subsystem 220 utilizes the gradient boosting scoring model to iteratively learn optimal weight assignments by minimizing prediction errors on historical hiring success data. Each boosting iteration refines weight assignments based on previous model errors.

‘‘‘
For iteration t:
Weight_t = Weight_(t−1) + α gradient_correction
Where α is the learning rate and gradient_correction addresses previous
errors
‘‘‘

For example, David, 2 years experience, applying for Customer Service Representative, is considered. The gradient boosting scoring model processes the analyzed response “I believe in active listening and always try to understand the customer's perspective before offering solutions”, contextual attributes “Empathy score: 8.8/10, Problem-solving: 7.5/10” and non-verbal cues “Patience indicators: 9.0/10, Stress management: 8.3/10”. The gradient boosting scoring model generates response weight as 0.40 (empathy and listening skills verbally expressed), context weight as 0.25 (supporting competency evidence), and non-verbal weight as 0.35 (patience and stress management crucial for customer service). The gradient boosting scoring model learned from historical data that successful customer service representatives demonstrate both verbal empathy and non-verbal patience indicators.

The score generating subsystem 220 is further configured to compute the one or more recruitment scores for each candidate based on the one or more weights generated for at least one of: the analyzed responses, the one or more contextual attributes, and interpreted non-verbal cues, of each candidate of the one or more candidates. This feature is the process of computing the final recruitment scores for candidates by applying the one or more weights derived from the previous step to their respective analyzed data. The score generating subsystem 220 processes all gathered and weighted information to compute a recruitment score. This recruitment score quantifies the candidate's appropriateness for the position in question based on the AI model's calculations. For example, continuing with John's example, if the score generating subsystem 220 computes the recruitment score using the following formula: \[\text{Total Score}=(Weight_{Responses}\times Score_{Responses})+(Weight_{Context}\times Score_{Context})+(Weight_{Non-Verbal}\times Score_{Non-Verbal})\]. Assuming John's analyzed response score is 85, contextual score is 70, and non-verbal score is 60, the total recruitment score would be computed as: \[\text{Total Score}=(0.6\times 85)+(0.2\times 70)+(0.2\times 60)=51+14+12=77\].

The plurality of subsystems 114 further includes the decision supporting subsystem 234 that is communicatively connected to the one or more hardware processors 202. The decision supporting subsystem 234 is configured to generate one or more offer ranges for the one or more candidates based on the one or more recruitment scores using the AI model. The one or more offer ranges are configured to assist for one or more users in recruitment-related decision making. The decision supporting subsystem 234 is a component of the overall recruitment system designed in generating recruitment-related decisions by generating the one or more offer ranges for candidates based on their recruitment scores. The decision supporting subsystem 234 leverages the AI model to analyze candidate's scores and produce standardized salary or compensation ranges that align with organizational policies, market trends, and candidates' qualifications.

For generating the one or more offer ranges for the one or more candidates based on the one or more recruitment scores using the AI model, the decision supporting subsystem 234 is configured to obtain information associated with the one or more recruitment scores generated for the one or more candidates. The feature involves the collection and utilization of data about the recruitment scores that have been generated for candidates throughout the evaluation process. The decision supporting subsystem 234 is designed to gather detailed information regarding the one or more recruitment scores assigned to candidates based on their interview performances, qualifications, and overall fit for the position. This recruitment score represents a quantitative assessment of a candidate's suitability, derived from various factors assessed during the interview process, such as answers to competency-based questions, non-verbal cues, and contextual evaluations. For example, if a candidate receives a recruitment score of 85 out of 100, this information is vital for generating an offer range. The decision supporting subsystem 234 would record not only the score but also the specific attributes that contributed to this evaluation, such as technical skills demonstrated and interpersonal communication abilities observed during the interview.

The decision supporting subsystem 234 is configured to analyze one or more target parameters and benchmarks based on at least one of: one or more industry standards, historical data, one or more organizational compensation structures, and competitor analyses. The one or more target parameters and benchmarks are evaluated against which candidate's recruitment scores can be compared. This evaluation is grounded in various sources, such as industry standards, historical data, organizational compensation structures, and analyses of competitors. The decision supporting subsystem 234 utilizes benchmarks to ensure that the one or more offer ranges generated are competitive and appropriate. By analyzing cohorts of historical recruits and current market conditions, as well as internal compensation frameworks, the decision supporting subsystem 234 seeks to contextualize a candidate's recruitment score. This broader analysis informs how the score correlates with the potential compensation package. For example, if the industry standard for a comparable role offers a salary range of $70,000 to $90,000, and historical data shows that candidates who scored between 80 and 90 typically receive offers towards the upper end of that spectrum, the decision supporting subsystem 234 will factor this information into the offer range it proposes for a candidate with a score of 85.

The decision supporting subsystem 234 is configured to generate the one or more offer ranges for each candidate of the one or more candidates by correlating the one or more offer ranges with the one or more recruitment scores, based on at least one of: the one or more target parameters and benchmarks and one or more factors, using the AI model. The one or more factors may include at least one of: experience level, skill set, and overall fit for the job role, of the one or more candidates within an organization. The decision supporting subsystem 234 encompasses the creation of specific monetary offer ranges for each candidate, correlating those ranges with their respective recruitment scores and taking into account various target parameters and factors like experience level, skill set, and overall job fit. The decision supporting subsystem 234 employs the AI model to derive the one or more offer ranges by interlinking the given recruitment scores with previously analyzed data on target parameters and benchmarks. This analytical approach ensures that the generated offers are justified by both quantitative assessments and qualitative factors related to the candidate's background and job demands.

By employing such AI models, organizations can streamline their recruitment processes and come up with informed decisions about candidate hiring and the corresponding offer structures, ultimately enhancing efficiency and effectiveness in talent acquisition. The AI model examines the recruitment scores in the context of established target parameters and benchmarks. This allows for the interpretation of how a candidate's score compares to standard performance levels and what the market typically offers for similar profiles. The decision supporting subsystem 234 incorporates other relevant factors that could influence compensation decisions, such as industry standards, geographic salary trends, and the company's compensation strategy. These factors provide a more comprehensive view to ensure that the offer ranges generated are competitive and strategically sound.

Utilizing the insights gained from the above analyses, the AI model generates one or more offer ranges for each candidate. This output is tailored not just to what the candidate deserves based on their score, but also reflects the broader context of market and organizational needs. These offer ranges assist the hiring team in making informed decisions regarding hiring offers. The AI-based interviewer might also provide recommendations or justifications for the suggested ranges based on the data-driven insights generated during the process.

The AI model may be an NLP model used to analyze text responses from candidates during interviews, helping to evaluate the sentiment and relevance of their answers. The AI model may be a machine learning regression models applied to identify patterns and relationships in historical compensation data, assisting in predicting appropriate salary ranges based on candidate qualifications and market conditions. The AI model may be a random forest classifier that is utilized to assess multiple features of candidates (experience, skill match, interview scores) to classify candidates into different offer categories. The AI model may be a SVM model employed to determine optimal offer thresholds based on candidate characteristics and market benchmarks, defining clear margin distinctions between different levels of potential compensation. The AI model may be reinforcement learning model utilized to adjust offer strategies dynamically based on feedback and outcomes from previous hiring rounds, continuously optimizing the offer ranges based on real-world results.

For example, in practice, if the AI model correlates a candidate's recruitment score of 88 with a historical benchmark indicating that similar candidates often receive offers in the range of $80,000 to $95,000, the decision supporting subsystem 234 may generate a refined offer range of $85,000 to $90,000. This offer not only reflects the candidate's capabilities but also aligns with their competitive positioning relative to other candidates in similar roles within the organization.

In an aspect, the decision supporting subsystem 234 is configured to analyze qualitative candidate signals (emotional engagement, domain fit, motivation) and external/industry benchmarks (industry salary ranges, market compensation standards) to generate dynamic, personalized offer ranges. The emotional engagement measures how interested and enthusiastic the candidate is (tone of voice, facial expressions, energy in responses). The domain fit measures alignment of candidate's skills and experience with the job's technical/functional requirements. The motivation measures intent and willingness to accept the role (derived from explicit responses and inferred cues). The Industry benchmarks are external salary/benefit data for similar roles, geographies, and industries. The inferred candidate preferences are personalized expectations (remote work, flexibility, base vs. bonus emphasis), inferred from answers and behavior.

The decision supporting subsystem 234 collects inputs including emotional cues (e.g., smiling, excited tone—positive engagement), verbal responses (e.g., I'm very passionate about AI research”—high motivation), and stated preferences (e.g., Work-life balance is important”—inferred preference), from the one or more candidates through the AI-based interviewer. The decision supporting subsystem 234 further collects industry compensation benchmarks (salary ranges per role, geography, seniority), from external one or more data sources. The decision supporting subsystem 234 extracts signals and scores using one or more ML models comprising NLP and vision model. In view of emotional engagement scoring the NLP and vision models analyze tone, facial micro expressions, and consistency. For example, the NLP and vision models provide 0.85 engagement score for enthusiastic tone with strong eye contact. In view of domain fit scoring, the NLP model compares candidate's skills, experience, certifications to job description. For example, the NLP model provides 0.9 domain fit score for candidate's 5 years in cloud security. In view of motivation scoring, the NLP detects language like “I'm excited to contribute long-term.” For example, the NLP provides 0.8 motivation score for frequent expressions of eagerness.

Each score is weighted depending on employer's priorities. For example, for a critical technical role, the decision supporting subsystem 234 assigned 50% for domain fit that is greater than engagement being assigned with 30% that is greater than motivation being assigned with 20%. For a client-facing role, the engagement (40%) may carry more weight.

The decision supporting subsystem 232 fetches industry compensation benchmarks (e.g., Glassdoor, Payscale, proprietary datasets). The decision supporting subsystem 232 further aligns candidate's recruitment scores with benchmark range. For example, the role benchmark is $100 k-$120 k. The candidate's fit scores place them in the upper quartile (>$115 k). The decision supporting subsystem 232 analyzes explicit and inferred candidate preferences. For example, if the candidate emphasizes remote work then the decision supporting subsystem 232 prioritizes flexible work benefits. If the candidate mentions “financial security” then the decision supporting subsystem 232 tilts toward higher base salary, less stock.

The decision supporting subsystem 232 dynamically computes personalized offer range using a formula combines benchmark data, candidate engagement/domain/motivation scores, and candidate preferences. For example, the candidate may receive offer recommendation of $118 k-$125 k with remote option, above median benchmark because of strong fit and high engagement. The decision supporting subsystem 232 outputs candidate's offer recommendation with rationale (e.g., “High domain expertise and strong motivation→upper-quartile compensation suggested”). The decision supporting subsystem 232 has options to adjust the offer recommendations based on employer's budget constraints.

In an exemplary scenario, the decision supporting subsystem 232 provides offer recommendations as $108 k-$112 k along with signing bonus suggested based on engagement having 0.9 (energetic tone, smiles, strong presence), domain fit having 0.95 (directly relevant skills, certifications), motivation having 0.85 (explicit excitement about the role). In another exemplary scenario, the decision supporting subsystem 232 provides offer recommendations as $122 k-$125 k along with near lower-mid range, with retention-focused perks like relocation support based on engagement having 0.55 (monotone, distracted), domain fit having 0.92 (strong technical background), motivation having 0.6 (seems hesitant about relocation).

In an exemplary interview scenario, Jannifer, 4 years marketing experience, applying for Marketing Manager position, is analyzed. The AI-based interviewer interacts with the candidate “Tell me about a time when a marketing campaign didn't perform as expected.” The AI-based interviewer performs real-time analysis of the visual data such as (a) gaze tracking indicates that Jennifer looks down at her hands (eye contact: 15%), (b) head position showing slight downward tilt, and avoiding camera, (c) facial expression showing neutral but tense jaw muscles, and body language showing shoulders slightly hunched with defensive posture. The data analyzing subsystem 228 analyzes the visual data using the computer vision techniques to identify emotions through facial expressions. The gaze tracking system detects sustained eye contact avoidance (85% reduction from baseline), indicating potential d/iscomfort or anxiety about the topic. The data processing subsystem 230 correlates verbal hesitation (“Um . . . well . . . ”) with simultaneous visual cues of discomfort. The transformer-based LLM processes this incongruence between expected confidence and observed behavior.

The AI-based interviewer generating subsystem 226 utilizes behavioral models to guide interactions and emulate human-like behaviors including changing tone based on detected emotional states from the real-time webcam. The AI-based interviewer performs adaptive tine adjustment process by (a) enabling (voice parameter modification) the TTS engine to reduce pitch by 15%, slows speech rate by 20%, (b) adding (vocal warmth increase) slight breathiness to convey empathy, (c) increasing (pause extension) natural pauses to reduce pressure, and (d) reducing (volume softening) volume by 10% to create less intimidating presence.

Finally, the adjusted response of the AI-based interviewer is “That's actually a really valuable learning experience that many marketers face. Take your time—I'm genuinely interested in hearing about how you approached the situation” with softer, warmer tone with slower pacing. The visual behavioral adaptation of the AI-based interviewer is at least one of: (a) facial expression showing slight forward lean with encouraging smile, (b) eye contact maintaining gentle, non-intimidating gaze, and (c) gestures showing palm gestures to convey acceptance and patience. The improvement in candidate response is at least one of: eye contact recovery increasing to 60% within 30 seconds, posture change showing shoulders relax, slight forward lean, and verbal confidence by talking “Actually, there was this product launch campaign . . . ”

In another exemplary interview scenario, the AI-based interviewer delivers a complex question to the candidate asking “How would you integrate omnichannel attribution modeling with customer lifetime value optimization in a privacy-first marketing ecosystem?”. The AI-based interviewer performs real-time analysis of the visual data such as (a) facial expression showing deep frown, furrowed brow (confusion score: 8.2/10), (b) eye movement showing rapid scanning, looking up-right (cognitive processing indicators), (c) head position showing slight backward lean (withdrawal signal), and (d) micro-expressions showing brief lip compression, indicating processing difficulty.

The data analyzing subsystem 228 categorizes facial expressions as confusion and anxiety based on real-time analysis of facial movements and micro-expressions using a convolutional neural network model. Key facial features including eyebrow position (raised and furrowed), mouth curvature (downward), and eye openness (slightly narrowed) indicate comprehension difficulty. The data analyzing subsystem 228 further tracks head position and movement patterns to assess candidate comfort and engagement levels. The backward lean combined with frowning indicates cognitive overload and potential question complexity mismatch. The query generating subsystem 232 monitors visual indicators of cognitive processing including facial expressions indicating concentration and generates contextually appropriate follow-up questions influenced by real-time visual feedback.

The question clarification process involves (a) detecting confusion within 2.3 seconds of question delivery and triggers adaptive response protocol, (b) breaking, using the transformer-based LLM, down the complex question into digestible components such as omnichannel attribution (tracking customer touchpoints), customer lifetime value (long-term customer worth), and privacy-first ecosystem (data protection considerations), and re-phrasing the questions by the AI-based interviewer. The clarified response of the AI-based interviewer is “Let me break that down a bit. I'm really asking about three things: First, how do you track which marketing channels are working best for your customers? Second, how do you think about the long-term value of those customers? And third, how do you do both of these things while respecting customer privacy? You can tackle any one of these areas first.”, with slightly slower pace, more supportive tone.

The AI-based interviewer provides visual behavioral support by providing (a) facial expression (i.e., the AI-based interviewer displays patient, encouraging expression), (b) gestures (i.e., the AI-based interviewer uses counting gestures (holding up fingers for “three things”)), and (c) head movement (slight nod to convey understanding and support). The AI-based interviewer continuously monitors Jennifer's facial expressions for comprehension indicators such as frown reduction that decreases from 8.2/10 to 4.1/10 within 15 seconds, eye contact showing that the candidate returns to camera (engagement recovery), and micro-expressions such as slight smile indicating relief and understanding. The improvement in the candidate's response is “Oh, that makes much more sense! So for tracking channels, I typically use . . . ”.

The AI-based interviewer generating subsystem 226 coordinates (a) audio adaptation i.e., TTS modifications for tone, pace, and warmth, (b) visual synchronization i.e., the AI-based interviewer's expressions and gestures matching vocal tone, (c) content adjustment i.e., LLM-generated content appropriate for detected emotional state, and timing optimization i.e., pause lengths and response timing based on visual processing cues. The adaptive responses of the AI-based interviewer may contribute to more accurate contextual attribute determination, such as (a) the verbal attributes i.e., improved through better question comprehension, (b) the non-verbal attributes i.e., enhanced comfort leads to more natural behavior, (c) performance attributes i.e., more accurate assessment due to reduced anxiety, and (d) contextual interaction attributes i.e., better engagement and communication flow.

The impact on recruitment scoring based on the adaptive responses of the AI-based interviewer is provided. Before the adaptive responses, the communication score is 6.2/10 (affected by discomfort and confusion), the confidence level is 5.8/10 (low eye contact and defensive posture), and the technical knowledge is 7.1/10 (limited by question complexity). After the adaptive responses of the AI-based interviewer, the communication score is 8.1/10 (improved through supportive interaction), the confidence level is 7.9/10 (recovered through tone adjustment and clarification), and the technical knowledge is 8.4/10 (accurately assessed through appropriate questioning). The impact of the final recruitment score is original trajectory: 6.4/10 (would suggest lower offer range) and post-adaptation: 8.1/10 (supports competitive offer range).

The improved recruitment score, achieved through adaptive interviewing techniques, influences the offer range generation to reflect the candidate's true capabilities rather than interview anxiety or question complexity issues. The decision supporting subsystem 234 generates an offer range of $75,000-$85,000 instead of the initially projected $65,000-$72,000, demonstrating how adaptive AI interviewing leads to more accurate candidate assessment and appropriate compensation recommendations. This exemplary scenario demonstrates how real-time visual cue detection enables the AI-based interviewer to provide a more supportive, effective interview experience that yields more accurate candidate evaluations for recruitment decision-making.

The plurality of subsystems 114 further includes the output subsystem 222 that is communicatively connected to the one or more hardware processors 202. The output subsystem 222 is configured to provide information associated with at least one of: one or more selected candidates, and the one or more offer ranges generated for the one or more selected candidates, to the one or more users through one or more user interfaces associated with one or more electronic devices of the one or more users.

The output subsystem 222 refers to a component of the computer implemented system that is specifically designed to deliver important information related to candidates and their associated offer ranges to the one or more users. This information is transmitted through the one or more user interfaces linked to the one or more electronic devices 102 utilized by the one or more users. The role of the output subsystem 222 is multifaceted. The output subsystem 222 primarily serves as a communication bridge between the AI's processing capabilities and the one or more users. After the AI model evaluates candidates, generates recruitment scores, and determines offer ranges, this output subsystem 222 ensures that: (a) the one or more users receive detailed information about selected candidates, such as their performance during interviews and relevant qualifications, (b) the one or more offer ranges generated for each candidate are presented in a comprehensible format, enabling users to make informed hiring decisions, and (c) the information may be accessed through different user interfaces, including desktop applications, mobile apps, or web portals, facilitating ease of use across different electronic devices 102.

For example, imagine a scenario where a company is seeking to hire a software engineer. After conducting interviews using the AI-based interviewer, the output subsystem 222 compiles the performance scores of multiple candidates. The output subsystem 222 generates offer ranges say, $90,000 to $110,000 for Candidate A and $95,000 to $105,000 for Candidate B.

The output subsystem 222 is configured to provide the refined results in one or more formats, ensuring a standardized and versatile output for seamless integration and analysis. The output subsystem 222 ensures that output data is presented in consistent formats, such as JSON, XML, or CSV. This standardization is essential for uniformity, allowing different systems and users to interpret the output data without confusion. The output subsystem 222 is capable of generating outputs in multiple formats to accommodate the varying needs of the one or more users. This might include numerical reports, graphical representations, or machine-readable formats depending on the end-user requirements. The outputs generated can easily be integrated into existing data pipelines, visualization tools, or reporting systems, thereby enhancing usability and facilitating further analytical tasks. The outputs may be directed to multiple user interfaces associated with the one or more electronic devices 102, such as desktop computers, mobile devices, or web interfaces where the one or more users can access and interact with the results.

In an aspect, the plurality of subsystems further includes a fallback subsystem that is communicatively connected to the one or more hardware processors 202. The fallback subsystem provides fallback to human intervention when at least one of: candidate responses are ambiguous, vision/NLP confidence drops below a threshold, or behavioral flags are raised, such as fraud suspicion. The fallback to the human intervention logic is a safeguard mechanism within the computer implemented system 112 that ensures reliability, fairness, and compliance during candidate interviews. The fallback subsystem activates the fallback when candidate responses are ambiguous (e.g., vague or contradictory answers), system confidence drops below a threshold (e.g., NLP misinterprets meaning, vision model uncertain about non-verbal cues), and behavioral red flags are raised (e.g., suspicion of fraudulent activity, impersonation, or cheating). When these conditions are detected, the fallback subsystem escalates the interview session to a human recruiter, either in real-time or after flagging for review.

The fallback subsystem continuously collects and processes candidate responses from audio, video, and text (e.g., the NLP model evaluates semantic clarity (confidence score for meaning extraction), the vision model checks non-verbal cues (e.g., facial expressions, eye contact, lip sync), and behavioral analysis checks for fraud signals (e.g., multiple faces detected, screen-switching)). The fallback subsystem assigns a confidence score (e.g., 0-1 scale) for each process outcomes performed by NLP in semantic interpretation, vision model in emotion recognition/gesture alignment, and fraud detection in probability of anomaly.

The fallback subsystem compares confidence scores corresponding to each process outcomes against pre-assigned threshold scores. For example, if NLP confidence is less than 0.7 then ambiguity is flagged. If vision model confidence is less then 0.6 then uncertainty is flagged. If fraud suspicion is greater than 0.8 then a fraud alert is raised. The fallback subsystem triggers the fallback logic when any threshold condition is met. The fallback subsystem performs actions including at least one of: pause automated questioning, escalate interview to a human recruiter dashboard, and highlight flagged segments (timestamps+risk type). Finally, a human recruiter takes over or reviews flagged sections. The human recruiter has options including at least one of: join live interview to clarify candidate responses, review session logs to make a decision later, and provide manual override (approve/deny continuation).

In an exemplary scenario, the fallback subsystem identifies some ambiguous response from candidate says, “I kind of did some coding, but not really, maybe in college, but I don't remember”. The fallback subsystem analyzes that the NLP model confidence level for the candidate response is 0.45 (low). The fallback subsystem triggers the fallback to the human recruiter to join to clarify “Can you specify which programming languages you used in college?”. In another exemplary scenario, the fallback subsystem identifies that a candidate looks away from camera often and lighting is poor. The fallback subsystem analyzes that the vision model confidence level is 0.52 (low). The fallback subsystem flags “uncertain visual interpretation” and triggers the fallback to the human recruiter to review video manually to assess candidate engagement.

FIG. 2C illustrates a sequence diagram representing a flow from video input of a candidate to computer vision speech recognition engine, a conversation engine, and a text to speech engine, to generate a response by an AI-based interviewer, in accordance with an embodiment of the present disclosure.

At step 236, the video stream is captured from the webcam 108 (visual data), and the audio stream is captured simultaneously from the candidate's speech through the microphones 110.

At step 238, the computer vision processes such as facial expression analysis for emotion detection, eye contact and gaze tracking, body language and gesture interpretation, head movement and posture analysis, of the one or more candidates, are performed.

At step 240, the speech recognition processes such as audio-to-text conversion of candidate responses, phonetic analysis for speech patterns, vocal tone and emotion extraction, are performed.

At step 242, the conversation engine with multi-modal analysis is configured to: (a) process the text responses using the LLM model, (b) integrate the visual cues of the candidate with the verbal contents, (c) determine one or more contextual attributes including verbal, non-verbal, performance, and interaction, (d) generate emotion-adaptive responses, (e) generate dynamic questions (contextually appropriate follow-up questions) with re-ranking, (f) tone-adapted responses based on audio/visual cues, and (g) guide behavioral model-driven interaction.

At step 244, the text-to-speech engine is configured to: convert the generated text to natural speech, (b) extract phoneme timing data for lip synchronization, and (c) adjust vocal parameters (tone, pace, warmth) based on candidate state.

At step 246, the AI-based interviewer is configured to respond to the candidates with at least one of: real-time lip synchronization with phoneme data, coordinated facial expressions matching vocal tone, gesture timing aligned with speech content, professional avatar behavior maintenance, emotional responses, empathy expression, tone changes.

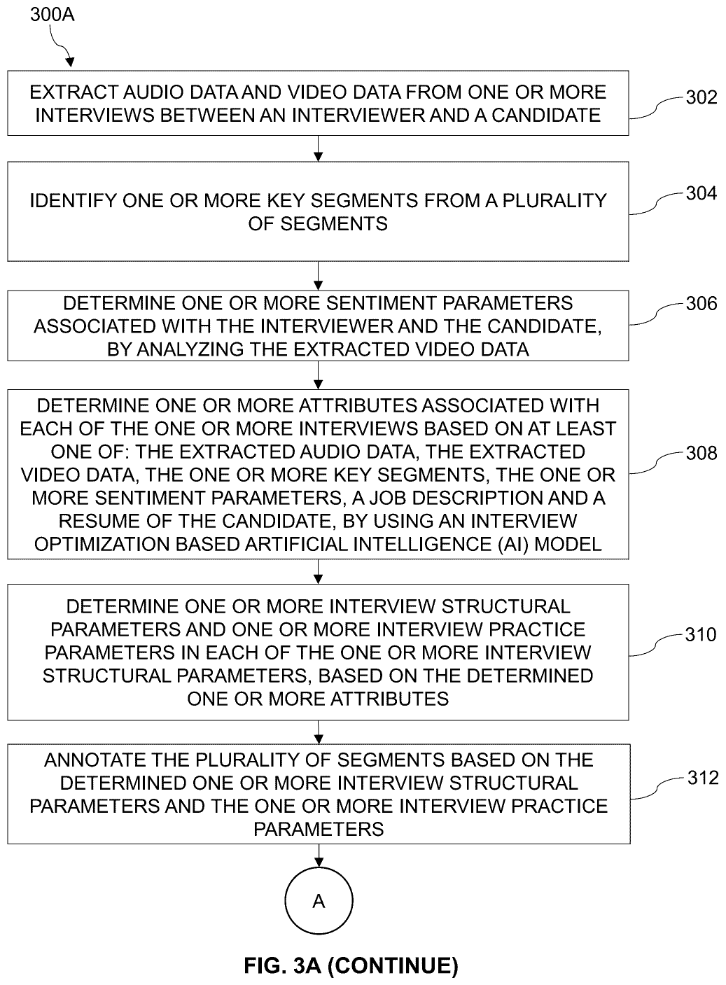

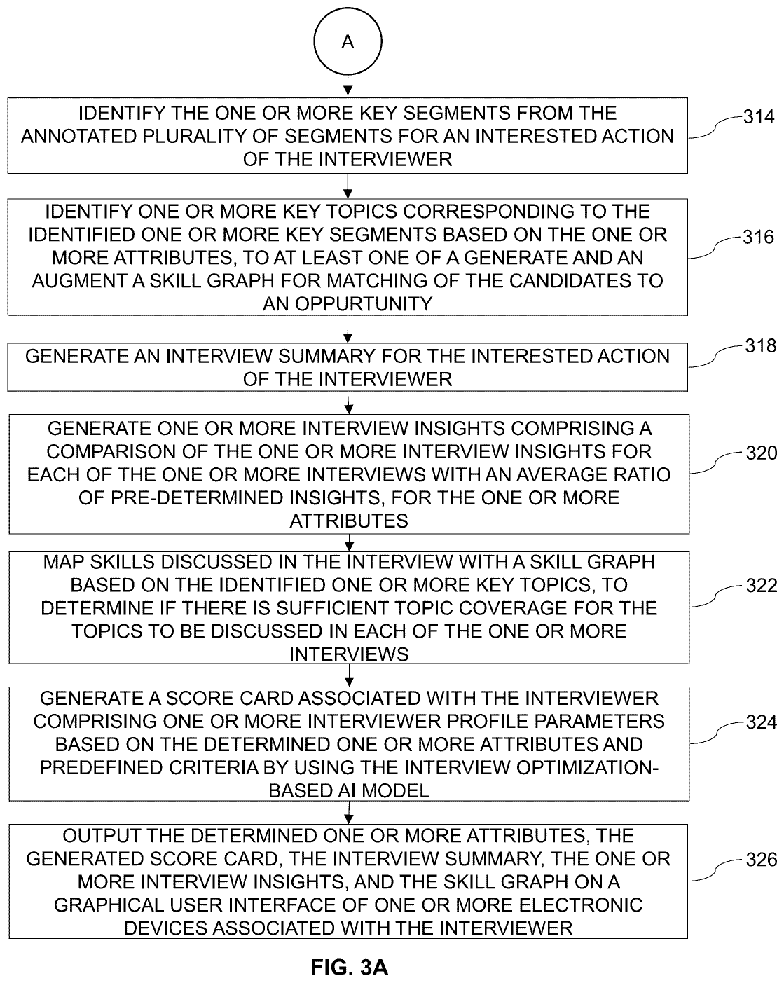

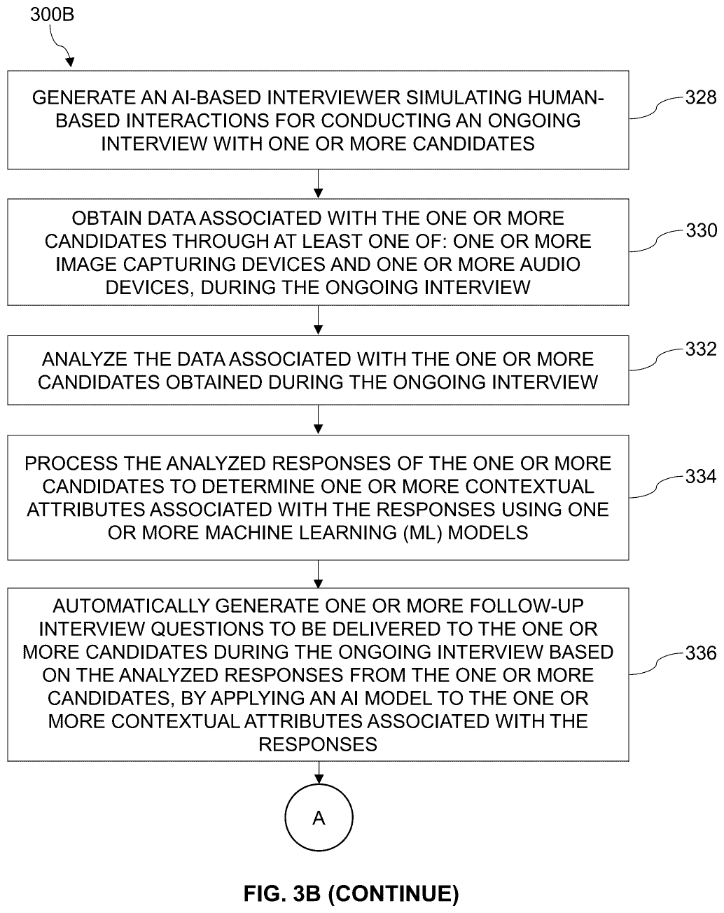

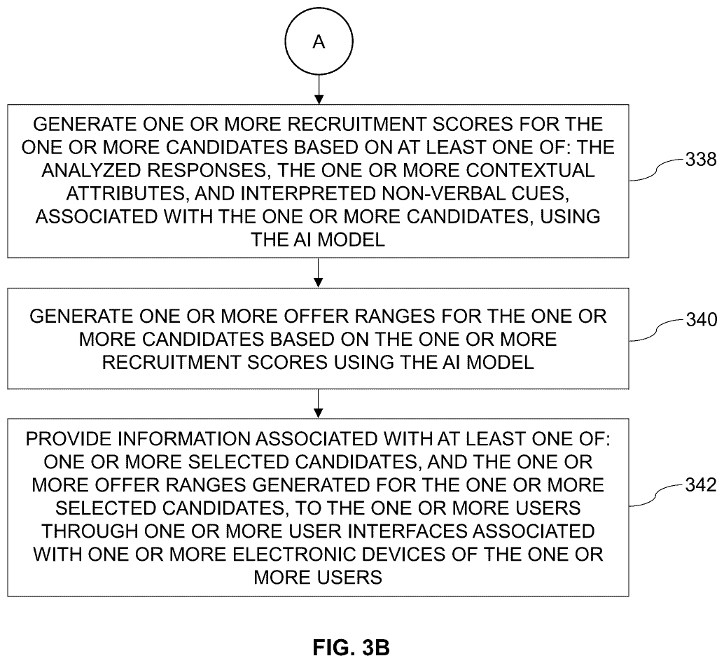

FIG. 3A illustrates an exemplary flow chart representation depicting a method 300A for generating interview insights in an interviewing process, in accordance with an embodiment of the present disclosure.

At block 302, the method 300A includes extracting, by the one or more hardware processors 202 associated with a computer implemented system 112, audio data and video data from one or more interviews between an interviewer and a candidate. In an embodiment of the present disclosure, the one or more interviews may be captured by the one or more image capturing devices 108 and the one or more microphones 110. In an embodiment of the present disclosure, the one or more interviews may be ongoing interviews. In another embodiment of the present disclosure, the one or more interviews may be pre-stored interviews stored in a storage unit 206.

At block 304, the method 300A includes identifying, by the one or more hardware processors 202, one or more key segments from a plurality of segments. The plurality of segments is identified from the extracted audio data corresponding to the interviewer and the candidate. The plurality of segments is identified from the extracted audio data corresponding to the interviewer and the candidate. In identifying the one or more key segments from the plurality of segments, the method 300A includes converting the extracted audio data into a plurality of text streams using a natural language processing technique and an audio analytic technique. Further, the method 300A includes determining one or more portions of the plurality of text streams corresponding to the interviewer and the candidate. In an embodiment of the present disclosure, the one or more conversation dividers between the interviewer and the interviewee may be identified to determine the one or more portions of the plurality of text streams corresponding to the interviewer and the candidate. The method 300A includes dividing the plurality of text streams into the plurality of segments based on the determined one or more portions. Furthermore, the method 300A includes annotating the plurality of segments. The method 300A includes identifying the one or more key segments from the annotated plurality of segments. The one or more key segments are sections of the plurality of segments in which relevant topics are discussed, such as qualification, experience, soft skills of the candidate and the like. In an embodiment of the present disclosure, the method 300A includes determining and assigning the identity of the interviewer and the candidate by analyzing the extracted audio data using an audio analytics technique.

At block 306, the method 300A includes determining, by the one or more hardware processors, one or more sentiment parameters associated with the interviewer and the candidate, by analyzing the extracted video data, wherein the one or more sentiment parameters comprise at least one of emotions, attitudes and thoughts associated with the interviewer and the candidate. In an exemplary embodiment of the present disclosure, the one or more sentiment parameters include emotion, attitude, thought of the interviewer and the candidate and the like. In determining the one or more sentiment parameters for the interviewer and the candidate by analyzing the extracted video data, the method 300A includes determining identity of the interviewer and the candidate by analyzing the extracted video data using a video analytics technique. Further, the method 300A includes determining the one or more sentiment parameters corresponding to the determined identity of the interviewer and the candidate by performing sentiment analysis on the extracted video data.

At block 308, the method 300A includes determining, by the one or more hardware processors 202, one or more attributes associated with each of the one or more interviews based on at least one of: the extracted audio data, the extracted video data, the one or more key segments, the one or more sentiment parameters, a job description and a resume of the candidate, by using an interview optimization based Artificial Intelligence (AI) model. In an exemplary embodiment of the present disclosure, the one or more attributes include talk ratio, inactivity, sentiment level, plurality of keywords, range, candidate at risk, questions asked by the interviewer during the one or more interviews, interview bias probability, relevance of the one or more interviews to the job description, company pitch, assessment report reference and the resume of the candidate, timelines in the interview, and the like. The talk ratio is ratio of time spent by the interviewer and the candidate in the one or more interviews. Inactivity is a time-period associated with the one or more interviews in which the interviewer and the candidate are in an ideal state. In an embodiment of the present disclosure, the determined identity of the interviewer and the candidate may also be used to determine the one or more attributes, such as the talk ratio and the inactivity. In an embodiment of the present disclosure, each of the one or more attributes may have a predefined score associated with it. In obtaining relevance of the one or more interviews to the job description, the company pitch, the assessment report reference and the resume of the candidate, the method 300A includes extracting the plurality of keywords from the job description, the company pitch, the assessment report reference, and the resume of the candidate. Further, the method 300A includes mapping the extracted plurality of keywords with the plurality of segments. The method 300A includes determining relevance of the one or more interviews to the job description, the company pitch, the assessment report reference, and the resume of the candidate based on the result of mapping. For example, when most of the extracted plurality of keywords are covered in the plurality of segments, it may be said that the one or more interviews are relevant to the job description, the company pitch, the assessment report reference, and the resume of the candidate. In an embodiment of the present disclosure, it may be identified where each of the extracted plurality of keywords is used in the one or more interviews.

At block 310, the method 300A includes determining, by the one or more hardware processors 202, one or more interview structural parameters and one or more interview practice parameters in each of the one or more interview structural parameters, based on the determined one or more attributes. The one or more interview structural parameters includes introduction of the interviewer and the candidate, discussion between the interviewer and the candidate, and conclusion of the interviewer and the candidate, and the like.

At block 312, the method 300A includes annotating, by the one or more hardware processors 202, the plurality of segments based on the determined one or more interview structural parameters and the one or more interview practice parameters.

At block 314, the method 300A includes identifying, by the one or more hardware processors, the one or more key segments from the annotated plurality of segments for an interested action of the interviewer.

At block 316, the method 300A includes identifying, by the one or more hardware processors 202, one or more key topics corresponding to the identified one or more key segments based on the one or more attributes, to at least one of a generating and an augmenting a skill graph for matching of the candidates to an opportunity.

At block 318, the method 300A includes generating, by the one or more hardware processors 202, an interview summary for the interested action of the interviewer, wherein the interested action comprises at least one of an action of an inference of topics discussed in the interview and an action of a preparation of upstream notes of the one or more interviews.

At block 320, the method 300A includes generating, by the one or more hardware processors 202, one or more interview insights comprising a comparison of the one or more interview insights for each of the one or more interviews with an average ratio of pre-determined insights, for the one or more attributes. The one or more interview insights include language insights, situational judgement insights, diversity, equity, and inclusion (DEI) insights, legal risk and compliance insights, interview bias probability insights, domain insights, and the like.

At block 322, the method 300A includes mapping, by the one or more hardware processors 202, skills discussed in the interview with a skill graph based on the identified one or more key topics, to determine if there is sufficient topic coverage for the topics to be discussed in each of the one or more interviews.

At block 324, the method 300A includes generating, by the one or more hardware processors, a score card associated with the interviewer comprising one or more interviewer profile parameters based on the determined one or more attributes and predefined criteria by using the interview optimization-based AI model. In an exemplary embodiment of the present disclosure, the one or more profile parameters include interview evaluations, number of interviews completed, learning score, number of comments, average candidate rating, time to interview, offer acceptance rate, select or reject ratio, average repeated questions per interview, compliance with guidance, interviewer learning path recommendation and the like. The offer acceptance rate is the rate at which job offers are accepted by the candidates. Further, the select or reject ratio is a ratio at which the interviewer selects the candidates. In an embodiment of the present disclosure, the predefined criteria may be used to obtain compliance with guidance. In generating the score card associated with the interviewer including the one or more interviewer profile parameters based on the determined one or more attributes and the predefined criteria by using the interview optimization-based AI model, the method 300A includes generating one or more scores corresponding to each of the one or more attributes based on the determined one or more attributes and the predefined criteria by using the interview optimization-based AI model. Further, the method 300A includes generating the score card for the generated one or more scores by using the interview optimization-based AI model.

At block 326, the method 300A includes outputting, by the one or more hardware processors 202, the determined one or more attributes, the generated score card, the interview summary, the one or more interview insights, and the skill graph on a graphical user interface of one or more electronic devices associated with the interviewer. The one or more electronic devices 102 may include a laptop computer, desktop computer, tablet computer, smartphone, wearable device, smart watch and the like. In an embodiment of the present disclosure, the interviewer may use the output one or more attributes and the score card for training himself/herself. Further, the method 300A includes outputting one or more notifications corresponding to the extracted plurality of keywords on the graphical user interface of the one or more electronic devices 102 based on the mapping of the extracted plurality of keywords with the plurality of segments. In an embodiment of the present disclosure, the method 300A includes outputting the one or more notifications corresponding to the extracted plurality of keywords for ascertaining that all the extracted plurality of keywords are covered by the interviewer during the one or more interviews. For example, when the interviewer forgets to cover keywords related to the job description, the one or more notifications may be output corresponding to the keywords related to the job description. The one or more notifications may be in the form of visual, audio, audio visual and the like. In an exemplary embodiment of the present disclosure, the one or more notifications include one or more images with the plurality of keywords, one or more cues with the plurality of keywords and the like. In an embodiment of the present disclosure, the one or more notifications may be output in real-time.

In an embodiment of the present disclosure, the method 300A also includes providing offer acceptance and job performance of the candidate selected by the interviewer as inputs to the interview optimization-based AI model for training. In an embodiment of the present disclosure, when the interview optimization-based AI model is trained based on the offer acceptance and job performance of the candidate selected by the interviewer, the interview optimization-based AI model may determine success rate of the interviewer in selecting the candidate. For example, when the job performance of the candidate selected by the interviewer is good, the success rate of the interviewer is high. Further, when the job performance of the candidate selected by the interviewer is poor, the success rate of the interviewer is low.

The method 300A may be implemented in any suitable hardware, software, firmware, or combination thereof.

FIG. 3B illustrates an exemplary flow chart illustrating a computer implemented method 300B for generating the one or more offer ranges in the interviewing process, in accordance with an embodiment of the present disclosure

At step 328, the AI-based interviewer simulating the human-based interactions is generated for conducting an ongoing interview with one or more candidates.

At step 330, the data associated with the one or more candidates through at least one of: the one or more image capturing devices 108 and one or more audio devices (i.e., the one or more microphones 110), during the ongoing interview. The data associated with the one or more candidates may include at least one of: the profile information, responses in form of the audio and text, and the non-verbal cues, associated with the one or more candidates.

At step 332, the data associated with the one or more candidates are analyzed during the ongoing interview. In an embodiment, analyzing the data associated with the one or more candidates includes processing of the responses of the one or more candidates using the natural language processing (NLP) techniques, and interpreting the one or more non-verbal cues.

At step 334, the analyzed responses of the one or more candidates are processed to determine one or more contextual attributes associated with the responses using one or more machine learning (ML) models. The one or more contextual attributes may include at least one of: the one or more verbal attributes, the one or more non-verbal attributes, the one or more performance attributes, and the one or more contextual interaction attributes.

At step 336, the one or more follow-up interview questions to be delivered to the one or more candidates are automatically generated during the ongoing interview based on the analyzed responses from the one or more candidates, by applying the AI model to the one or more contextual attributes associated with the responses.

At step 338, the one or more recruitment scores are generated for the one or more candidates based on at least one of: the analyzed responses, the one or more contextual attributes, and interpreted non-verbal cues, associated with the one or more candidates, using the AI model.

At step 340, the one or more offer ranges are generated for the one or more candidates based on the one or more recruitment scores using the AI model. In an embodiment, the one or more offer ranges are configured to assist for one or more users in recruitment-related decision making.

At step 342, the information associated with at least one of: one or more selected candidates, and the one or more offer ranges generated for the one or more selected candidates, are provided to the one or more users through the one or more user interfaces associated with the one or more electronic devices 102 of the one or more users.

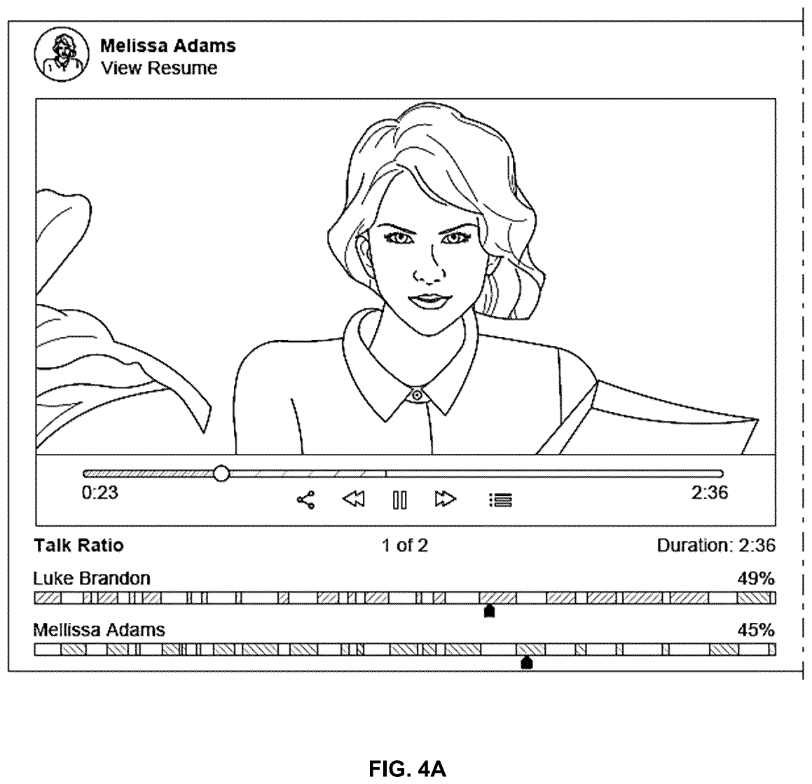

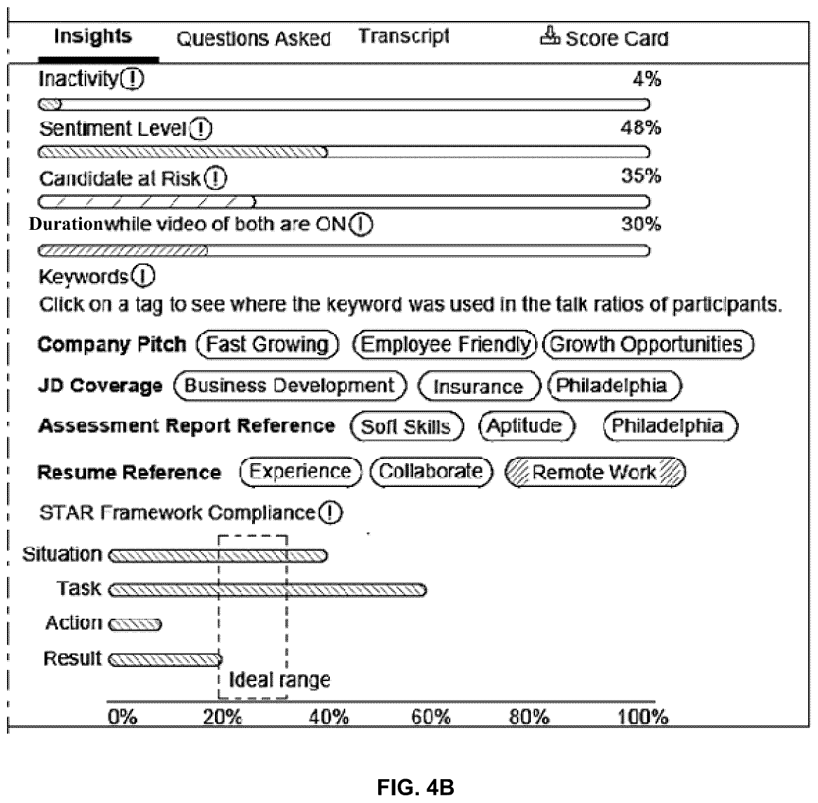

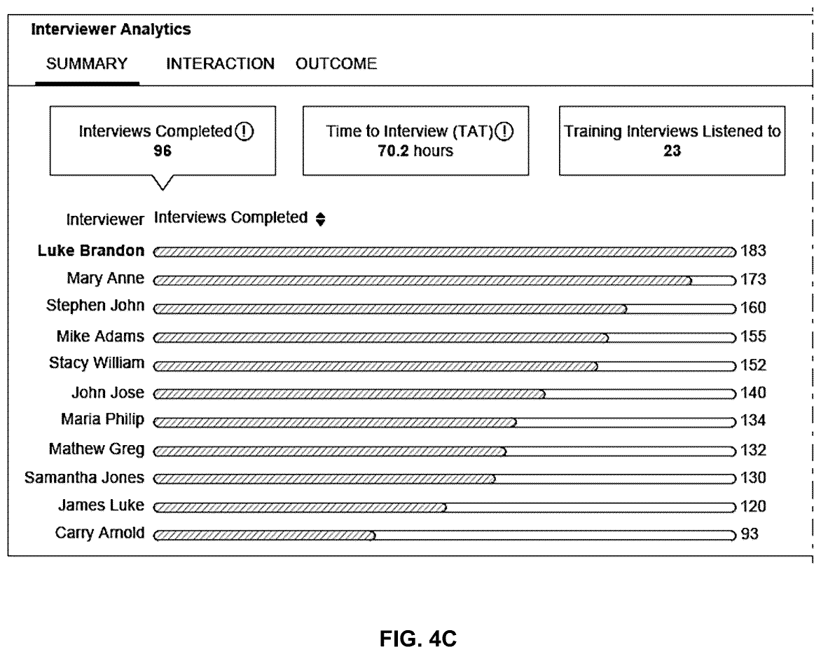

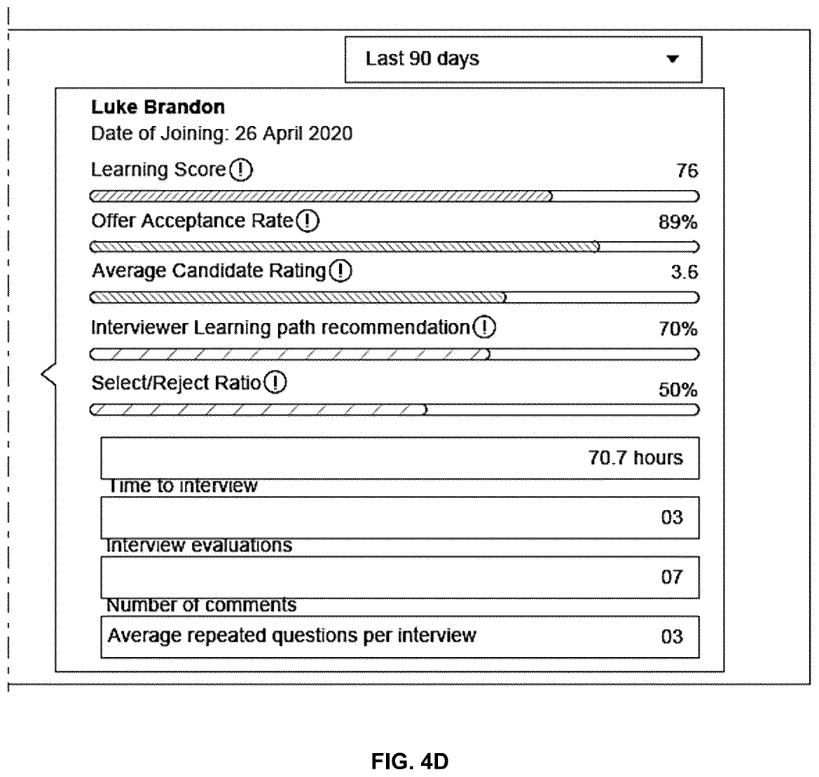

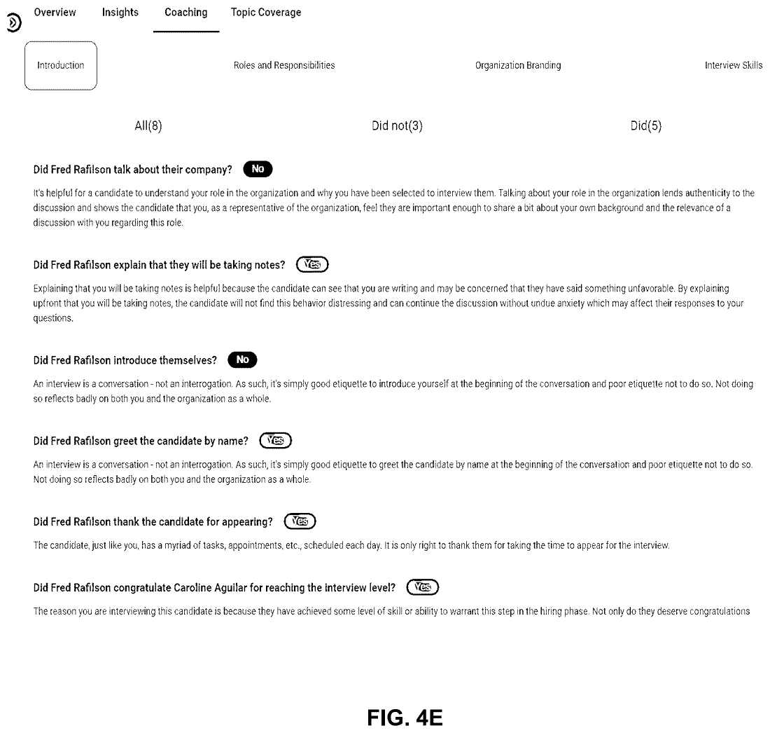

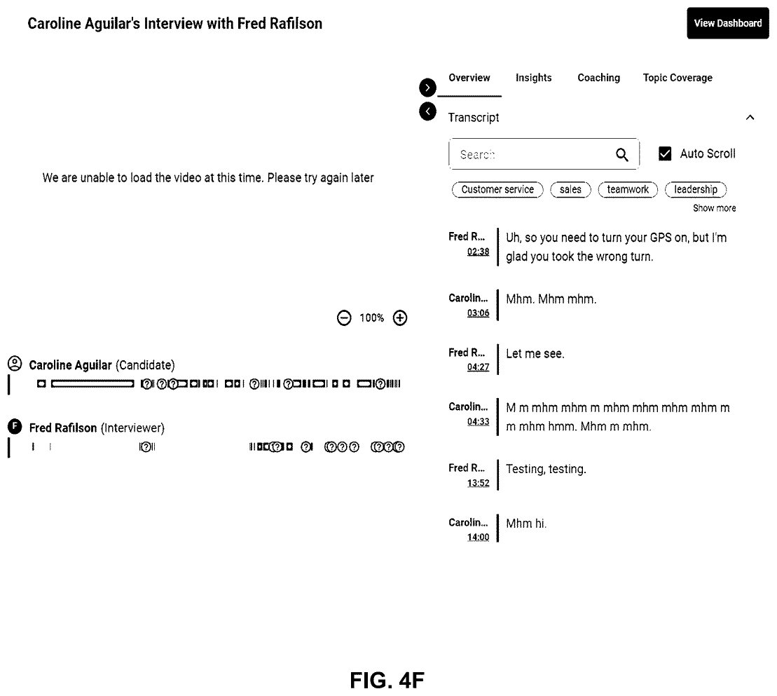

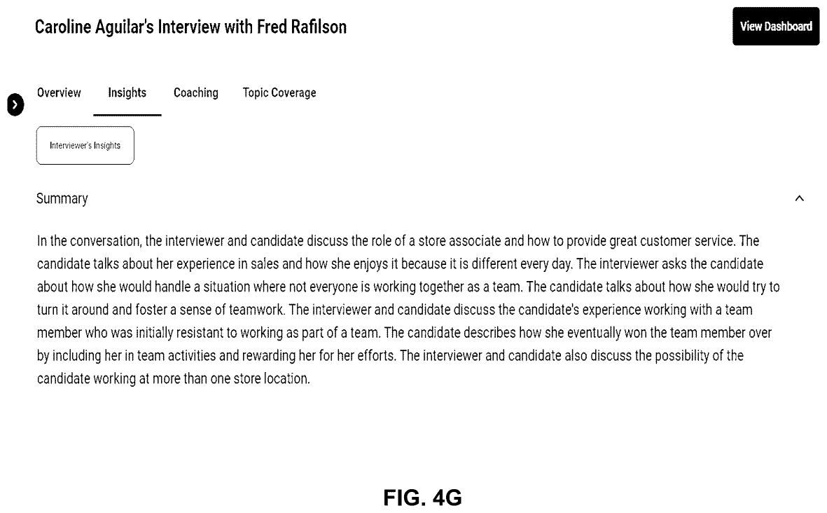

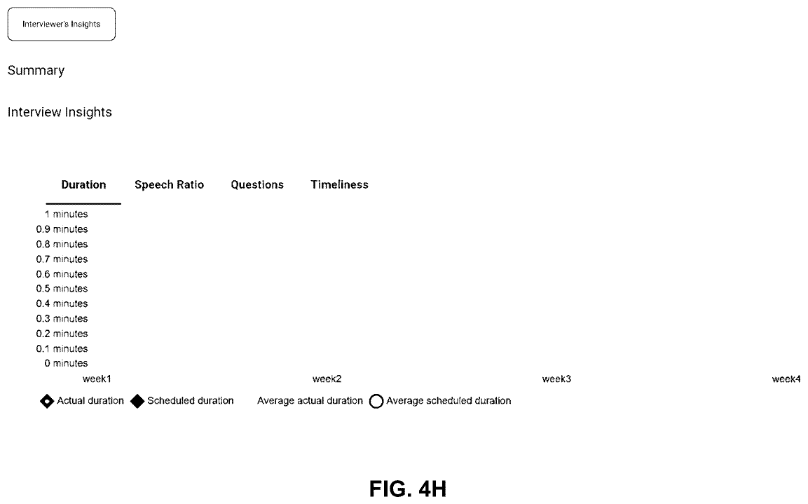

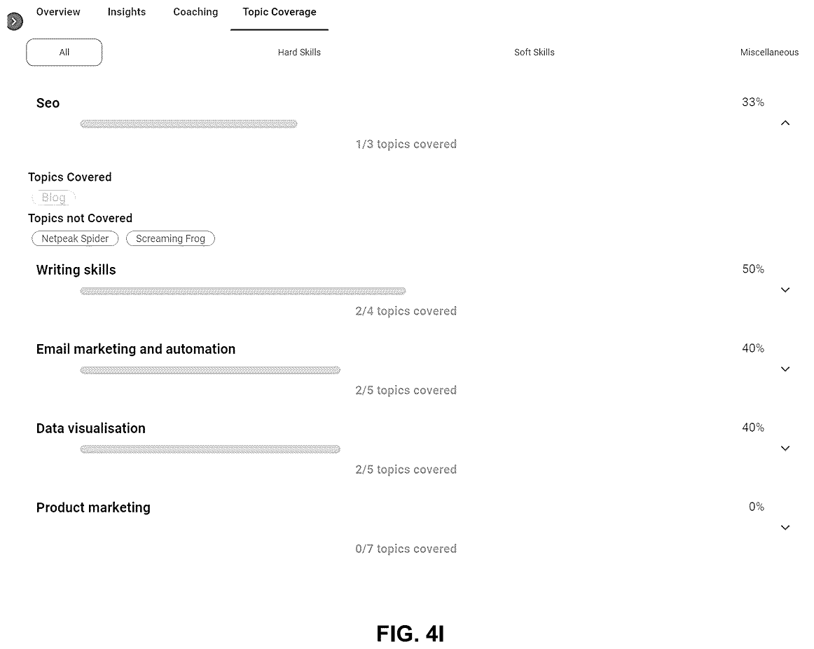

FIGS. 4A and 4B illustrate exemplary schematic diagram representations of graphical user interface screens of web application capable of outputting one or more attributes associated with one or more interviews, in accordance with an embodiment of the present disclosure. The graphical user interface screen of the web application may be accessed by the interviewer via the one or more electronic devices 102. FIGS. 4A and 4B is the graphical user interface screen of the web application capable of outputting the one or more attributes associated with the one or more interviews, which is earlier explained with respect to FIG. 2. The graphical user interface screen displays the one or more interviews, duration of the one or more interviews, talk ratio, the plurality of segments corresponding to the interviewer i.e., Luke Brandon and the candidate i.e., Melissa Adams, as shown in FIG. 4A. In the current scenario, the talk ratio for the interviewer is 49% and the talk ratio for the candidate is 45%. Further, the graphical user interface screen displays insights including inactivity, sentiment level, candidate at risk, duration while video of both is ON and framework compliance along with their respective scores, questions asked by the interviewer during the one or more interviews and transcript as shown in FIG. 4B. In an embodiment of the present disclosure, the framework compliance is displayed along with its ideal range. Furthermore, the interviewer may also click on the plurality of keywords corresponding to the company pitch, job description, assessment report reference and resume of the candidate to identify where each of the extracted plurality of keywords is used in the one or more interviews.

FIGS. 4C and 4D illustrate exemplary schematic diagram representations of graphical user interface screens of a web application capable of outputting score card associated with an interviewer, which is earlier explained with respect to FIG. 2. The graphical user interface screen displays a summary including interviews completed, time to interview and training interviews listened to, interaction, and outcome, as shown in FIG. 4C. Further, the graphical user interface screen also displays date of joining of the interviewer, learning score, offer acceptance rate, average candidate rating, interviewer learning path recommendation, select or reject ratio, time to interview, interview evaluations, number of comments and average repeated questions per interview, as shown in FIG. 4D.

FIGS. 4E and 4F illustrate exemplary schematic diagram representations of graphical user interface screens of a web application capable of outputting interview structure, and interview transcript, respectively, for the interviewer, in accordance with an embodiment of the present disclosure. The graphical user interface screen shown in FIG. 4E displays interview structure, which includes how interviewers are structuring the interview based on introduction, discussion, and conclusion, between interviewer and candidate. Further, the computer implemented system 112 determines if the interviewer is following best practices during each of the introduction, the discussion, and the conclusion. Further, the computer implemented system 112 also analyzes if the interviewer is explaining the roles and responsibilities correctly and pitching the organization and the opportunity appropriately.

Further, the graphical user interface screen shown in FIG. 4F displays an interview transcript by automatically identifying and annotating, by the computer implemented system 112, questions and other speech bubbles that could be of interest to the interviewer or a hiring manager or a recruiter. The transcript itself may be searchable and key topics are surfaced for quick review.

FIGS. 4G and 4H illustrate exemplary schematic diagram representations of graphical user interface screens of a web application capable of outputting interview summary, and interview insights, respectively, for the interviewer, in accordance with an embodiment of the present disclosure.

The graphical user interface screen shown in FIG. 4G displays an interview summary. The computer implemented system 112 may automatically prepare a summary of the interview conversation that helps the interviewer, the recruiter, or the hiring manager to have a good understanding of what was discussed, and the interviewer, the recruiter, or the hiring manager can prepare upstream notes based on the interview summary. For example, to prepare the interview summary, the computer implemented system 112 may analyze an interview transcript to understand the key topics and segments of the conversation. Further, the computer implemented system 112 may combine key topics and segments of conversation to generate a summary that is readable by a human.

The graphical user interface screen is shown in FIG. 4H displays interview insights which include a comparison of how a particular interview compares with the organization/industry average interviews/standards, based on parameters such as duration, talk ratio, number of questions, timeliness in the interview, and the like. In an embodiment, the language insights may be an ability to build a score of a candidate's skill in a particular language by analyzing the interview. For example, the computer implemented system 112 may provide insights for the interviewer, by comparing various attributes of the interview against the median values of those attributes on the platform or against an industry best practice.

Further, the situational judgement insights may be an ability to understand how the candidate may respond to various situations and mimic a traditional situational judgement test. In an exemplary embodiment, the DEI insights may be extracted using DEI features. The DEI features are extracted, by the computer implemented system 112, based on extracting gender, age of the candidate and other identifiable attributes from the interview video for the purpose of identifying any visible patterns of bias exhibited by interviewers during the interview.

In an exemplary embodiment, legal risk and compliance insights may be provided based on monitoring and flagging language, by the computer implemented system 112, used in interviews that might lead to legal risk with respect to lack of compliance with equal employment opportunity commission (EEOC) regulations and other similar rules. Further, interview bias probability insights are based on detecting, monitoring and flag language, by the computer implemented system 112, in the interview that might not well suited for candidates from varied demographics. In an exemplary embodiment, domain insights are based on scoring, by the computer implemented system 112, candidate responses for the proficiency of the candidate in a particular domain by using the skill graph.

FIG. 4I illustrates an exemplary schematic diagram representation of a graphical user interface screen of a web application capable of outputting topic coverage during the interviewing process, in accordance with an embodiment of the present disclosure. The graphical user interface screen is shown in FIG. 4I displays one or more key topics coverage. Based on the job description and resume of the candidate, the computer implemented system 112 may identify one or more key topics leveraging a skill graph that should be discussed in the interview and corresponding coverage in actual interview. For example, one or more external/internal databases may include an up-to-date skill graph with skills along with one or more associated topics for each skill. The one or more external/internal databases may monitor logs mentions of the topics or related keywords in the conversation. The computer implemented system 112 may use the topics or related keywords to compare with the list of skills mentioned in a job description and the list of skills mentioned in a resume of the candidate. In a quality interview, there should be sufficient coverage of topics from both the job description and the resume. The computer implemented system 112 may output the topic coverage during the interviewing process, based on the coverage of topics from both the job description and the resume, and the corresponding interview.

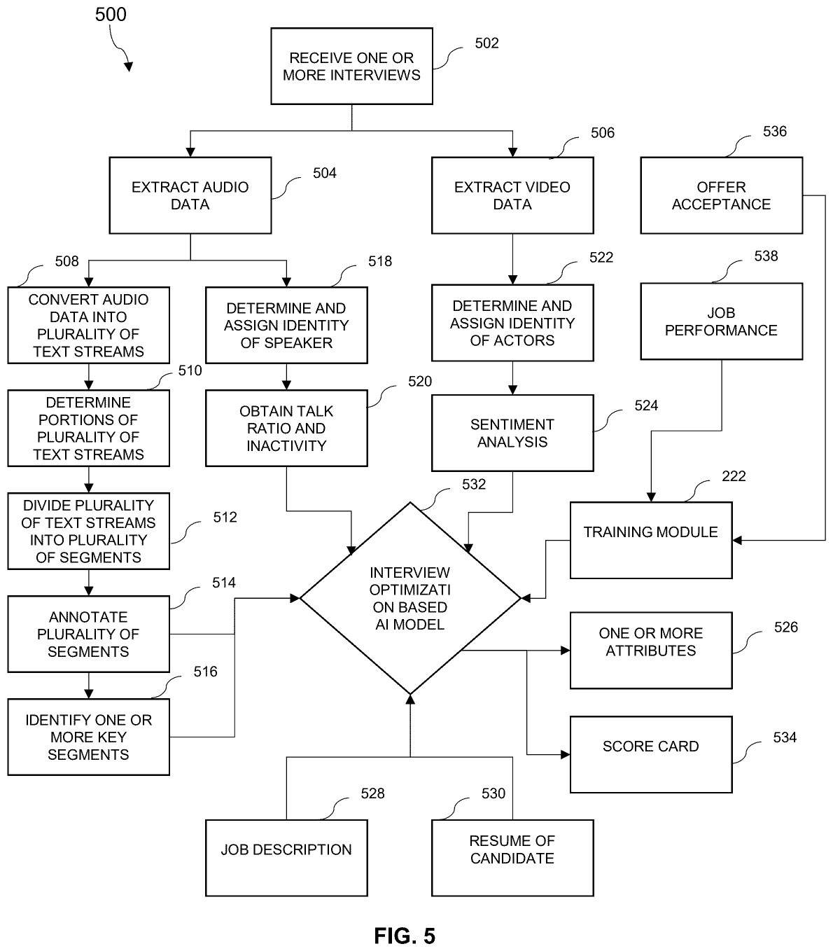

FIG. 5 illustrates an exemplary flow diagram representation depicting a method 500 for facilitating the interviewing process, in accordance with an embodiment of the present disclosure. The computer implemented system 112 receives one or more interviews 502 captured by the one or more image capturing devices and the one or microphones. Further, the computer implemented system 112 extracts audio data 504 and the video data 506. The computer implemented system 112 converts the audio data into the plurality of text streams 508. The computer implemented system 112 also determines one or more portions of the plurality of text streams 510 corresponding to the interviewer and the candidate. Furthermore, the computer implemented system 112 divides the plurality of text streams into the plurality of segments 512 based on the determined one or more portions. The computer implemented system 112 annotates the plurality of segments 514. Further, the computer implemented system 112 identifies the one or more key segments 516 from the annotated plurality of segments.

Further, the computer implemented system 112 determines and assigns identity of the interviewer and the candidate 518 by analyzing the extracted audio data using the audio analytics technique. The computer implemented system 112 obtains talk ratio and inactivity 520 based on the determined and assigned identity of the interviewer and the candidate. Furthermore, the computer implemented system 112 determines and assigns the identity of the interviewer and the candidate 522 by analyzing the extracted video data using the video analytics technique. The computer implemented system 112 determines the one or more sentiment parameters corresponding to the determined identity of the interviewer and the candidate by performing sentiment analysis 524 on the extracted video data. Further, the computer implemented system 112 determines the one or more attributes 526 associated with the one or more interviews based on the extracted audio data, the extracted video data, the one or more key segments, the annotated plurality of segments, the one or more sentiment parameters, job description 528, resume of the candidate 530 or any combination thereof by using the interview optimization-based AI model 532. The job description 528, and resume of the candidate 530 are ML models, these two models, trained with millions of resumes and job descriptions. The computer implemented system 112 populates relevant keywords and skills from a resume, the computer implemented system 112 will match and the skills and responsibilities that are mentioned in the job description from the resume are retrieved. The computer implemented system 112 also generates the score card 534 associated with the interviewer including the one or more interviewer profile parameters based on the determined one or more attributes and the predefined criteria by using the interview optimization-based AI model 532. The training subsystem 224 is configured to provide offer acceptance 536 and job performance 538 of the candidate selected by the interviewer as inputs to the interview optimization-based AI model 532 for training. The interview optimization-based AI model 532 determines the success rate of the interviewer in selecting the candidate.

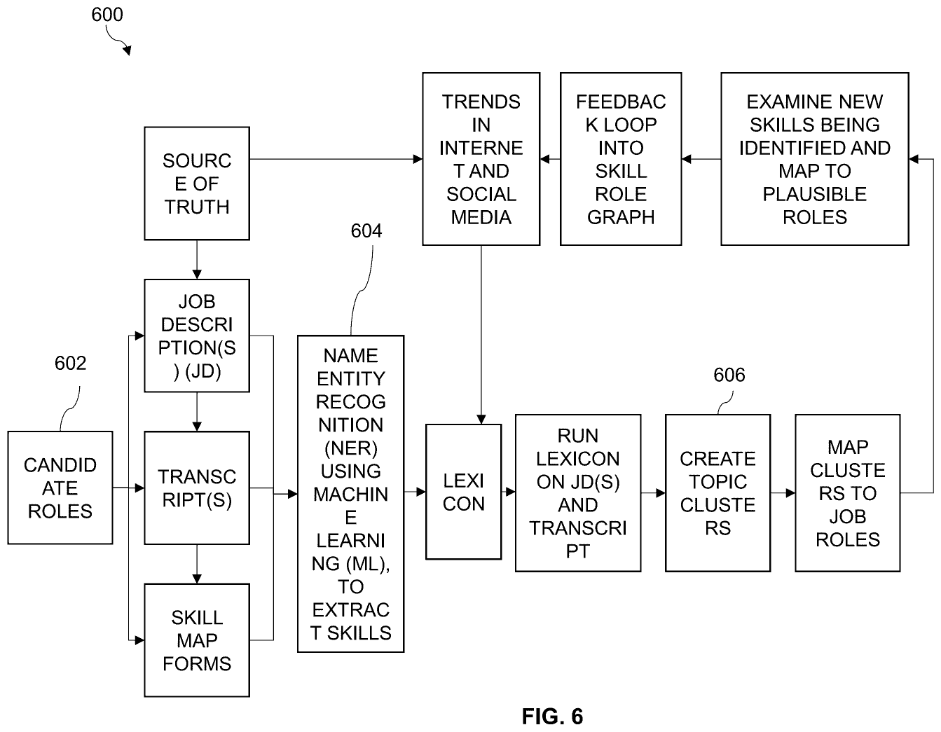

FIG. 6 illustrates an exemplary flow diagram representation depicting a method 600 for creating topic clusters for one or more exemplary candidate roles, in accordance with an embodiment of the present disclosure.

At step 602, the method 600 includes receiving, by the computer implemented system 112, one or more exemplary candidate roles. For example, consider the candidate role as software developer. The computer implemented system 112 may retrieve ground truth data from one or more databases (not shown) to generate job descriptions (JDs), transcripts, skill map forms for the received one or more exemplary candidate roles. The JDs, transcripts, skill map forms are generated based on analyzing ground truth data and candidate roles using a natural language processing based artificial intelligence (AI) models.

At step 604, the method 600 includes identifying and classifying, by the computer implemented system 112, named entities, such as people, organizations, and locations, in the job descriptions (JDs), the transcripts, and the skill map forms. The named entities are identified and classified to extract skills of the candidate. The named entities are identified and classified using a named entity recognition (NER) based machine learning (ML) models. The computer implemented system 112 may use context-based relationships between the named entities to generate lexicon using lexicon generation-based AI model. The lexicon is a set of words or terms used in a particular field or context. In the context of skill graph generation, a lexicon might include the specific terminology and jargon used in a given industry or profession. The computer implemented system 112 generates the lexicon using skill trends in internet and social media. The computer implemented system 112 may use lexicon for the JDs and transcripts.

At step 606, the method 600 includes creating, by the computer implemented system 112, one or more topic clusters using the lexicon of JDs and transcripts. The one or more topic clusters are created using a hierarchical and/or k-medoid clustering based AI model. The hierarchical and/or k-medoid clustering based AI model may be used to group similar data points together based on respective characteristics. In the context of skill graph generation, clustering can be used to identify common skills and topics across different job descriptions and transcripts. The computer implemented system 112 maps the one or more topic clusters to one or more job roles. The computer implemented system 112 may examine new skills being identified and map to plausible candidate roles. The new skills and the plausible candidate roles may be feedback in a loop into one or more skill role graphs, which is then used as the trends of skills and roles for generating the lexicon. The intersection of skills/topics from the JDs and transcripts may be used by the computer implemented system 112, to identify the most important and relevant skills for a given role, and to create a report/interview insights that summarizes the relevant skills for the given role.

Various embodiments of the present computer implemented system 112 provide a solution to generate interview insights in an interviewing process. Because the computer implemented system 112 outputs the one or more attributes and the score card on graphical user interface of the one or more electronic devices 102, the interviewer may monitor candidate performance in the one or more interviews based on the one or more attributes and the score card. Further, the interviewer may also improve the quality of the one or more interviews to hire the best candidate for their organization. The computer implemented system 112 also facilitates conducting an unbiased and structured interview. The computer implemented system 112 generates one or more interview insights comprising a comparison of the one or more interview insights for each of the one or more interviews with an average ratio of pre-determined insights, for the one or more attributes. The one or more interview insights is comprised of at least one of language insights, situational judgement insights, diversity, equity, and inclusion (DEI) insights, legal risk and compliance insights, interview bias probability insights, and domain insights. Furthermore, the computer implemented system 112 outputs the one or more notifications corresponding to the extracted plurality of keywords on the graphical user interface of the one or more electronic devices 102 for ascertaining that all the extracted plurality of keywords are covered by the interviewer during the one or more interviews. Furthermore, the computer implemented system 112 outputs the one or more attributes, score card, interview summary, one or more interview insights, and the skill graph on a graphical user interface of one or more electronic devices associated with the interviewer.

The present invention with the computer implemented system 112 is configured to automatically generate the one or more offer ranges for the one or more candidates during the ongoing interviews. The AI-based interviewer generated by the computer implemented system 112 is used to reduce the burden on human interviewers and ensure consistent engagement with the candidates, allowing organizations to handle more interviews efficiently. The use of NLP techniques allows for advanced processing of candidate responses, enabling the computer implemented system 112 to analyze sentiment, context, and relevance dynamically. This analysis facilitates the generation of follow-up questions that are tailored to the specific direction of each conversation, enhancing the effectiveness of the interview.

The one or more contextual attributes derived from the one or more responses (verbal, non-verbal, performance) are assessed using the one or more machine learning models. This multi-faceted evaluation reduces bias and improves accuracy in determining candidate fit, which leads to more equitable hiring decisions. The AI-based interviewer autonomously generates the one or more follow-up interview questions based on responses, allowing for a more engaging and responsive interaction. This fosters an organic interview dialogue rather than a rigid question-and-answer format, which can lead to more insightful data collection. The one or more recruiting scores are generated based on candidate's responses and contextual attributes, providing a quantifiable method for assessing candidate suitability. The one or more recruiting scores objectively reflect the potential performance and fit of candidates, ensuring recruitment decisions are data-driven.

The computer implemented system 112 automatically generates competitive offer ranges for the one or more candidates. By analyzing the one or more recruitment scores alongside industry benchmarks and historical data, the computer implemented system 112 produces tailored offer ranges that align with organizational needs as well as market conditions. By utilizing data analytics and machine learning, the computer implemented system 112 systematically mitigates bias present in traditional interviewing methods. Automated processes help standardize evaluations across candidates, minimizing human errors and prejudice.

The information regarding the one or more candidates and their respective offer ranges is conveniently provided through user-friendly interfaces associated with the one or more electronic devices 102. This enhances the usability of the computer implemented system 112 for hiring managers and decision-makers, enabling quick adaptations in recruitment strategies. The AI models incorporated can be periodically updated with new data, allowing the AI models to adapt to evolving market conditions and organizational needs. This continuous learning loop secures the computer implemented system's 112 relevance and effectiveness over time, improving hiring practices based on real-world insights.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the computer implemented system 112 either directly or through intervening I/O controllers. Network adapters may also be coupled to the computer implemented system 112 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer implemented system 112 in accordance with the embodiments herein. The computer implemented system 112 herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the computer implemented system 112. The computer implemented system 112 can read the inventive instructions on the program storage devices and follow these instructions to execute the methodology of the embodiments herein.

The computer implemented system 112 further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A computer implemented system for automatically generating one or more offer ranges for one or more candidates during an interviewing process, the computer implemented system comprising:
one or more hardware processors; and
a memory communicatively coupled to the one or more hardware processors, wherein the memory comprises a plurality of subsystems in form of programmable instructions executable by the one or more hardware processors, wherein the plurality of subsystems comprises:
an AI-based interviewer generating subsystem configured to generate an AI-based interviewer simulating human-based interactions for conducting an ongoing interview with one or more candidates;
a data obtaining subsystem configured to obtain data associated with the one or more candidates through at least one of: one or more image capturing devices and one or more audio devices, during the ongoing interview, wherein the data associated with the one or more candidates comprise at least one of: profile information, responses in form of audio and text, and non-verbal cues, associated with the one or more candidates;
a data analyzing subsystem configured to analyze the data associated with the one or more candidates obtained during the ongoing interview, wherein analyzing the data associated with the one or more candidates comprises processing of the responses of the one or more candidates using natural language processing (NLP) techniques, and interpreting the one or more non-verbal cues;
a data processing subsystem configured to process the analyzed responses of the one or more candidates to determine one or more contextual attributes associated with the responses using one or more machine learning (ML) models, wherein the one or more contextual attributes comprise at least one of: one or more verbal attributes, one or more non-verbal attributes, one or more performance attributes, and one or more contextual interaction attributes;
a query generating subsystem configured to automatically generate one or more follow-up interview questions to be delivered to the one or more candidates during the ongoing interview based on the analyzed responses from the one or more candidates, by applying an AI model to the one or more contextual attributes associated with the responses;
a score generating subsystem configured to generate one or more recruitment scores for the one or more candidates based on at least one of: the analyzed responses, the one or more contextual attributes, and interpreted non-verbal cues, associated with the one or more candidates, using the AI model;
a decision supporting subsystem configured to generate one or more offer ranges for the one or more candidates based on the one or more recruitment scores using the AI model, wherein the one or more offer ranges are configured to assist for one or more users in recruitment-related decision making; and
an output subsystem configured to provide information associated with at least one of: one or more selected candidates, and the one or more offer ranges generated for the one or more selected candidates, to the one or more users through one or more user interfaces associated with one or more electronic devices of the one or more users.

2. The computer implemented system of claim 1, wherein in generating the AI-based interviewer, the AI-based interviewer generating subsystem is configured to:
identify one or more objectives of the AI-based interviewer by creating one or more interactive visual representations conducting the ongoing interview effectively;
generate a lifelike AI-based interviewer based on user personas relevant to one or more targeted interview domains comprising at least one of: one or more job roles and industries;
generate a visually appealing AI-based interviewer reflecting an identity and desired competencies of a human interviewer using a three dimensional modelling application;
perform at least one of: analyzing one or more inputs, processing the one or more inputs, and responding to the one or more inputs of the one or more candidates in real-time, by integrating one or more NLP capabilities within the AI-based interviewer;
train the AI-based interviewer with a set of competency-based questions and the one or more follow-up interview questions, relevant to a career path of the one or more candidates using the one or more ML models;
utilize one or more behavioral models to guide one or more interactions of the AI-based interviewer to emulate human-like behaviors comprising at least one of: changing tone, expressing empathy, providing facial expressions, and adjusting emotional responses, based on the responses from the one or more candidates;
implement a conversation engine for the AI-based interviewer to adapt for follow-up questions based on the responses from the one or more candidates, using the AI model;
synchronize at least one of: lip movements, gestures, and the facial expressions, of the AI-based interviewer with verbal communication of the AI-based interviewer during the ongoing interview, using a visual and audio synchronization technique; and
generate a natural sounding voice matching a visual persona of the AI-based interviewer using a speech synthesis technology.

3. The computer implemented system of claim 1, wherein in analyzing the data associated with the one or more candidates obtained during the ongoing interview, the data analyzing subsystem is configured to at least one of:
process the responses of the one or more candidates using the natural language processing (NLP) techniques, by:
obtaining the data associated with the one or more candidates;
processing the responses in form of the audio by a speech recognition model, wherein the speech recognition model transforms the audio into a text;
segmenting the transformed text into one or more tokens for analyzing the transformed text;
tagging each token with one or more corresponding grammatical roles for analyzing a structure of the responses;
analyzing an emotional tone of the responses comprising at least one of: positive, neutral, and negative emotions, to provide one or more insights into attitudes and feelings of the one or more candidates, using the one or more ML models;
identifying one or more key entities comprising skills, experiences, and names, within the responses, for matching the one or more candidates with one or more job roles; and
processing context surrounding specific phrases with the one or more key entities for analyzing nuance in the responses of the one or more candidates, using one or more transformer models;
interpret the one or more non-verbal cues by:
analyzing visual data collected during the ongoing interview using a computer vision technique;
identifying one or more emotions through the facial expressions of the one or more candidates;
tracking body language and hand gestures to assess confidence and reluctance of the one or more candidates; and
determining physical stance to guage comfort levels and engagement during the ongoing interview; and
integrate the processed responses of the one or more candidates and the interpreted one or more non-verbal cues to generate a comprehensive profile of the one or more candidates during the ongoing interview.

4. The computer implemented system of claim 1, wherein in automatically generating the one or more follow-up interview questions, the query generating subsystem is configured to:
obtain the analyzed responses comprising at least one of: verbal response and the non-verbal responses, from the one or more candidates;
identify the one or more contextual attributes from the analyzed responses;
utilize the one or more ML models being trained on one or more datasets of interview transcripts and the one or more follow-up interview questions, to analyze context and intention behind the responses of the one or more candidates;
interpret the nuances in a language capturing subtleties around meaning and intent guiding question formulation using the AI model with the NLP techniques; and
generate contextually appropriate one or more follow-up interview questions based on the identified one or more contextual attributes, using one or more neural network architectures.

5. The computer implemented system of claim 1, wherein the query generating subsystem is further configured to:
filter the one or more follow-up interview questions based on relevance of the specific context provided by one or more previous responses of the one or more candidates;
generate multiple variation of the one or more follow-up interview questions for at least one of: natural conversation flow, avoiding rigid scripts, and enabling dynamic interactions;
structure the one or more follow-up interview questions to assess competencies related to the one or more job roles; and
interact with the one or more candidates with one or more follow-up questions, adapting to a flow of conversation with the one or more candidates.

6. The computer implemented system of claim 1, wherein in generating the one or more recruitment scores for the one or more candidates, using the AI model, the score generating subsystem is configured to:
obtain information associated with at least one of: the analyzed responses, the one or more contextual attributes, and interpreted non-verbal cues, of each candidate of the one or more candidates;
generate one or more weights to at least one of: the analyzed responses, the one or more contextual attributes, and interpreted non-verbal cues, of the one or more candidates, using a scoring model; and
compute the one or more recruitment scores for each candidate based on the one or more weights generated for at least one of: the analyzed responses, the one or more contextual attributes, and interpreted non-verbal cues, of each candidate of the one or more candidates.

7. The computer implemented system of claim 1, wherein in generating the one or more offer ranges for the one or more candidates based on the one or more recruitment scores using the AI model, the decision supporting subsystem is configured to:
obtain information associated with the one or more recruitment scores generated for the one or more candidates;
analyze one or more target parameters and benchmarks based on at least one of: one or more industry standards, historical data, one or more organizational compensation structures, and competitor analyses; and
generate the one or more offer ranges for each candidate of the one or more candidates by correlating the one or more offer ranges with the one or more recruitment scores, based on at least one of: the one or more target parameters and benchmarks and one or more factors, using the AI model, wherein the one or more factors comprise at least one of: experience level, skill set, and overall fit for the job role, of the one or more candidates within an organization.

8. The computer implemented system of claim 1, wherein the AI-based interviewer is configured to analyze at least one of: emotion recognition, gaze tracking, and head movement through a real-time webcam, for performing at least one of: adjusting tone, pacing, and questioning in style using a multi-modal fusion, by adapting at least one of:
the data obtaining subsystem to continuously capture visual data with high-resolution video streams associated with the one or more candidates from webcam inputs, processing frame-by-frame visual data at rates for real-time emotion detection and behavioral analysis;
the data analyzing subsystem configured to:
analyze the visual data using computer vision techniques to identify emotions through facial expressions of the one or more candidates;
categorize the facial expressions of the one or more candidates as at least one of: happiness, sadness, confusion, anxiety, and confidence based on real-time analysis of facial movements and micro-expressions using a convolutional neural network model;
identify key facial features comprising eyebrow position, mouth curvature, eye openness, and cheek muscle tension, to analyze the emotion recognition;
track eye movements, fixation points, and gaze direction, of the one or more candidates, to assess candidate engagement and attention levels, using a computer vision system; and
track head position, tilt angles, and movement patterns, of the one or more candidates, to assess candidate comfort, agreement and disagreement signals, and overall engagement levels;
the data processing subsystem configured to:
process the analyzed responses to determine the one or more contextual attributes using machine learning models, wherein the visual data obtained from the real-time webcam input is processed to dynamically modify the one or more contextual attributes that are provided as input to a transformer-based large language model (LLM);
generate unified embeddings indicating verbal content and real-time visual behavioral data; and
correlate verbal responses with simultaneous visual cues to detect incongruence between spoken words and body language, using the transformer-based LLM; and
the query generating subsystem configured to:
utilize one or more behavioral models to guide interactions and emulate human-like behaviors comprising changing tone based on detected emotional states from the real-time webcam;
monitor visual indicators of cognitive processing comprising prolonged gaze aversion and facial expressions indicating concentration, to adjust the pacing; and
generate contextually appropriate follow-up questions influenced by real-time visual feedback.

9. The computer implemented system of claim 1, wherein the AI-based interviewer generating subsystem is configured to emulate at least one of: the lip movements, the gestures, the facial expressions, and speech tone through a text-to-speech engine with phoneme sync, using a LLM, by:
synchronizing the lip movements with verbal communication during the ongoing interview using visual and audio synchronization techniques;
analyzing generated speech content at a phoneme level, mapping each speech sound to corresponding viseme representations indicating lip and mouth movements;
synchronizing gestures of the AI-based interviewer with verbal communication during the ongoing interview;
analyzing LLM-generated content for contextual cues triggering corresponding hand and arm movements, comprising counting gestures for enumerated points and descriptive gestures for spatial concepts;
utilizing the one or more behavioral models to guide interactions of the AI-based interviewer to emulate human-like behaviors comprising the gestures based on the one or more responses from the one or more candidates;
utilizing the one or more behavioral models to guide the interactions and emulate human-like behaviors comprising providing facial expressions based on the one or more responses from the one or more candidates;
processing emotional context from LLM outputs and candidate analysis to select corresponding facial expressions indicating empathy, interest, concern, and encouragement;
utilizing the one or more behavioral models to guide the interactions comprising changing tone based on the one or more responses from the one or more candidates; and
modifying vocal parameters comprising pitch, pace, volume, and intonation to match emotional context determined by the LLM and candidate analysis systems.

10. A computer implemented method for automatically generating one or more offer ranges for one or more candidates during an interviewing process, the computer implemented method comprising:
generating, by one or more hardware processors, an AI-based interviewer simulating human-based interactions for conducting an ongoing interview with one or more candidates;
obtaining, by the one or more hardware processors, data associated with the one or more candidates through at least one of: one or more image capturing devices and one or more audio devices, during the ongoing interview, wherein the data associated with the one or more candidates comprise at least one of: profile information, responses in form of audio and text, and non-verbal cues, associated with the one or more candidates;
analyzing, by the one or more hardware processors, the data associated with the one or more candidates obtained during the ongoing interview, wherein analyzing the data associated with the one or more candidates comprises processing of the responses of the one or more candidates using natural language processing (NLP) techniques, and interpreting the one or more non-verbal cues;
processing, by the one or more hardware processors, the analyzed responses of the one or more candidates to determine one or more contextual attributes associated with the responses using one or more machine learning (ML) models, wherein the one or more contextual attributes comprise at least one of: one or more verbal attributes, one or more non-verbal attributes, one or more performance attributes, and one or more contextual interaction attributes;
automatically generating, by the one or more hardware processors, one or more follow-up interview questions to be delivered to the one or more candidates during the ongoing interview based on the analyzed responses from the one or more candidates, by applying an AI model to the one or more contextual attributes associated with the responses;
generating, by the one or more hardware processors, one or more recruitment scores for the one or more candidates based on at least one of: the analyzed responses, the one or more contextual attributes, and interpreted non-verbal cues, associated with the one or more candidates, using the AI model;
generating, by the one or more hardware processors, one or more offer ranges for the one or more candidates based on the one or more recruitment scores using the AI model, wherein the one or more offer ranges are configured to assist for one or more users in recruitment-related decision making; and
providing, by the one or more hardware processors, information associated with at least one of: one or more selected candidates, and the one or more offer ranges generated for the one or more selected candidates, to the one or more users through one or more user interfaces associated with one or more electronic devices of the one or more users.

11. The computer implemented method of claim 10, wherein generating the AI-based interviewer, comprises:
identifying, by the one or more hardware processors, one or more objectives of the AI-based interviewer by creating one or more interactive visual representations conducting the ongoing interview effectively;
generating, by the one or more hardware processors, a lifelike AI-based interviewer based on user personas relevant to one or more targeted interview domains comprising at least one of: one or more job roles and industries;
generating, by the one or more hardware processors, a visually appealing AI-based interviewer reflecting an identity and desired competencies of a human interviewer using a three dimensional modelling application;
performing, by the one or more hardware processors, at least one of: analyzing one or more inputs, processing the one or more inputs, and responding to the one or more inputs of the one or more candidates in real-time, by integrating one or more NLP capabilities within the AI-based interviewer;
training, by the one or more hardware processors, the AI-based interviewer with a set of competency-based questions and the one or more follow-up interview questions, relevant to a career path of the one or more candidates using the one or more ML models;
utilizing, by the one or more hardware processors, one or more behavioral models to guide one or more interactions of the AI-based interviewer to emulate human-like behaviors comprising at least one of: changing tone, expressing empathy, providing facial expressions, and adjusting emotional responses, based on the responses from the one or more candidates;
implementing, by the one or more hardware processors, a conversation engine for the AI-based interviewer to adapt for follow-up questions based on the responses from the one or more candidates, using the AI model;
synchronizing, by the one or more hardware processors, at least one of: lip movements, gestures, and the facial expressions, of the AI-based interviewer with verbal communication of the AI-based interviewer during the ongoing interview, using a visual and audio synchronization technique; and
generating, by the one or more hardware processors, a natural sounding voice matching a visual persona of the AI-based interviewer using a speech synthesis technology.

12. The computer implemented method of claim 10, wherein analyzing the data associated with the one or more candidates obtained during the ongoing interview, comprises:
processing, by the one or more hardware processors, the responses of the one or more candidates using the natural language processing (NLP) techniques, by:
obtaining, by the one or more hardware processors, the data associated with the one or more candidates;
processing, by the one or more hardware processors, the responses in form of the audio by a speech recognition model, wherein the speech recognition model transforms the audio into a text;
segmenting, by the one or more hardware processors, the transformed text into one or more tokens for analyzing the transformed text;
tagging, by the one or more hardware processors, each token with one or more corresponding grammatical roles for analyzing a structure of the responses;
analyzing, by the one or more hardware processors, an emotional tone of the responses comprising at least one of: positive, neutral, and negative emotions, to provide one or more insights into attitudes and feelings of the one or more candidates, using the one or more ML models;
identifying, by the one or more hardware processors, one or more key entities comprising skills, experiences, and names, within the responses, for matching the one or more candidates with one or more job roles; and
processing, by the one or more hardware processors, context surrounding specific phrases with the one or more key entities for analyzing nuance in the responses of the one or more candidates, using one or more transformer models;
interpreting, by the one or more hardware processors, the one or more non-verbal cues by:
analyzing, by the one or more hardware processors, visual data collected during the ongoing interview using a computer vision technique;
identifying, by the one or more hardware processors, one or more emotions through the facial expressions of the one or more candidates;
tracking, by the one or more hardware processors, body language and hand gestures to assess confidence and reluctance of the one or more candidates; and
determining, by the one or more hardware processors, physical stance to guage comfort levels and engagement during the ongoing interview; and
integrating, by the one or more hardware processors, the processed responses of the one or more candidates and the interpreted one or more non-verbal cues to generate a comprehensive profile of the one or more candidates during the ongoing interview.

13. The computer implemented method of claim 10, wherein automatically generating the one or more follow-up interview questions, comprises:
obtaining, by the one or more hardware processors, the analyzed responses comprising at least one of: verbal response and the non-verbal responses, from the one or more candidates;
identifying, by the one or more hardware processors, the one or more contextual attributes from the analyzed responses;
utilizing, by the one or more hardware processors, the one or more ML models being trained on one or more datasets of interview transcripts and the one or more follow-up interview questions, to analyze context and intention behind the responses of the one or more candidates;
interpreting, by the one or more hardware processors, the nuances in a language capturing subtleties around meaning and intent guiding question formulation using the AI model with the NLP techniques; and
generating, by the one or more hardware processors, contextually appropriate one or more follow-up interview questions based on the identified one or more contextual attributes, using one or more neural network architectures.

14. The computer implemented method of claim 10, further comprising:
filtering, by the one or more hardware processors, the one or more follow-up interview questions based on relevance of the specific context provided by one or more previous responses of the one or more candidates;
generating, by the one or more hardware processors, multiple variation of the one or more follow-up interview questions for at least one of: natural conversation flow, avoiding rigid scripts, and enabling dynamic interactions;
structuring, by the one or more hardware processors, the one or more follow-up interview questions to assess competencies related to the one or more job roles; and
interacting, by the one or more hardware processors, with the one or more candidates with one or more follow-up questions, adapting to a flow of conversation with the one or more candidates.

15. The computer implemented method of claim 10, wherein generating the one or more recruitment scores for the one or more candidates, using the AI model, comprises:
obtaining, by the one or more hardware processors, information associated with at least one of: the analyzed responses, the one or more contextual attributes, and interpreted non-verbal cues, of each candidate of the one or more candidates;
generating, by the one or more hardware processors, one or more weights to at least one of: the analyzed responses, the one or more contextual attributes, and interpreted non-verbal cues, of the one or more candidates, using a scoring model; and
computing, by the one or more hardware processors, the one or more interview scores for each candidate based on the one or more weights generated for at least one of: the analyzed responses, the one or more contextual attributes, and interpreted non-verbal cues, of each candidate of the one or more candidates.

16. The computer implemented method of claim 10, wherein generating the one or more offer ranges for the one or more candidates based on the one or more recruitment scores using the AI model, comprises:
obtaining, by the one or more hardware processors, information associated with the one or more recruitment scores generated for the one or more candidates;
analyzing, by the one or more hardware processors, one or more target parameters and benchmarks based on at least one of: one or more industry standards, historical data, one or more organizational compensation structures, and competitor analyses; and
generating, by the one or more hardware processors, the one or more offer ranges for each candidate of the one or more candidates by correlating the one or more offer ranges with the one or more recruitment scores, based on at least one of: the one or more target parameters and benchmarks and one or more factors, using the AI model, wherein the one or more factors comprise at least one of: experience level, skill set, and overall fit for the job role, of the one or more candidates within an organization.

17. The computer implemented method of claim 10, further comprising analyzing, by the one or more hardware processors, at least one of: emotion recognition, gaze tracking, and head movement through a real-time webcam, for performing at least one of: adjusting tone, pacing, and questioning in style using a multi-modal fusion, by:
continuously capturing, by the one or more hardware processors, visual data with high-resolution video streams associated with the one or more candidates from webcam inputs, processing frame-by-frame visual data at rates for real-time emotion detection and behavioral analysis;
analyzing, by the one or more hardware processors, the visual data using computer vision techniques to identify emotions through facial expressions of the one or more candidates;
categorizing, by the one or more hardware processors, the facial expressions of the one or more candidates as at least one of: happiness, sadness, confusion, anxiety, and confidence based on real-time analysis of facial movements and micro-expressions using a convolutional neural network model;
identifying, by the one or more hardware processors, key facial features comprising eyebrow position, mouth curvature, eye openness, and cheek muscle tension, to analyze the emotion recognition;
tracking, by the one or more hardware processors, eye movements, fixation points, and gaze direction, of the one or more candidates, to assess candidate engagement and attention levels, using a computer vision system; and
tracking, by the one or more hardware processors, head position, tilt angles, and movement patterns, of the one or more candidates, to assess candidate comfort, agreement and disagreement signals, and overall engagement levels;
processing, by the one or more hardware processors, the analyzed responses to determine the one or more contextual attributes using machine learning models, where the visual data from the real-time webcam input directly influence the one or more contextual attributes fed into a transformer-based LLM;
generating, by the one or more hardware processors, unified embeddings indicating verbal content and real-time visual behavioral data;
correlating, by the one or more hardware processors, verbal responses with simultaneous visual cues to detect incongruence between spoken words and body language, using the transformer-based LLM;
utilizing, by the one or more hardware processors, one or more behavioral models to guide interactions and emulate human-like behaviors comprising changing tone based on detected emotional states from the real-time webcam;
monitoring, by the one or more hardware processors, visual indicators of cognitive processing comprising prolonged gaze aversion and facial expressions indicating concentration, to adjust the pacing; and
generating, by the one or more hardware processors, contextually appropriate follow-up questions influenced by real-time visual feedback.

18. The computer implemented method of claim 10, further comprising emulating, by the one or more hardware processors, at least one of: the lip movements, the gestures, the facial expressions, and speech tone through a text-to-speech engine with phoneme sync, using a LLM, by:
synchronizing, by the one or more hardware processors, the lip movements with verbal communication during the ongoing interview using visual and audio synchronization techniques;
analyzing, by the one or more hardware processors, generated speech content at a phoneme level, mapping each speech sound to corresponding viseme representations indicating lip and mouth movements;
synchronizing, by the one or more hardware processors, gestures of the AI-based interviewer with verbal communication during the ongoing interview;
analyzing, by the one or more hardware processors, LLM-generated content for contextual cues triggering corresponding hand and arm movements, comprising counting gestures for enumerated points and descriptive gestures for spatial concepts;
utilizing, by the one or more hardware processors, the one or more behavioral models to guide interactions of the AI-based interviewer to emulate human-like behaviors comprising the gestures based on the one or more responses from the one or more candidates;
utilizing, by the one or more hardware processors, the one or more behavioral models to guide the interactions and emulate human-like behaviors comprising providing facial expressions based on the one or more responses from the one or more candidates;
processing, by the one or more hardware processors, emotional context from LLM outputs and candidate analysis to select corresponding facial expressions indicating empathy, interest, concern, and encouragement;
utilizing, by the one or more hardware processors, the one or more behavioral models to guide the interactions comprising changing tone based on the one or more responses from the one or more candidates; and
modifying, by the one or more hardware processors, vocal parameters comprising pitch, pace, volume, and intonation to match emotional context determined by the LLM and candidate analysis systems.

19. A non-transitory computer-readable storage medium having instructions stored therein that when executed by one or more hardware processors, cause the one or more hardware processors to execute operations of:
generating an AI-based interviewer simulating human-based interactions for conducting an ongoing interview with one or more candidates;
obtaining data associated with the one or more candidates through at least one of:
one or more image capturing devices and one or more audio devices, during the ongoing interview, wherein the data associated with the one or more candidates comprise at least one of: profile information, responses in form of audio and text, and non-verbal cues, associated with the one or more candidates;
analyzing the data associated with the one or more candidates obtained during the ongoing interview, wherein analyzing the data associated with the one or more candidates comprises processing of the responses of the one or more candidates using natural language processing (NLP) techniques, and interpreting the one or more non-verbal cues;
processing the analyzed responses of the one or more candidates to determine one or more contextual attributes associated with the responses using one or more machine learning (ML) models, wherein the one or more contextual attributes comprise at least one of: one or more verbal attributes, one or more non-verbal attributes, one or more performance attributes, and one or more contextual interaction attributes;
automatically generating one or more follow-up interview questions to be delivered to the one or more candidates during the ongoing interview based on the analyzed responses from the one or more candidates, by applying an AI model to the one or more contextual attributes associated with the responses;
generating one or more recruitment scores for the one or more candidates based on at least one of: the analyzed responses, the one or more contextual attributes, and interpreted non-verbal cues, associated with the one or more candidates, using the AI model;
generating one or more offer ranges for the one or more candidates based on the one or more recruitment scores using the AI model, wherein the one or more offer ranges are configured to assist for one or more users in recruitment-related decision making; and
providing information associated with at least one of: one or more selected candidates, and the one or more offer ranges generated for the one or more selected candidates, to the one or more users through one or more user interfaces associated with one or more electronic devices of the one or more users.

20. The non-transitory computer-readable storage medium of claim 19, wherein generating the AI-based interviewer, comprises:
identifying one or more objectives of the AI-based interviewer by creating one or more interactive visual representations conducting the ongoing interview effectively;
generating a lifelike AI-based interviewer based on user personas relevant to one or more targeted interview domains comprising at least one of: one or more job roles and industries;
generating a visually appealing AI-based interviewer reflecting an identity and desired competencies of a human interviewer using a three dimensional modelling application;
performing at least one of: analyzing one or more inputs, processing the one or more inputs, and responding to the one or more inputs of the one or more candidates in real-time, by integrating one or more NLP capabilities within the AI-based interviewer;
training the AI-based interviewer with a set of competency-based questions and the one or more follow-up interview questions, relevant to a career path of the one or more candidates using the one or more ML models;
utilizing one or more behavioral models to guide one or more interactions of the AI-based interviewer to emulate human-like behaviors comprising at least one of: changing tone, expressing empathy, providing facial expressions, and adjusting emotional responses, based on the responses from the one or more candidates;
implementing a conversation engine for the AI-based interviewer to adapt for follow-up questions based on the responses from the one or more candidates, using the AI model;
synchronizing at least one of: lip movements, gestures, and the facial expressions, of the AI-based interviewer with verbal communication of the AI-based interviewer during the ongoing interview, using a visual and audio synchronization technique; and
generating a natural sounding voice matching a visual persona of the AI-based interviewer using a speech synthesis technology.
